(19) United States
(12) Patent Application Publication
(10) Pub. No.: US 2007/0149401 A1
(43) Pub. Date: Jun. 28, 2007

(54) METHODS AND COMPOSITION FOR GROWTH ENGINEERING AND DISEASE CONTROL

(75) Inventors: Jack Haskell, Hudson, NY (US); Kiran Shetty, Durham, NH (US); Alex Cochran, Obenwil (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Crop Protection, Inc., Greensboro, NC (US)

(21) Appl. No.: 11/615,311

(22) Filed: Dec. 22, 2006

Related U.S. Application Data
(60) Provisional application No. 60/753,027, filed on Dec. 22, 2005.

(30) Foreign Application Priority Data
Dec. 14, 2006 (US) PCT/US06/62059

(51) Int. Cl. A01N 25/32

(52) U.S. Cl. 504/103

(57) ABSTRACT

The present invention relates to compositions and methods for suppressing bacterial disease, manipulating the emergence and growth of plants, enhancing the health of transplants, and safening plants against post-emergent pesticide application by treating the plant propagation material with a composition comprising at least one plant growth regulator in combination with at least one plant activator and other optional active ingredients.

The present invention relates to compositions and methods for manipulating the germination and growth of plants and for controlling diseases in plants by treating plants or plant propagation material with at least one plant growth regulator, alone or in combination with at least one plant activator and/or other active ingredients. The present invention additionally relates to methods for manipulating the germination and growth of plants and for controlling diseases in plants by treating plants or plant propagation material with at least one plant growth regulator in combination with at least one plant activator and/or other active ingredients.

Plant growth regulators (PGRs) are generally any substances or mixtures of substances intended to accelerate or retard the rate of growth or maturation, or otherwise alter the development of plants or their produce. Some plant growth regulators provide protection against abiotic stresses to a plant. Tolerance to temperature extremes, both high and low, drought, and salt are a few examples of abiotic stresses to which a plant may be subjected. PGRs enable a plant to fight the abiotic stresses by controlling the natural expression of hormones within the plant.

Plant growth regulators are known in the art of agricultural chemistry and are described in The Pesticide Manual (Twelfth Edition, C.D.S. Tomlin, Ed.). For example, paclobutrazol (590) and cyproconazole (189) are triazole fungicides that exhibit plant growth regulating activity, specifically as growth retardants. By slowing the growth of the plant, certain triazole fungicides have been shown to produce more compact plants with earlier flowering and fruiting and greater tolerance to temperature extremes and drought.

However, use of PGRs as seed treatments in general and paclobutrazol or cyproconazole in particular, can delay emergence while affecting the plant's ability to fight against and tolerate abiotic stresses and diseases. It would be desirable to obtain increased resistance to abiotic stresses in plants by using a PGR without limiting the rate of emergence.

It is also known in the art that plants, like humans, possess a variety of natural defenses that can be expressed in response to biotic stresses such as diseases and parasites. Controlling these natural defensive responses is a process known as systemic activated resistance (SAR). Plant activators (PA) are used to control these responses, resulting in the plant either coping or succumbing to the disease or parasite.

Plant activators are also described in The Pesticide Manual (Twelfth Edition, C.D.S. Tomlin, Ed.) as having activity for controlling biotic stresses of plants. In particular, application of acibenzolar-S-methyl (8) to wheat shows fungal control, even though the compound itself possesses no fungicidal properties. By activating the natural disease-fighting responses of the plant, acibenzolor-S-methyl is able to stimulate SAR against fungal pathogens in wheat.

Reactions to biotic and abiotic stresses affect the way a plant thrives, and particularly affect the way a plant responds to transplanting. Control of bacterial and fungal pathogens plays an important role in plant and transplant health. As many plants are commercialized as seedlings for subsequent transplanting, the ability to strengthen a plant and control diseases in preparation for transplanting represents a significant commercial advantage to the grower.

Several characteristics can be used to assess a seedling's durability for transplant. For example, shorter, stockier plants would be more desirable than taller, thinner plants since the potential for lodging and stem damage is less. Additionally, shorter plants can be stacked and packaged more efficiently than taller plants, making their transportability easier. By controlling growth of the plants so that desirability for transplantation is optimized, a grower can optimize crop productivity.

There exists a need in the art for a method for controlling the emergence and growth of a plant without compromising tolerance to biotic and abiotic stresses or the characteristics desirable for transplantability.

Controlling the canopy size of a plant would also be beneficial, especially from a commercial grower's standpoint. By limiting the size of a plant canopy, the surface area of the plant is reduced, providing less area for insects to feed. Such a reduction in insect damage provides a valuable benefit to the grower as it allows for insect control without the additional application of insecticidal agents. As a result, the growers' costs and inputting requirements are reduced. Modified canopy via plant growth regulation will also aid in efficient harvesting of the crop, be it foliage, fruit or pod, stem and root with much reduced waste and unusuable plant material.

There exists a need in the art for a method for controlling insect damage to plants without the need to treat the plant with an insecticidal agent. Alternatively, there is a need in the art to reduce the use of insecticides.

An optimized canopy also provides other benefits to the plant. Canopy size control allows for control of the size and number of internodes on the plant, allowing more fruit-bearing opportunities per plant. Additionally, the controlled canopy and stockier plants result in less watering, fertilizing, and other inputs to the plants, thus allowing greater efficiencies in time and expense to the grower. A more compact plant with an optimized canopy size eliminates shadowing by adjacent plants, allowing more light to be captured by each plant. Such increased light capture allows for greater photosynthetic efficiency and improves growth, development, flowering (timing and synchronizing), maturity and yield.

There exists a need in the art for a method to control and optimize the canopy size of plants.

In the field of agrochemicals, active chemical agents have been applied by application of the agents to the plants themselves and to the growing medium (e.g., soil) for the plants. However, it is known that treatments can be employed prior to the emergence of the plants by applying active chemical agents in a manner to affect the seeds, seed germination and seedling growth, either by applying the agents to the growing medium near the seeds or, more preferably, by applying the agents directly to the seeds themselves.

For several reasons, such pre-emergent application often has been found advantageous relative to post-emergent topical application to the plants. For example, application of the active chemical agents to the seeds prior to or during germination of the plants, or to the growing medium in which the seeds are planted, has been found to eliminate the need for the expensive equipment required for topical in situ application of such agents to growing plants, to reduce the waste associated with the topical in situ application to growing plants, to reduce the run-off associated with such topical applications and the resulting need for repeated re-application of the agents. This approach also minimizes or eliminates the need for expensive and cumbersome aerial application of products that have sometimes caused environmental concerns.

On the other hand, pre-emergent techniques suffer certain drawbacks as well. For instance, whether the active agent is applied to the growing medium or directly to the seed prior to planting, the active agent often tends to bond in some fashion to the soil (or other growing medium) or certain components of the soil. This can limit uptake into the plant or otherwise inhibit delivery of an effective dose to the pest or target site in the plant.

However, applying the active agent to the seed itself presents other problems. First, it is usually difficult to bond active agents to seeds. And once the active agent is bonded to the seed, such as by use of an adhesive or polymer, the method of adherence, or active agent itself can cause agglomeration of seeds together, making it difficult to use standard planting equipment. Moreover, once adhered, much of the active agent is typically lost due to abrasion encountered during handling. Secondly, it is also important to note that delivery of active ingredients on to the seed or the growing medium must be safe without inducing phytotoxicity to the seed.

There is a need in the art for a method for applying one or more plant growth regulators, alone and in combination with plant activators, to an individual seed in a specific, consistent quantity and delivery systems.

The present invention includes a novel composition comprising at least one plant growth regulator and at least one plant activator. More specifically, the present invention includes a composition for treating plant propagation material of a plant, such as a crop or ornamental plant, comprising an effective amount of at least one plant growth regulator, such as paclobutrazol or cyproconazole and other analogues, with or without at least one other plant growth regulator such as gibberellic acid and a plant activator such as acibenzolar-S-methyl or harpin.

The present invention includes a method comprising treating plant propagation material with an effective amount of a novel composition comprising at least one plant growth regulator and at least one plant activator. More specifically, the present invention includes a method for treating plant propagation material of a plant, such as a crop or ornamental plant, with an effective amount of a novel composition comprising an effective amount of at least one plant growth regulator, such as paclobutrazol or cyproconazole, with or without at least one other plant growth regulator such as gibberellic acid and a plant activator such as acibenzolar-S-methyl or harpin.

The present invention additionally includes a method for manipulating and/or promoting germination of a plant comprising treating plant propagation material with an effective amount of a composition comprising at least one plant growth regulator alone, or in combination with, at least one plant activator. More specifically, the present invention includes a method for manipulating and/or promoting germination of a plant comprising treating plant propagation material with an effective amount of a composition comprising an effective amount of at least one plant growth regulator, such as paclobutrazol or cyproconazole, with or without at least one other plant growth regulator such as gibberellic acid and a plant activator such as acibenzolar-S-methyl or harpin.

The present invention additionally includes a method for controlling diseases in a plant comprising treating plant propagation material with an effective amount of a composition comprising at least one plant growth regulator(s) alone, or in combination with, at least one plant activator. More specifically, the present invention includes a method for controlling disease in a plant comprising treating plant propagation material with an effective amount of a composition comprising an effective amount of at least one plant growth regulator, such as paclobutrazol or cyproconazole, with or without at least one other plant growth regulator such as gibberellic acid and a plant activator such as acibenzolar-S-methyl or harpin.

The present invention further includes a method for treating an individual seed of a plant with an amount from 0.01 to 20 μg/seed of the at least one plant growth regulator independently or in combination with 0.01 to 20 μg/seed of the at least one plant activator. The plant activator(s) may be applied as a formulated product in combination with the growth regulator(s) onto the seed or plant propagation materials. Alternatively, in some instances, the plant growth regulator(s) and plant activator(s) may be applied sequentially and/or interchangeably onto the seed or propagating plant materials. In another aspect, the plant growth regulator(s) and plant activator(s) may be delivered on the seed via pelleting, film coating, micro-encapsulations or encrusting procedures. Additionally, as another alternative, the plant growth regulator(s) is (are) applied first onto the seed and the plant activator(s) is (are) applied at a later stage, such as after germination, at higher dosage, for example between 100 to 750 g/ha, during growth and development of the plant. Alternatively, the plant activator(s) is (are) applied first onto the seed and the plant growth regulator(s) are applied at a later stage.

In a specific embodiment of one embodiment of the present invention, the method comprises treating an individual seed of a plant with an amount from 0.01 to 20 μg/seed of a plant growth regulator, especially paclobutrazol or cyproconazole, in combination with 0.01 μg/seed to 20 μg/seed of at least one additional plant growth regulator, particularly a gibberellin, optionally further in combination with 0.01 μg/seed to 20 μg/seed of the at least one plant activator, especially acibenzalor-S-methyl or harpin. The seed treatment can be as a combined formulation of all active ingredients or as a sequential treatment of one or more of the active ingredients individually applied to the seed.

The present invention is additionally directed to a method for enhancing the transplant health of a plant comprising treating plant propagation material with an effective amount of a composition comprising at least one plant growth regulator in combination with at least one plant activator, planting, and achieving enhanced transplant characteristics.

The present invention is additionally directed to a method for improved disease protection, especially for improved bacterial protection, in plants comprising treating the plant or its propagation material with an effective amount of a composition comprising at least one plant growth regulator in combination or in sequence, or during any stage in the growth and development of the plants, with at least one plant activator.

The present invention is additionally directed to a method for improved disease protection in transplants comprising treating the plant propagation material, including the seed, with an effective amount of a composition comprising at least one plant growth regulator in combination with at least one plant activator, planting and/or transplanting, and achieving enhanced disease protection. Alternatively, the invention provides for improved disease protection in transplants comprising treating the plant propagation material with a composition comprising at least one plant growth regulator, planting and/or transplanting, and treating the resulting plant with at least one plant activator and achieving enhanced disease protection.

Additionally, the present invention provides a method for synergistically enhancing disease protection in plants and transplants comprising treating the plant propagation material with a composition comprising at least one plant growth regulator in combination with at least one plant activator, planting and/or transplanting, and optionally treating the resulting plant with at least one plant activator and achieving enhanced disease protection greater than would be provided by treatment of the plant with a plant activator alone.

Additionally, the present invention includes a method for optimizing a plant canopy comprising treating plant propagation material with an effective amount of a composition comprising at least one plant growth regulator in combination with at least one plant activator.

The present invention further includes a method for controlling insect damage to a plant comprising treating plant propagation material with a composition comprising at least one plant growth regulator in combination with at least one plant activator.

The present invention also includes plant propagation material treated by the compositions of the present invention.

The present invention provides a composition useful for controlling emergence, growth and development of a plant while simultaneously maintaining its tolerance to biotic and abiotic stresses. Additionally, the plant maintains characteristics desirable for transplantability. The composition of the present invention comprises at least one plant growth regulator and at least one plant activator. In one embodiment, the composition of the present invention comprises one or more plant growth regulators, for example but not for limitation paclobutrazol, cyproconazole, flurprimidol, or uniconazole, in combination with at least one plant activator. In one preferred embodiment, the composition of the present invention comprises paclobutrazol, cyproconazole, flurprimidol, or uniconazole, optionally in combination with a gibberellin, and further in combination with acibenzolor-S-methyl or harpin protein, optionally in combination with one or more additional pesticidal agents.

In another embodiment, the composition of the present invention comprises one or more of plant growth regulators, for example but not for limitation paclobutrazol, cyproconazole, flurprimidol, or uniconazole, optionally in combination with at least one gibberellin, and further in combination with at least one plant activator. In one preferred embodiment, the composition of the present invention comprises paclobutrazol, cyproconazole, flurprimidol, or uniconazole in combination with at least one gibberellin, and in combination with acibenzolor-S-methyl or harpin, optionally in combination with one or more additional pesticidal agents.

Plant growth regulators are any substances or mixtures of substances intended to alter the germination, growth, maturation, or development of plants or their produce. Plant growth regulators may be classified into subcategories including, but not limited to antiauxins (clofibric acid, 2,3,5-tri-iodobenzoic acid), auxins (4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, 2,4,5-T), cytokinins (2iP, benzyladenine, kinetin, zeatin), defoliants (calcium cyanamide, dimethipin, endothal, ethephon, merphos, metoxuron, pentachlorophenol, thidiazuron, tribufos), ethylene inhibitors (aviglycine, 1-methylcyclopropene), ethylene releasers (ACC, etacelasil, ethephon, glyoxime), gibberellins (gibberellic acid, gibberellins, including non-cyclopropene compounds that show gibberellin-like activity, such as, for example, helminthosporic acid, phaseolic acid, kaurenoic acid, and steviol), growth inhibitors (abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham 2,3,5-tri-iodobenzoic acid), morphactins (chlorfluren, chlorflurenol, dichlorflurenol, flurenol), growth retardants/modifiers (chlormequat, daminozide, flurprimidol, mefluidide, paclobutrazol, cyproconazole, tetcyclacis, uniconazole, ancymidol, trinexapac-ethyl, and progexadione-CA), growth stimulators (brassinolide, forchlorfenuron, hymexazol, 2-amino-6-oxypurine derivatives, as described below, indolinone derivates, as described below, 3,4-disubstituted maleimide derivatives, as described below, and fused azepinone derivatives, as described below). The term additionally includes other active ingredients such as benzofluor, buminafos, carvone, ciobutide, clofencet, cloxyfonac, cyclanilide, cycloheximide, epocholeone, ethychlozate, ethylene, fenridazon, heptopargil, holosulf, inabenfide, karetazan, lead arsenate, methasulfocarb, prohexadione, pydanon, sintofen, triapenthenol, and trinexapac. Preferred plant growth regulators include growth retardants, the class of gibberellins, including gibberellic acid, growth inhibitors, and growth stimulators. Particularly preferred plant growth regulators include growth retardants, particularly paclobutrazol, cyproconazole, flurprimidol, trinexapac, and uniconazole and the class of gibberellins, including gibberellic acid, especially GA₃. Particularly preferred are paclobutrazol, cyproconazole, uniconazole, trinexapac and gibberellic acid.

Included as plant growth regulators, specifically as growth stimulators, are 2-amino-6-oxypurine derivatives having the formula (I) and agriculturally acceptable salts thereof: 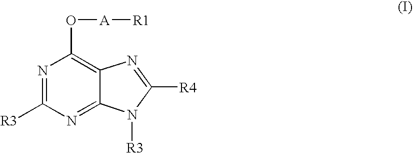
wherein: A is (C₁-C₆)-alkylene or (C₁-C₆)-haloalkylene, in which groups a methylene moiety may be replaced by a group selected from —C(═O)—, —O— and —S—, with the proviso that the replacing group is not bonded to the adjacent O atom; or is (C₂-C₆)-alkenylene, (C₂-C₆)-haloalkenylene, (C₃-C₆)-alkynylene or (C₃-C₆)-haloalkynylene; R¹ is H, (C₃-C₁₀)cycloalkyl or (C₅-C₁₀)cycloalkenyl, where each of the last 2 mentioned radicals is unsubstituted or substituted by one or more R⁵ radicals; or is (C₅-C₁₀) aryl or (3-10)heterocyclyl, where each of the last 2 mentioned radicals is unsubstituted or substituted by one or more R⁶ radicals; R² and R^{2a} are each independently H, (C₁-C₃)alkyl or (C₁-C₃)haloalkyl; R³ is H, CO—(C₁-C₃)alkyl, CO—(C₁-C₃)haloalkyl, CO2-(C₁-C₃)alkyl, CONR²R^{2a} or COS— (C₁-C₃) alkyl; R⁴ is H, halogen, (C₁-C₃)alkyl or (C₁-C₃)haloalkyl; R⁵ is (C₁-C₆)alkyl, (C₁-C₆)haloalkyl, halogen, (C₁-C₆)alkoxy, (C₁-C₆)haloalkoxy, (C₁-C₆)alkylthio or (C₁-C₆)haloalkylthio; R⁶ is (C₁-C₆)alkyl, (C₁-C₆)haloalkyl, (C₂-C₆)alkenyl, (C₂-C₆)haloalkenyl, (C₂-C₆)alkynyl, (C₂-C₆)haloalkynyl, halogen, (C₁-C₆)alkoxy, (C₁-C₆)haloalkoxy, (C₂-C₆)alkenyloxy, (C₂-C₆)haloalkenyloxy, (C₂-C₆)alkynyloxy, (C₂-C₆)haloalkynyloxy, S(O)ₘR⁷, CN, NO₂, OH, —(CH₂)ₙR⁸, COR⁹, NR¹⁰COR⁹, NR⁹SO₂R⁷, CONR⁹R^{10c}, NR⁹R^{10c}, S(O)ₚR⁸, or CO₂R⁷, or two adjacent OH groups may together with two adjacent carbon atoms of the heterocyclyl group form a 2-R¹¹^{^{c}}, 2-R¹²^{^{c}}-1,3-dioxolan-yl ring, or when R¹ is (3-10)heterocyclyl may also be oxo; R⁷ is (C₁-C₆)alkyl or (C₁-C₆)haloalkyl; R⁸ is phenyl unsubstituted or substituted by one or more radicals selected from the group consisting of (C₁-C₆)alkyl, (C₁-C₆)haloalkyl, halogen, (C₁-C₆)alkoxy, (C₁-C₆) haloalkoxy, S(O)ₘR⁷, CN and NO₂; R⁹ and R¹⁰ are each independently H, (C₁-C₆)alkyl or (C₁-C₆)haloalkyl; R¹¹^{^{c}} is H, (C₁-C₆) alkyl or phenyl; R¹²^{^{c}} is H or (C₁-C₆) alkyl; and m, n and p are each independently 0,1 or 2.

Also included as plant growth regulators, specifically as growth stimulators, are fused azepinone derivatives, and agriculturally acceptable salts thereof, of the formula II: 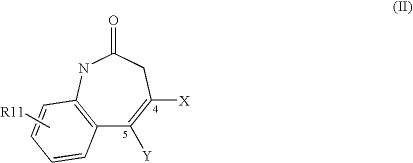
X is CO₂R²¹ or H; Y is OH; NHNR³¹R⁴¹, NHNHC(=Z)NR⁵¹R⁶¹ or NHNHC(=Z)CR⁷¹R⁸¹R⁹¹; X and Y together with the two carbon atoms to which they are attached form a ring of formula (IIa): 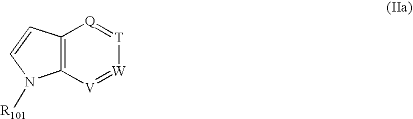
   wherein the carbon atoms marked 4 and 5 respectively correspond to the carbon atoms marked 4 and 5 in formula (II); Q, T, W and V are each independently CR¹¹¹ or a N atom, providing that a maximum of one of Q, T, W and V is a N atom; Z is O or S; R¹¹ and R¹¹¹ are each independently H, halogen, hydroxy, amino, nitro, formyl, carboxy, cyano, thiocyanato, aminocarbonyl, (C₁-C₆)alkoxy, (C₁-C₆)haloalkoxy, (C₁-C₆)alkyl-S(O)ₙ, (C₁-C₆)haloalkyl-S(O)ₙ, (C₁-C₆)alkylamino, di[(C₁-C₆)alkyl]amino, (C₁-C₆)alkylcarbonyl, (C₁-C₆)alkoxycarbonyl, (C₁-C₆)alkylaminocarbonyl, di[(C₁-C₆)alkyl]aminocarbonyl, N—(C₁-C₆)alkanoylamino, N—(C₁-C₆)alkanoyl-N—(C₁-C₆)alkylamino, sulfamoyl, N—(C₁-C₆)alkylsulfamoyl, N,N-di[(C₁-C₆)alkyl]sulfamoyl, (C₃-C₉)cycloalkyl, (C₁-C₆)alkyl, (C₂-C₆)alkenyl and (C₂-C₆)alkynyl, where each of the last-mentioned 3 radicals is unsubstituted or substituted by one or more radicals selected from the group consisting of halogen, hydroxy, amino, nitro, carboxy, cyano, (C₁-C₄)alkoxy, (C₁-C₄)haloalkoxy, (C₁-C₄)alkyl-S(O)ₙ, (C₁-C₄)haloalkyl-S(O)ₙ, (C₁-C₄)alkylamino, di[(C₁-C₄)alkyl]amino, (C₃-C₉)cycloalkyl, (C₁-C₄)alkylcarbonyl, (C₁-C₄)alkoxycarbonyl, phenyl, phenoxy, phenylthio, heterocyclyl, heteroaryloxy and heteroarylthio, where each of the last-mentioned 6 radicals is unsubstituted or has one or more substituents selected from the group consisting of halogen, nitro, formyl, cyano, (C₁-C₄)alkyl, (C₁-C₄)alkoxy, (C₁-C₄)alkyl-S(O)ₙ, (C₁-C₄)haloalkyl-S(O)ₙ, (C₁-C₄)haloalkyl, (C₁-C₄)haloalkoxy, (C₁-C₄)alkylcarbonyl and (C₁-C₄)alkoxycarbonyl; or phenyl, phenoxy, phenylthio, phenylcarbonyl, heteroaryl, heteroaryloxy and heteroarylthio, where each of the last-mentioned 7 radicals is unsubstituted or substituted by one or more radicals selected from the group consisting of halogen, hydroxy, amino, nitro, carboxy, formyl, cyano, (C₁-C₄)alkyl, (C₁-C₄)haloalkyl, (C₁-C₄)alkoxy, (C₁-C₄)haloalkoxy, (C₁-C₄)alkyl-S(O)ₙ, (C₁-C₄)haloalkyl-S(O)ₙ, (C₁-C₄)alkylamino, di[(C₁-C₄)alkyl]amino, (C₁-C₄)alkylcarbonyl, (C₁-C₄)alkoxycarbonyl and in the case of heteroaryl also oxo, where heteroaryl in the abovementioned radicals independently of one another in each case is a mono-, bi- or tricyclic heteroaromatic ring system in which at least 1 ring contains one or more hetero atoms (preferably 1, 2 or 3 hetero atoms) selected from the group consisting of N, O and S, and which contains a total of 5 to 14 (preferably 5 to 7) ring atoms wherein at least one ring is fully unsaturated (any further rings being unsaturated, or partially or fully hydrogenated); and heterocyclyl is a heterocyclic radical having 3 to 7 ring atoms and 1 to 3 hetero atoms selected from the group consisting of N, O and S; R²¹ is (C₁-C₆)alkyl, (C₃-C₉)cycloalkyl, (C₁-C₆)alkyl, (C₂-C₆)alkenyl, (C₂-C₆)alkynyl, (C₁-C₄)alkoxy-(C₁-C₄)alkyl; R³ is (C₁-C₆)alkyl, (C₂-C₆)alkenyl, (C₂-C₆)alkynyl, phenyl-(CH₂)ₘ or heteroaryl, where heteroaryl is a mono-, bi- or tricyclic heteroaromatic ring system in which at least 1 ring contains one or more hetero atoms (preferably 1, 2 or 3 hetero atoms) selected from the group consisting of N, O and S, and which contains a total of 5 to 14 (preferably 5 to 7) ring atoms wherein at least one ring is fully unsaturated (any further rings being unsaturated, or partially or fully hydrogenated) which is unsubstituted or substituted by one or more radicals selected from the group consisting of halogen, hydroxy, amino, nitro, carboxy, formyl, cyano, (C₁-C₄)alkyl, (C₁-C₄)haloalkyl, (C₁-C₄)alkoxy, (C₁-C₄)haloalkoxy, (C₁-C₄)alkyl-S(O)ₙ, (C₁-C₄)haloalkyl-S(O)ₙ, (C₁-C₄)alkylamino, di[(C₁-C₄)alkyl]amino, (C₁-C₄)alkylcarbonyl, (C₁-C₄)alkoxycarbonyl and oxo; R⁴¹, R⁶¹, R⁸¹, R⁹¹ and R¹⁰¹ are each independently H or (C₁-C₆)alkyl; R⁵¹ is H or R³¹; R⁷¹ is as defined for R³¹ wherein m is zero; m is 0 or 1; and n is 0, 1 or 2.

Also included as plant growth regulators, specifically as plant stimulants, are indolinone derivatives of the formula III: 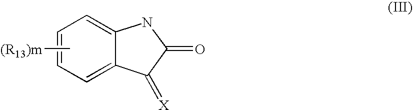
Wherein X is NNHR²², NNHC(═S)NH—(C₁-C₆)alkyl or a group of the formula (IIIa): 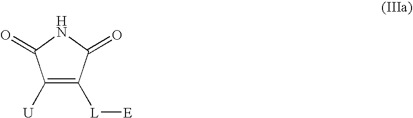
in which the point of attachment is the carbon atom marked 2; D is a group of the formula ═N—OR^{23a} in which R^{23a} is H, (C₁-C₄) alkyl or (C₁-C₆)alkoxycarboylmethyl; R¹²³ and R³²³ are each independently H, halogen, hydroxy, amino, nitro, formyl, carboxy, cyano, aminocarbonyl, (C₁-C₆)alkoxy, (C₁-C₆)haloalkoxy, (C₁-C₆)alkyl-S(O)ₙ, (C₁-C₆)haloalkyl-S(O)ₙ, (C₁-C₆)alkylamino, di[(C₁-C₆)alkyl]amino, (C₁-C₆)alkylcarbonyl, [(C₁-C₆)alkoxy]-carbonyl, (C₁-C₆)alkylaminocarbonyl, di[(C₁-C₆)alkyl]aminocarbonyl, N—(C₁-C₆)alkanoylamino, N—(C₁-C₆)alkanoyl-N—(C₁-C₆)alkylamino, sulfamoyl, N—(C₁-C₆)alkylsulfamoyl, N,N-di[(C₁-C₆)alkyl]sulfamoyl, R⁴²³, COR⁴²³, OR⁴²³, SO₂R⁴²³, OCH₂R⁴²³, hydroxysulfonylamino, (C₁-C₆)alkoxysulfonylamino, (C₁-C₆)alkyl, (C₂-C₆)alkenyl and (C₂-C₆) alkynyl, where each of the last-mentioned 3 radicals is unsubstituted or substituted by one or more radicals selected from the group consisting of halogen, hydroxy, amino, nitro, carboxy, cyano, (C₁-C₄)alkoxy, (C₁-C₄)haloalkoxy, (C₁-C₄)alkyl-S(O)ₙ, (C₁-C₄)haloalkyl-S(O)ₙ, (C₁-C₄)alkylamino, di[(C₁-C₄)alkyl]amino, (C₃-C₉)cycloalkyl, (C₁-C₄)alkylcarbonyl and (C₁-C₄)alkoxycarbonyl; R²²³ is phenyl or heteroaryl, which groups are unsubstituted or substituted by one or more radicals selected from the group consisting of halogen, hydroxy, amino, nitro, carboxy, formyl, cyano, (C₁-C₆)alkyl, (C₁-C₆)haloalkyl, (C₁-C₆)alkoxy, (C₁-C₆)haloalkoxy, (C₁-C₆)alkyl-S(O)ₙ, (C₁-C₆)haloalkyl-S(O)ₙ, (C₁-C₆)alkylamino, di[(C₁-C₆)alkyl]amino, (C₁-C₆)alky[carbonyl, [(C₁-C₆)alkoxy]-carbonyl, sulfamoyl, (C₁-C₆)alkylsulfonylamino, (C₁-C₆)alkylaminosulfonylmethyl, SO₂NHR⁵²³ and in the case of heteroaryl also oxo, wherein heteroaryl is a mono-, bi- or tricyclic heteroaromatic ring system which contains a total of 5 to 14 (preferably 5 to 7) ring atoms, in which at least 1 ring contains one or more hetero atoms (preferably 1, 2 or 3 hetero atoms) selected from the group consisting of N, O and S and is fully unsaturated (any further rings being unsaturated, or partially or fully hydrogenated); R⁴²³ is phenyl unsubstituted or substituted by one or more radicals selected from the group consisting of halogen, (C₁-C₄)alkyl, (C₁-C₄)haloalkyl, (C₁-C₄)alkoxy and (C₁-C₄) alkyl-S(O)ₙ; R⁵²³ is (C₁-C₄)alkyl, (C₁-C₄)haloalkyl, phenyl or heteroaryl, which latter two groups are unsubstituted or substituted by one or more radicals selected from the group consisting of halogen, hydroxy, amino, nitro, carboxy, cyano, (C₁-C₄)alkyl, (C₁-C₄)haloalkyl, (C₁-C₄)alkoxy, (C₁-C₄)haloalkoxy, [(C₁-C₄)alkoxy]-carbonyl, (C₁-C₄)alkyl-S(O)ₙ, (C₁-C₄)haloalkyl-S(O)ₙ and in the case of heteroaryl also oxo, wherein heteroaryl is a monocyclic 5 to 7 membered heteroaromatic ring which contains from 1 to 3 hetero atoms selected from the group consisting of N, O and S; n is 0, 1 or 2; m means 4 radicals R¹²³ wherein each independently from each other are same or different; and o means 4 radicals R³²³ wherein each independently from each other are same or different.

Also included as a plant growth regulator, specifically as a plant stimulant, are 3,4-disubstituted maleimide derivatives, or agriculturally acceptable salts thereof, of the formula IV: 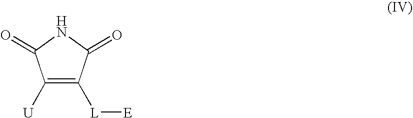
wherein U is aryl or heteroaryl which groups are unsubstituted or substituted; L is NH or a covalent bond; and E is aryl or heteroaryl which groups are unsubstituted or substituted.

The invention also encompasses any stereoisomer, enantiomer, geometric isomer or tautomer, and mixtures of the compounds of formulae (I-IV) and formulae IIa and IIIa.

By the term “agriculturally acceptable salts” is meant salts the anions or cations of which are known and accepted in the art for the formation of salts for agricultural use.

Suitable salts with bases, e.g. formed by compounds of formulae (I-IV) containing a carboxylic acid group, include alkali metal (e.g. sodium and potassium), alkaline earth metal (e.g. calcium and magnesium) and ammonium salts. The ammonium salts include ammonium (NH₄⁺) and ammonium salts of organic amines, (e.g. the diethanolamine, triethanolamine, octylamine, morpholine and dioctylmethylamine salts), and quaternary ammonium salts (NR₄⁺) for example tetramethylammonium.

Suitable acid addition salts, e.g. formed by compounds of formulae (I-IV) containing an amino group, include salts with inorganic acids, for example hydrochlorides, sulphates, phosphates and nitrates and salts with organic acids for example acetic acid.

The aforementioned substituents have the following meanings: The term “aryl” means a carbocyclic aromatic ring system such as phenyl, biphenyl, naphthyl, anthracenyl, phenanthrenyl, fluorenyl, indenyl, pentalenyl, azulenyl, biphenylenyl and the like.

A “heteroaryl” group is a mono-, bi- or polycyclic heteroaromatic ring system in which at least 1 ring contains one or more hetero atoms (preferably 1, 2 or 3 hetero atoms) selected from the group consisting of N, O and S, and which contains a total of 5 to 14 (preferably 5 to 7) ring atoms wherein at least one ring is fully unsaturated (any further rings being unsaturated, or partially or fully hydrogenated). The heteroaryl group is for example pyridyl, pyrimidinyl, pyridazinyl, pyrazinyl, triazinyl, thienyl, thiazolyl, thiadiazolyl, oxazolyl, isoxazolyl, furyl, pyrrolyl, pyrazolyl, imidazolyl, triazolyl, benzothienyl, benzofuranyl, indolyl, isothiazolyl, benzotriazolyl, benzisoxazolyl, isoindolyl, benzoxazolyl, benzimidazolyl, quinolyl, tetrahydroquinolyl, isoquinolyl, dihydroindolyl, benzo[1,4]dioxanyl or 6,7,8,9-tetrahydropyrido[1,2-a]indolyl. The “heteroaryl” group may be unsubstituted or substituted, preferably by one or more radicals (preferably 1, 2 or 3 radicals) selected from the group consisting of halogen, alkoxy, haloalkoxy, alkylthio, haloalkylthio, hydroxy, amino, nitro, carboxy, cyano, alkoxycarbonyl, alkylcarbonyl, formyl, carbamoyl, mono- and dialkylaminocarbonyl, substituted amino such as acylamino, mono- and dialkylamino, and alkylsulfinyl, haloalkylsulfinyl, alkylsulfonyl, haloalkylsulfonyl, alkyl, haloalkyl and oxo. The oxo group can also be present at those hetero ring atoms where various oxidation numbers are possible, for example in the case of N and S.

The radicals alkyl, alkoxy, haloalkyl, haloalkoxy, alkylamino and alkylthio and the corresponding unsaturated and/or substituted radicals can be in each case straight-chain or branched in the carbon skeleton. Unless specifically indicated, the lower carbon skeletons, for example those having 1 to 6 carbon atoms or, in the case of unsaturated groups, 2 to 6 carbon atoms, are preferred for these radicals.

Halogen means fluorine, chlorine, bromine or iodine.

The term “halo” before the name of a radical means that this radical is partially or completely halogenated, that is to say, substituted by F, Cl, Br, or I, in any combination.

The expression “(C₁-C₆)alkyl” an unbranched or branched non-cyclic saturated hydrocarbon radical having 1, 2, 3, 4, 5 or 6 carbon atoms (indicated by a range of C-atoms in the parenthesis), such as, for example a methyl, ethyl, propyl, isopropyl, 1-butyl, 2-butyl, 2-methylpropyl or tert-butyl radical. The same applies to alkyl groups in composite radicals such as “alkoxyalkyl”.

Alkyl radicals and also in composite groups, unless otherwise defined, preferably have 1 to 4 carbon atoms.

“(C₁-C₆)Haloalkyl” means an alkyl group mentioned under the expression “(C₁-C₆)alkyl” in which one or more hydrogen atoms are replaced by the same number of identical or different halogen atoms, such as monohaloalkyl, perhaloalkyl, CF₃, CHF₂, CH₂F, CHFCH₃, CF₃CH₂, CF₃CF₂, CHF₂CF₂, CH₂FCHCl, CH₂Cl, CCl₃, CHCl₂ or CH₂CH₂Cl. “(C₁-C₄)Alkoxy-(C₁-C₆)alkyl” means (C₁-C₆)alkyl which is substituted by (C₁-C₄) alkoxy.

“(C₁-C₆)Alkoxy” means an alkoxy group whose carbon chain has the meaning given under the expression “(C₁-C₆)alkyl”. “Haloalkoxy” is, for example, OCF₃, OCHF₂, OCH₂F, CF₃CF₂O, OCH₂CF₃ or OCH₂CH₂Cl. “(C₁-C₄)Alkoxycarbonyl” means a (C₁-C₄)alkyl ester of a carboxylic acid radical. “(C₁-C₄)Alkylcarbonyl” means a (C₁-C₄)alkyl group which is attached to a carbonyl group, for example acetyl. “N—(C₁-C₆)Alkanoyl-N—(C₁-C₆)alkylamino” means a (C₁-C₆)alkylamino group which is substituted on the N atom by a (C₁-C₆) alkylcarbonyl group, for example N-acetyl-N-methylamino.

“N—(C₁-C₆)Acylamino” means an amino group which is attached to a (C₁-C₆) alkylcarbonyl group, for example acetamido.

“Amino-(C₁-C₆)alkyl” means a (C₁-C₆)alkyl group which is substituted by amino, for example aminopropyl. “N—(C₁-C₆)Alkyl-pyrrolidinyl-(C₁-C₆)alkyl” means a (C₁-C₆)alkyl group which is attached to a N—(C₁-C₆)alkyl-pyrrolidinyl for example 2-(1-methyl-pyrrolidin-2-yl) ethyl. “S-isothiureido(C₁-C₆)alkyl” means a (C₁-C₆)alkyl group which is attached to the S atom of an isothiureido radical, for example 3-(S-isothiureido)propyl.

“(C₂-C₆)Alkenyl” means an unbranched or branched non-cyclic carbon chain having a number of carbon atoms which corresponds to this stated range and which contains at least one double bond which can be located in any position of the respective unsaturated radical. “(C₂-C₆)Alkenyl” denotes, for example, the vinyl, allyl, 2-methyl-2-propenyl, 2-butenyl, pentenyl, 2-methylpentenyl or the hexenyl group.

“(C₂-C₆)Alkynyl” means an unbranched or branched non-cyclic carbon chain having a number of carbon atoms which corresponds to this stated range and which contains one triple bond which can be located in any position of the respective unsaturated radical. “(C₂-C₆)Alkynyl” accordingly denotes, for example, the propargyl, 1-methyl-2-propynyl, 2-butynyl or 3-butynyl group. “(C₃-C₆)Cycloalkyl” denotes monocyclic alkyl radicals, such as the cyclopropyl, cyclobutyl, cyclopentyl or cyclohexyl radical. “(C₃-C₆)Cycloalkylamino-(C₁-C₄)alkyl” means a (C₁-C₄)alkyl group which is substituted by a (C₃-C₆) cydoalkylamino group, for example cyclopropylaminoethyl.

A heterocyclyl radical can be saturated, unsaturated or heteroaromatic; it preferably contains one or more, in particular 1,2 or 3, hetero atoms in the heterocyclic ring, preferably selected from the group consisting of N, O and S; it is preferably an aliphatic heterocyclyl radical having 3 to 7 ring atoms or a heteroaromatic radical having 5 or 6 ring atoms. The heterocyclic radical can be, for example, a heteroaromatic radical or ring (heteroaryl) such as, for example, a mono-, bi- or polycyclic aromatic system in which at least 1 ring contains one or more hetero atoms, for example pyridyl, pyrimidinyl, pyridazinyl, pyrazinyl, triazinyl, thienyl, thiazolyl, thiadiazolyl, oxazolyl, isoxazolyl, furyl, pyrrolyl, pyrazolyl, imidazolyl and triazolyl, or it is a partially or fully hydrogenated radical such as oxiranyl, oxetanyl, oxolanyl (=tetrahydrofuryl), oxanyl, pyrrolidyl, piperidyl, piperazinyl, dioxolanyl, oxazolinyl, isoxazolinyl, oxazolidinyl, isoxazolidinyl and morpholinyl. Suitable substituents for a substituted heterocyclic radical are the substituents stated further below, and additionally also oxo. The oxo group can also be present at those hetero ring atoms where various oxidation numbers are possible, for example in the case of N and S.

Substituted radicals such as a substituted alkyl, alkenyl, alkynyl, aryl, phenyl, benzyl, heterocyclyl and heteroaryl radical are, for example, a substituted radical which is derived from the unsubstituted skeleton, the substituents being, for example, one or more, preferably 1, 2 or 3, radicals selected from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino such as acylamino, mono- and dialkylamino, and alkylsulfinyl, haloalkylsulfinyl, alkylsulfonyl, haloalkylsulfonyl and, in the case of cyclic radicals, also alkyl and haloalkyl.

Processes for preparing plant growth regulators are known in the art. In general, plant growth regulators are described in The Pesticide Manual (Twelfth Edition, C.D.S. Tomlin, Ed.). In particular, processes for preparing paclobutrazol and certain other triazole plant growth regulators are disclosed in U.S. Pat. No. 4,243,405.

Indolinone derivative plant stimulators and processes for preparing the same are described in WO 2005/107466; 3,4-disubstituted maleimide derivatives and processes for preparing them are described in WO 2005/107465; fused azepinone derivatives and processes for preparing the same are described in WO 2005/107471; 2-amino-6-oxypurine derivatives and processes for preparing the same are described in WO 2005/107472.

The terms “class of gibberellins” and “gibberellins” as used herein include a class of diterpenoid compounds derived from four isoprenoid units forming a system of four rings. Included in the definition is ethephon, glycinebetaine, aminocyclopropane-1-carboxylic acid (ACC), and gibberellic acid (GA), generically, and all specific GA, such as GA₁, GA₂, GA₃, GA₄, GA₅, GA₆, GA₇, GA₈, GA₉, GA₁₀, GA₁₁, GA₁₂, GA₁₃, GA₁₄, GA₁₅, GA₁₆, GA₁₇, GA₁₈, GA₁₉, GA₂₀, GA₂₁, GA₂₂, GA₂₃, GA₂₄, GA₂₅, GA₂₆, GA₂₇, GA₂₈, GA₂₉, GA₃₀, GA₃₁, GA₃₂, GA₃₃, GA₃₄, GA₃₅, GA₃₆, GA₃₇, GA₃₈, GA₃₉, GA₄₀, GA₄₁, GA₄₂, GA₄₃, GA₄₄, GA₄₅, GA₄₆, GA₄₇, GA₄₈, GA₄₉, GA₅₀, GA₅₁, GA₅₂, GA₅₃, GA₅₄, GA₅₅, GA₅₆, GA₅₇, GA₅₈, GA₅₈, GA₆₀, GA₆₁, GA₆₂, GA₆₃, GA₆₄, GA₆₅, GA₆₆, GA₆₇, GA₆₈, GA₆₉, GA₇₀, GA₇₁, GA₇₂, GA₇₃, GA₇₄, GA₇₅, GA₇₆, GA₇₇, GA₇₈, GA₇₉, GA₈₀, GA₈₁, GA₈₂, GA₈₃, GA₈₄, GA₈₅, GA₈₆, GA₈₇, GA₈₈, GA₈₉, GA₉₀, GA₉₁, GA₉₂, GA₉₃, GA₉₄, GA₉₅, GA₉₆, GA₉₇, GA₉₈, GA₉₉, GA₁₀₀, GA₁₀₁, GA₁₀₂, GA₁₀₃, GA₁₀₄, GA₁₀₅, GA₁₀₆, GA₁₀₇, GA₁₀₈, GA₁₀₉, GA₁₁₀, and mixtures thereof. The basic structure of gibberellins includes: 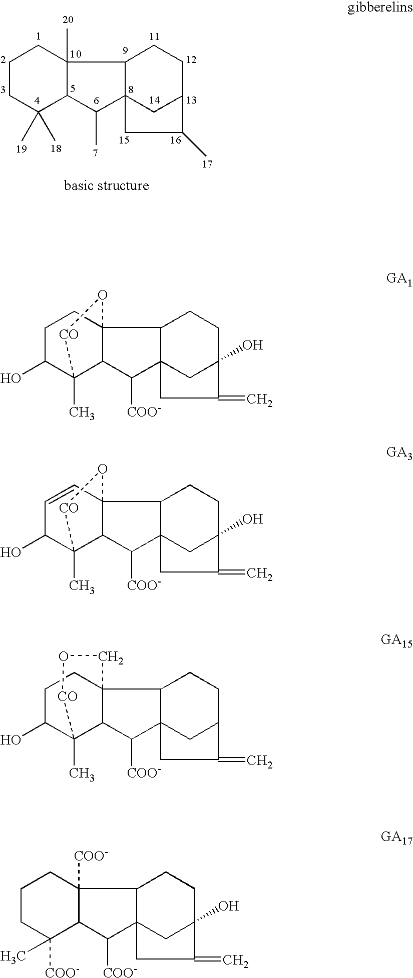
Gibberellins are commercially produced by fermentation of a natural fungus, Gibberella fugikuroi and are available commercially. Preferred gibberellins include GA₃ and GA₇ and mixtures of the various gibberellins.

As used herein, an effective amount of plant growth regulator includes a rate between 0.01 μg/seed and 20 μg/seed. More particularly, an effective amount of plant growth regulator includes between 0.01 μg/seed and 5 μg/seed. Preferably, an effective amount of plant growth regulator includes between 0.01 μg/seed and 2 μg/seed. Even more preferably, an effective amount of plant growth regulator includes between 0.1 μg/seed and 1 μg/seed.

As used herein, an effective amount of gibberellin or gibberellic acid includes a rate between 0.01 μg/seed and 20 μg/seed. More particularly, an effective amount of gibberellin or gibberellic acid includes between 0.01 μg/seed and 5 μg/seed. Preferably, an effective amount of gibberellin or gibberellic acid includes between 0.01 μg/seed and 2 μg/seed. Even more preferably, an effective amount of gibberellin or gibberellic acid includes between 0.1 μg/seed and 1 μg/seed.

Plant activators are defined as agents that activate a plant's natural defense mechanisms (“systemic activated resistance”). Plant activators generally have no independent disease-fighting activity; rather, they stimulate the plant's natural abilities to fight diseases. Examples of plant activators include, but are not limited to, acibenzolar-S-methyl, harpin protein, probenazole, and reynoutria sachalinensis extract (reysa). Preferred plant activators are acibenzolor-S-methyl and harpin.

Plant activators are generally known in the art and are described The Pesticide Manual (Twelfth Edition, C.D.S. Tomlin, Ed.). Processes for preparing plant activators are generally known in the art. Processes for preparing acibenzolar-S-methyl can be found generally in U.S. Pat. No. 5,523,311 and U.S. Pat. No. 5,190,928, both of which are incorporated herein by reference. Processes for isolating harpin are generally known in the art and can be found in “Harpin, Elicitor of the Hypersensitive Response Produced by the Plant Pathogen Erwinia amylovora,” Science 257:85-88 (1992).

As used herein, an effective amount of plant activator includes a rate between 0.01 μg/seed and 20 μg/seed. More particularly, an effective amount of plant activator includes between 0.01 μg/seed and 5 μg/seed. Preferably, an effective amount of plant activator includes between 0.01 μg/seed and 2 μg/seed. Even more preferably, an effective amount of plant activator includes between 0.1 μg/seed and 1 μg/seed.

The compositions of the present invention may contain varying proportions of the plant growth regulator(s) and plant activator(s) active ingredients. A ratio, by weight, of from 99:1 total plant growth regulator to total plant activator to 99:1 total plant activator to total plant growth regulator is contemplated by the present invention. More particularly, a ratio of total plant growth regulator to total plant activator of from 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:45, 64:46, 63:47, 62:48, 61:49, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, 1:99 is included in the scope of the present invention.

When the composition of the present invention is directed to a two-way combination of plant growth regulators or PGRs and gibberellic acid/gibberellins, the compositions may contain varying proportions of the component active ingredients. A ratio, by weight, of from 99:1 component one to component two to 99:1 component two to component one is contemplated by the present invention. More particularly, a ratio of component one to component two of from 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:45, 64:46, 63:47, 62:48, 61:49, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, 1:99 is included in the scope of the present invention.

The three-way ratio of component one/componet two to at least one plant activator may contain varying proportions, as described above for two-way compositions. In such compositions, the ratio of component one/component two is determined first, followed by the ratio of the combination (one/two) to the plant activator, as described above.

The rates of application of the compositions vary according to type of use, but typically for foliar and soil uses 50-1000, preferably 75-500, especially 100-300, g/ha each of plant growth regulator and, optionally, gibberellic acid/gibberellin; 50-1000, preferably 250-750 g/ha of plant activator; 50-1000, preferably 75-500, especially 100-300, g/ha of each additional (optional) pesticide are applied; while for treatment of plant propagation material, particularly for seed treatment, the application rates range from 0.01-20 microgram per seed preferably, especially 1 to 10 microgram/per seed each of plant growth regulator and, optionally, gibberellin; 0.01 microgram to 20 micrograms per seed, and preferably 0.01 to 5 microgram per seed of plant activator; 1-100, preferably 5-50, especially 5-20 g/100 kg of seeds of each additional (optional) pesticide. When gibberellic acid is optionally applied to the seed prior to planting, the rate of application ranges from 0.01 to 20 micrograms/seed. If the plant activator(s) is applied post emergence to a seed pre-treated with at least one plant growth regulator, then the rate of total plant activator is 100-750 g/ha.

Preferred combinations of at least one plant growth regulator and at least one plant activator of the present invention include paclobutrazole, cyproconazole, uniconazole, tetcyclacis, trinexapac, and gibberellic acid (GA), particularly GA(3) in combination with at least one of acibenzalor-S-methyl and harpin. The following charts are used to define the preferred active ingredients used in the combinations of the present invention.

CHART 1
Plant Growth Regulators

| A1 | A2 | A3 | A4 | A5 | A6 | A7 |
|---|---|---|---|---|---|---|
| Paclobutrazole | Cyproconazole | Uniconazole | Tetcyclacis | Trinexapac | GA | GA(3) |

CHART 2
Plant Activators

| B1 | B2 |
|---|---|
| Acibenzalor-S-methyl | harpin |

Specifically contemplated combinations include but are not limited to the following combinations: A1+B1; A1+B2; A2+B1; A2+B2; A3+B1; A3+B2; A4+B1; A4+B2; A5+B1; A5+B2; A6+B1; A6+B2; A7+B1; and A7+B2. Preferred combinations include A1+B1; A1+B2; A2+B1; A2+B2; A6+B1; A6+B2; A7+B1; A7+B2. Particularly preferred combinations include A1+B1; A1+B2; A6+B1; A6+B2; A7+B1; A7+B2.

The combinations of the present invention may further comprise additional active ingredient pesticides. Examples of pesticides include those selected from, for example and not for limitation, insecticides, acaricides, bactericides, fungicides, nematicides and molluscicides.

Suitable additions of insecticidally, acaricidally, nematicidally, or molluscicidally active ingredients are, for example and not for limitation, representatives of the following classes of active ingredients: organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. Especially preferred components in mixtures are abamectin, cyanoimine, acetamiprid, thiodicarb, nitromethylene, nitenpyram, clothianidin, dinotefuran, fipronil, lufenuron, pyripfoxyfen, thiacloprid, fluxofenime; imidacloprid, thiamethoxam, Chloranthraniliprole, beta cyfluthrin, lambda cyhalothrin, fenoxycarb, diafenthiuron, pymetrozine, diazinon, disulphoton; profenofos, furathiocarb, cyromazin, cypermethrin, tau-fluvalinate, tefluthrin or Bacillus thuringiensis products, very especially abamectin, thiodicarb, cyanoimine, acetamiprid, nitromethylene, nitenpyram, clothianidin, dinotefuran, fipronil, thiacloprid, imidacloprid, thiamethoxam, Chloranthraniliprole, beta cyfluthrin, lambda cyhalothrin, and tefluthrin.

Preferred insecticidally, acaricidally, nematicidally, or molluscicidally active ingredients are, for example and not for limitation:

CHART 3
Insecticidally, Acaricidally, Nematicidally, Or Molluscicidally Active
Ingredients

| | |
|---|---|
| C1 | Thiamethoxam |
| C2 | Imidacloprid |
| C3 | Thiacloprid |
| C4 | Clothianidin |
| C5 | Chloranthraniliprole |
| C6 | Thiodicarb |
| C7 | Abamectin |
| C8 | Acetamidprid |
| C9 | Fipronil |
| C10 | Tefluthrin |
| C11 | Lambda cyhalothrin |
| C12 | Beta cyfluthrin |

Using the designations provided in Chart 1 and Chart 2 for the PGR and the plant activator, respectively, and using the designations provided in Chart 3 for the insecticidally, acaricidally, nematicidally or molluscicidally active compounds, the following combinations of at least one plant growth regulator and at least one plant activator in combination with at least one additional insecticidally, acaricidally, nematicidally, or molluscicidally pesticide include, but are not limited to: A1+B1+C1; A1+B2+C1; A2+B1+C1; A2+B2+C1; A3+B1+C1; A3+B2+C1; A4+B1+C1; A4+B2+C1; A5+B1+C1; A5+B2+C1; A6+B1+C1; A6+B2+C1; A7+B1+C1; and A7+B2+C1; A1+B1+C2; A1+B2+C2; A2+B1+C2; A2+B2+C2; A3+B1+C2; A3+B2+C2; A4+B1+C2; A4+B2+C2; A5+B1+C2; A5+B2+C2; A6+B1+C2; A6+B2+C2; A7+B1+C2; and A7+B2+C2; A1+B1+C3; A1+B2+C3; A2+B1+C3; A2+B2+C3; A3+B1+C3; A3+B2+C3; A4+B1+C3; A4+B2+C3; A5+B1+C3; A5+B2+C3; A6+B1+C3; A6+B2+C3; A7+B1+C3; and A7+B2+C3; A1+B1+C4; A1+B2+C4; A2+B1+C4; A2+B2+C4; A3+B1+C4; A3+B2+C4; A4+B1+C4; A4+B2+C4; A5+B1+C4; A5+B2+C4; A6+B1+C4; A6+B2+C4; A7+B1+C4; and A7+B2+C4; A1+B1+C5; A1+B2+C5; A2+B1+C5; A2+B2+C5; A3+B1+C5; A3+B2+C5; A4+B1+C5; A4+B2+C5; A5+B1+C5; A5+B2+C5; A6+B1+C5; A6+B2+C5; A7+B1+C5; and A7+B2+C5; A1+B1+C6; A1+B2+C6; A2+B1+C6; A2+B2+C6; A3+B1+C6; A3+B2+C6; A4+B1+C6; A4+B2+C6; A5+B1+C6; A5+B2+C6; A6+B1+C6; A6+B2+C6; A7+B1+C6; and A7+B2+C6; A1+B1+C7; A1+B2+C7; A2+B1+C7; A2+B2+C7; A3+B1+C7; A3+B2+C7; A4+B1+C7; A4+B2+C7; A5+B1+C7; A5+B2+C7; A6+B1+C7; A6+B2+C7; A7+B1+C7; and A7+B2+C7; A1+B1+C8; A1+B2+C8; A2+B1+C8; A2+B2+C8; A3+B1+C8; A3+B2+C8; A4+B1+C8; A4+B2+C8; A5+B1+C8; A5+B2+C8; A6+B1+C8; A6+B2+C8; A7+B1+C8; and A7+B2+C8; A1+B1+C9; A1+B2+C9; A2+B1+C9; A2+B2+C9; A3+B1+C9; A3+B2+C9; A4+B1+C9; A4+B2+C9; A5+B1+C9; A5+B2+C9; A6+B1+C9; A6+B2+C9; A7+B1+C9; and A7+B2+C9; A1+B1+C10; A1+B2+C10; A2+B1+C10; A2+B2+C10; A3+B1+C10; A3+B2+C10; A4+B1+C10; A4+B2+C10; A5+B1+C10; A5+B2+C10; A6+B1+C10; A6+B2+C10; A7+B1+C10; and A7+B2+C10; A1+B1+C11; AL +B2+C11; A2+B1+C11; A2+B2+C11; A3+B1+C11; A3+B2+C11; A4+B1+C11; A4+B2+C11; A5+B1+C11; A5+B2+C11; A6+B1+C11; A6+B2+C11; A7+B1+C11; and A7+B2+C11; A1+B1+C12; A1+B2+C12; A2+B1+C12; A2+B2+C12; A3+B1+C12; A3+B2+C12; A4+B1+C12; A4+B2+C12; A5+B1+C12; A5+B2+C12; A6+B1+C12; A6+B2+C12; A7+B1+C12; and A7+B2+C12; A1+B1+C1+C7; A1+B2+C1+C7; A2+B1+C1+C7; A2+B2+C1+C7; A3+B1+C1+C7; A3+B2+C1+C7; A4+B1+C1+C7; A4+B2+C1+C7; A5+B1+C1+C7; A5+B2+C1+C7; A6+B1+C1+C7; A6+B2+C1+C7; A7+B1+C1+C7; and A7+B2+C1+C7.

Preferred combinations of at least one PGR, at least one plant activator and at least one insecticide, nematicide, acaricide or molluscicide include A1+B1+C1; A1+B2+C1; A2+B1+C1; A2+B2+C1; A6+B1+C1; A6+B2+C1; A7+B1+C1; A7+B2+C1; A1+B1+C7; A1+B2+C7; A2+B1+C7; A2+B2+C7; A6+B1+C7; A6+B2+C7; A7+B1+C7; A7+B2+C7. Particularly preferred combinations include A1+B1+C1; A1+B2+C1; A6+B1+C1; A6+B2+C1; A7+B1+C1; A7+B2+C1; A1+B1+C7; A1+B2+C7; A6+B1+C7; A6+B2+C7; A7+B1+C7; A7+B2+C7.

Suitable additions of fungicidally active ingredients are, for example and not for limitation, representatives of the following classes of active ingredients: strobilurins, triazoles, ortho-cyclopropyl-carboxanilide derivatives, phenylpyrroles, and systemic fungicides. Examples of suitable additions of fungicidally active ingredients include, but are not limited to, the following compounds: azoxystrobin; bitertanol; carboxin; Cu₂O; cymoxanil; cyproconazole; cyprodinil; dichlofluamid; difenoconazole; diniconazole; epoxiconazole; fenpiclonil; fludioxonil; fluoxastrobin, fluquiconazole; flusilazole; flutriafol; furalaxyl; guazatin; hexaconazole; hymexazol; imazalil; imibenconazole; ipconazole; kresoxim-methyl; mancozeb; metalaxyl; mefenoxam; metconazole; myclobutanil, oxadixyl, pefurazoate; penconazole; pencycuron; prochloraz; propiconazole; pyroquilone; (±)-cis-1-(4-chlorophenyl)-2-(1H-1,2,4-triazol-1-yl)cycloheptanol; spiroxamin; tebuconazole; thiabendazole; tolifluamide; triazoxide; triadimefon; triadimenol; trifloxystrobin, triflumizole; triticonazole and uniconazole. Particularly preferred fungicidally active agents include azoxystrobin, difenoconazole, fludioxonil, thiabendazole, tebuconazole, metalaxyl, mefenoxam, myclobutanil, fluoxastrobin, tritaxonazole, and trifloxystrobin. Ortho-cyclopropyl-carboxanilide derivatives include, but are not limited to, compounds, stereoisomers, and mixtures of stereoisomers of the formulae: 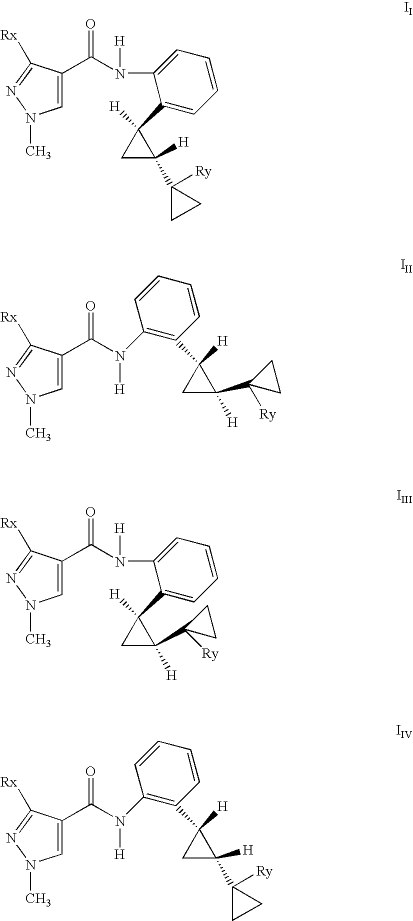
wherein
Rₓ is trifluoromethyl or difluoromethyl and
R_{y} is hydrogen or methyl; or a tautomer of such a compound. Particularly preferred are compounds wherein the content of racemic compounds represents a racemic mixture of compounds of formula I_{I}, wherein Rₓ is difluoromethyl and R_{y} is hydrogen, and compounds of formula I_{II}, wherein Rₓ is difluoromethyl and R_{y} is hydrogen, is from 65 to 99% by weight.

Chart 3 provides designations for some preferred fungicides useful in combination with at least one plant growth regulator and at least one plant activator.

CHART 4
Fungicides useful in Combinations with at least one PGR and at least
one PA

| | |
|---|---|
| D1 | Fludioxonil |
| D2 | R-metalaxyl or metalaxyl |
| D3 | Fludioxonil + R-metalaxyl |
| | or metalaxyl |
| D4 | Azoxystrobin |
| D5 | Fluoxastrobin |
| D6 | Trifloxystrobin |
| D7 | Tebuconazole |
| D8 | Thiabendazole |
| D9 | Myclobutanil |
| D10 | Ortho-cyclopropyl- |
| | carboxanilide derivatives |
| | of formula I_{(I)} − I_{(IV)} |
| D11 | Difenoconazole |
| D12 | Tritaconazole |
| D13 | Azoxystrobin + |
| | Fludioxonil + R- |
| | Metalaxyl or metalaxyl |
| D14 | Azoxystrobin + |
| | Fludioxonil + R- |
| | Metalaxyl or metalaxyl + |
| | Myclobutanil |
| D15 | Azoxystrobin + |
| | Fludioxonil + R- |
| | Metalaxyl or metalaxyl + |
| | difenoconazole |
| D16 | Azoxystrobin + |
| | Fludioxonil + R- |
| | Metalaxyl or metalaxyl + |
| | thiabendazole |

Preferred combinations of at least one plant growth regulator (chart 1) and at least one plant activator (chart 2) in combination with one or more additional fungicides (chart 4) include but are not limited to:

A1+B1+D1; A1+B2+D1; A2+B1+D1; A2+B2+D1; A3+B1+D1; A3+B2+D1; A4+B1+D1; A4+B2+D1; A5+B1+D1; A5+B2+D1; A6+B1+D1; A6+B2+D1; A7+B1+D1; and A7+B2+D1; A1+B1+D2; A1+B2+D2; A2+B1+D2; A2+B2+D2; A3+B1+D2; A3+B2+D2; A4+B1+D2; A4+B2+D2; A5+B1+D2; A5+B2+D2; A6+B1+D2; A6+B2+D2; A7+B1+D2; and A7+B2+D2; A1+B1+D3; A1+B2+D3; A2+B1+D3; A2+B2+D3; A3+B1+D3; A3+B2+D3; A4+B1+D3; A4+B2+D3; A5+B1+D3; A5+B2+D3; A6+B1+D3; A6+B2+D3; A7+B1+D3; and A7+B2+D3; A1+B1+D4; A1+B2+D4; A2+B1+D4; A2+B2+D4; A3+B1+D4; A3+B2+D4; A4+B1+D4; A4+B2+D4; A5+B1+D4; A5+B2+D4; A6+B1+D4; A6+B2+D4; A7+B1+D4; and A7+B2+D4; A1+B1+D5; A1+B2+D5; A2+B1+D5; A2+B2+D5; A3+B1+D5; A3+B2+D5; A4+B1+D5; A4+B2+D5; A5+B1+D5; A5+B2+D5; A6+B1+D5; A6+B2+D5; A7+B1+D5; and A7+B2+D5; A1+B1+D6; A1+B2+D6; A2+B1+D6; A2+B2+D6; A3+B1+D6; A3+B2+D6; A4+B1+D6; A4+B2+D6; A5+B1+D6; A5+B2+D6; A6+B1+D6; A6+B2+D6; A7+B1+D6; and A7+B2+D6; A1+B1+D7; A1+B2+D7; A2+B1+D7; A2+B2+D7; A3+B1+D7; A3+B2+D7; A4+B1+D7; A4+B2+D7; A5+B1+D7; A5+B2+D7; A6+B1+D7; A6+B2+D7; A7+B1+D7; and A7+B2+D7; A1+B1+D8; A1+B2+D8; A2+B1+D8; A2+B2+D8; A3+B1+D8; A3+B2+D8; A4+B1+D8; A4+B2+D8; A5+B1+D8; A5+B2+D8; A6+B1+D8; A6+B2+D8; A7+B1+D8;and A7+B2+D8; A1+B1+D9; A1+B2+D9; A2+B1+D9; A2+B2+D9; A3+B1+D9; A3+B2+D9; A4+B1+D9; A4+B2+D9; A5+B1+D9; A5+B2+D9; A6+B1+D9; A6+B2+D9; A7+B1+D9; and A7+B2+D9; A1+B1+D10; A1+B2+D10; A2+B1+D10; A2+B2+D10; A3+B1+D10; A3+B2+D10; A4+B1+D10; A4+B2+D10; A5+B1+D10; A5+B2+D10; A6+B1+D10; A6+B2+D10; A7+B1+D10; and A7+B2+D10; A1+B1+D1l; A1+B2+D11; A2+B1+D11; A2+B2+D11; A3+B1+D11; A3+B2+D11; A4+B1+D11; A4+B2+D11; A5+B1+D11; A5+B2+D11; A6+B1+D11; A6+B2+D11; A7+B1+D11; and A7+B2+D11; A1+B1+D12; A1+B2+D12; A2+B1+D12; A2+B2+D12; A3+B1+D12; A3+B2+D12; A4+B1+D12; A4+B2+D12; A5+B1+D12; A5+B2+D12; A6+B1+D12; A6+B2+D12; A7+B1+D12;and A7+B2+D12; A1+B1+D13; A1+B2+D13; A2+B1+D13; A2+B2+D13; A3+B1+D13; A3+B2+D13; A4+B1+D13; A4+B2+D13; A5+B1+D13; A5+B2+D13; A6+B1+D13; A6+B2+D13; A7+B1+D13; and A7+B2+D13; A1+B1+D14; A1+B2+D14; A2+B1+D14; A2+B2+D14; A3+B1+D14; A3+B2+D14; A4+B1+D14; A4+B2+D14; A5+B1+D14; A5+B2+D14; A6+B1+D14; A6+B2+D14; A7+B1+D14; and A7+B2+D14; A1+B1+D15; A1+B2+D15; A2+B1+D15; A2+B2+D15; A3+B1+D15; A3+B2+D15; A4+B1+D15; A4+B2+D15; A5+B1+D15; A5+B2+D15; A6+B1+D15; A6+B2+D15; A7+B1+D15; and A7+B2+D15; A1+B1+D16; A1+B2+D16; A2+B1+D16; A2+B2+D16; A3+B1+D16; A3+B2+D16; A4+B1+D16; A4+B2+D16; A5+B1+D16; A5+B2+D16; A6+B1+D16; A6+B2+D16; A7+B1+D16;and A7+B2+D16.

Particularly preferred combinations include A1+B1+D1; A1+B2+D1; A2+B1+D1; A2+B2+D1; A6+B1+D1; A6+B2+D1; A7+B1+D1; A7+B2+D1; A1+B1+D2; A1+B2+D2; A2+B1+D2; A2+B2+D2; A6+B1+D2; A6+B2+D2; A7+B1+D2; A7+B2+D2; A1+B1+D3; A1+B2+D3; A2+B1+D3; A2+B2+D3; A6+B1+D3; A6+B2+D3; A7+B1+D3; A7+B2+D3; A1+B1+D4; A1+B2+D4; A2+B1+D4; A2+B2+D4; A6+B1+D4; A6+B2+D4; A7+B1+D4; A7+B2+D4; A1+B1+D13; A1+B2+D13; A2+B1+D13; A2+B2+D13; A6+B1+D13; A6+B2+D13; A7+B1+D13; A7+B2+D13. More particularly preferred combinations include A1+B1+D1; A1+B2+D1; A6+B1+D1; A6+B2+D1; A7+B1+D1; A7+B2+D1; A1+B1+D2; A1+B2+D2; A6+B1+D2; A6+B2+D2; A7+B1+D2; A7+B2+D2; A1+B1+D3; A1+B2+D3; A6+B1+D3; A6+B2+D3; A7+B1+D3; A7+B2+D3; A1+B1+D4; A1+B2+D4; A6+B1+D4; A6+B2+D4; A7+B1+D4; A7+B2+D4; A1+B1+D13; A1+B2+D13; A6+B1+D13; A6+B2+D13; A7+B1+D13; A7+B2+D13.

The present inventions further provides for combinations of at least one plant growth regulator (chart 1), at least one plant activator (chart 2), at least one additional insecticide, acaracide, nematicide, or molluscicide (chart 3) and at least one additional fungicide (chart 4). Preferred combinations include but are not limited to: A1+B1+C1+D1; A1+B2+C1+D1; A2+B1+C1+D1; A2+B2+C1+D1; A3+B1+C1+D1; A3+B2+C1+D1; A4+B1+C1+D1; A4+B2+C1+D1; A5+B1+C1+D1; A5+B2+C1+D1; A6+B1+C1+D1; A6+B2+C1+D1; A7+B1+C1+D1; and A7+B2+C1+D1; A1+B1+C2+D1; A1+B2+C2+D1; A2+B1+C2+D1; A2+B2+C2+D1; A3+B1+C2+D1; A3+B2+C2+D1; A4+B1+C2+D1; A4+B2+C2+D1; A5+B1+C2+D1; A5+B2+C2+D1; A6+B1+C2+D1; A6+B2+C2+D1; A7+B1+C2+D1; and A7+B2+C2+D1; A1+B1+C3+D1; A1+B2+C3+D1; A2+B1+C3+D1; A2+B2+C3+D1; A3+B1+C3+D1; A3+B2+C3+D1; A4+B1+C3+D1; A4+B2+C3+D1; A5+B1+C3+D1; A5+B2+C3+D1; A6+B1+C3+D1; A6+B2+C3+D1; A7+B1+C3+D1; and A7+B2+C3+D1; A1+B1+C4+D1; A1+B2+C4+D1; A2+B1+C4+D1; A2+B2+C4+D1; A3+B1+C4+D1; A3+B2+C4+D1; A4+B1+C4+D1; A4+B2+C4+D1; A5+B1+C4+D1; A5+B2+C4+D1; A6+B1+C4+D1; A6+B2+C4+D1; A7+B1+C4+D1; and A7+B2+C4+D1; A1+B1+C5+D1; A1+B2+C5+D1; A2+B1+C5+D1; A2+B2+CS +D1; A3+B1+C5+D1; A3+B2+C5+D1; A4+B1+C5+D1; A4+B2+C5+D1; A5+B1+C5+D1; A5+B2+C5+D1; A6+B1+C5+D1; A6+B2+C5+D1; A7+B1+C5+D1; and A7+B2+C5+D1; A1+B1+C6+D1; A1+B2+C6+D1; A2+B1+C6+D1; A2+B2+C6+D1; A3+B1+C6+D1; A3+B2+C6+D1; A4+B1+C6+D1; A4+B2+C6+D1; A5+B1+C6+D1; A5+B2+C6+D1; A6+B1+C6+D1; A6+B2+C6+D1; A7+B1+C6+D1; and A7+B2+C6+D1; A1+B1+C7+D1; A1+B2+C7+D1; A2+B1+C7+D1; A2+B2+C7+D1; A3+B1+C7+D1; A3+B2+C7+D1; A4+B1+C7+D1; A4+B2+C7+D1; A5+B1+C7+D1; A5+B2+C7+D1; A6+B1+C7+D1; A6+B2+C7+D1; A7+B1+C7+D1; and A7+B2+C7+D1; A1+B1+C8+D1; A1+B2+C8+D1; A2+B1+C8+D1; A2+B2+C8+D1; A3+B1+C8+D1; A3+B2+C8+D1; A4+B1+C8+D1; A4+B2+C8+D1; A5+B1+C8+D1; A5+B2+C8+D1; A6+B1+C8+D1; A6+B2+C8+D1; A7+B1+C8+D1; and A7+B2+C8+D1; A1+B1+C9+D1; A1+B2+C9+D1; A2+B1+C9+D1; A2+B2+C9+D1; A3+B1+C9+D1; A3+B2+C9+D1; A4+B1+C9+D1; A4+B2+C9+D1; A5+B1+C9+D1; A5+B2+C9+D1; A6+B1+C9+D1; A6+B2+C9+D1; A7+B1+C9+D1; and A7+B2+C9+D1; A1+B1+C10+D1; A1+B2+C10+D1; A2+B1+C10+D1; A2+B2+C10+D1; A3+B1+C10+D1; A3+B2+C10+D1; A4+B1+C10+D1; A4+B2+C10+D1; A5+B1+C10+D1; A5+B2+C10+D1; A6+B1+C10+D1; A6+B2+C10+D1; A7+B1+C10+D1; and A7+B2+C10+D1; A1+B1+C11+D1; A1+B2+C11+D1; A2+B1+C11+D1; A2+B2+C11+D1; A3+B1+C11+D1; A3+B2+C11+D1; A4+B1+C11+D1; A4+B2+C11+D1; A5+B1+C11+D1; A5+B2+C11+D1; A6+B1+C11; A6+B2+C I +D1; A7+B1+C1+D1; and A7+B2+C11+D1; A1+B1+C12+D1; A1+B2+C12+D1; A2+B1+C12+D1; A2+B2+C12+D1; A3+B1+C12+D1; A3+B2+C12+D1; A4+B1+C12+D1; A4+B2+C12+D1; A5+B1+C12+D1; A5+B2+C12+D1; A6+B1+C12+D1; A6+B2+C12+D1; A7+B1+C12+D1; and A7+B2+C12+D1; A1+B1+C1+D2; A1+B2+C1+D2; A2+B1+C1+D2; A2+B2+C1+D2; A3+B1+C1+D2; A3+B2+C1+D2; A4+B1+C1+D2; A4+B2+C1+D2; A5+B1+C1+D2; A5+B2+C1+D2; A6+B1+C1+D2; A6+B2+C1+D2; A7+B1+C1+D2; and A7+B2+C1+D2; A1+B1+C2+D2; A1+B2+C2+D2; A2+B1+C2+D2; A2+B2+C2+D2; A3+B1+C2+D2; A3+B2+C2+D2; A4+B1+C2+D2; A4+B2+C2+D2; A5+B1+C2+D2; A5+B2+C2+D2; A6+B1+C2+D2; A6+B2+C2+D2; A7+B1+C2+D2; and A7+B2+C2+D2; A1+B1+C3+D2; A1+B2+C3+D2; A2+B1+C3+D2; A2+B2+C3+D2; A3+B1+C3+D2; A3+B2+C3+D2; A4+B1+C3+D2; A4+B2+C3+D2; A5+B1+C3+D2; A5+B2+C3+D2; A6+B1+C3+D2; A6+B2+C3+D2; A7+B1+C3+D2; and A7+B2+C3+D2; A1+B1+C4+D2; A1+B2+C4+D2; A2+B1+C4+D2; A2+B2+C4+D2; A3+B1+C4+D2; A3+B2+C4+D2; A4+B1+C4+D2; A4+B2+C4+D2; A5+B1+C4+D2; A5+B2+C4+D2; A6+B1+C4+D2; A6+B2+C4+D2; A7+B1+C4+D2; and A7+B2+C4+D2; A1+B1+C5+D2; A1+B2+C5+D2; A2+B1+C5+D2; A2+B2+C5+D2; A3+B1+C5+D2; A3+B2+C5+D2; A4+B1+C5+D2; A4+B2+C5+D2; A5+B1+C5+D2; A5+B2+C5+D2; A6+B1+C5+D2; A6+B2+C5+D2; A7+B1+C5+D2; and A7+B2+C5+D2; A1+B1+C6+D2; A1+B2+C6+D2; A2+B1+C6+D2; A2+B2+C6+D2; A3+B1+C6+D2; A3+B2+C6+D2; A4+B1+C6+D2; A4+B2+C6+D2; A5+B1+C6+D2; A5+B2+C6+D2; A6+B1+C6+D2; A6+B2+C6+D2; A7+B1+C6+D2; and A7+B2+C6+D2; A1+B1+C7+D2; A1+B2+C7+D2; A2+B1+C7+D2; A2+B2+C7+D2; A3+B1+C7+D2; A3+B2+C7+D2; A4+B1+C7+D2; A4+B2+C7+D2; A5+B1+C7+D2; A5+B2+C7+D2; A6+B1+C7+D2; A6+B2+C7+D2; A7+B1+C7+D2; and A7+B2+C7+D2; A1+B1+C8+D2; A1+B2+C8+D2; A2+B1+C8+D2; A2+B2+C8+D2; A3+B1+C8+D2; A3+B2+C8+D2; A4+B1+C8+D2; A4+B2+C8+D2; A5+B1+C8+D2; A5+B2+C8+D2; A6+B1+C8+D2; A6+B2+C8+D2; A7+B1+C8+D2; and A7+B2+C8+D2; A1+B1+C9+D2; A1+B2+C9+D2; A2+B1+C9+D2; A2+B2+C9+D2; A3+B1+C9+D2; A3+B2+C9+D2; A4+B1+C9+D2; A4+B2+C9+D2; A5+B1+C9+D2; A5+B2+C9+D2; A6+B1+C9+D2; A6+B2+C9+D2; A7+B1+C9+D2; and A7+B2+C9+D2; A1+B1+C10+D2; A1+B2+C10+D2; A2+B1+C10+D2; A2+B2+C10+D2; A3+B1+C10+D2; A3+B2+C10+D2; A4+B1+C10+D2; A4+B2+C10+D2; A5+B1+C10+D2; A5+B2+C10+D2; A6+B1+C10+D2; A6+B2+C10+D2; A7+B1+C10+D2; and A7+B2+C10+D2; A1+B1+C11+D2; A1+B2+C11+D2; A2+B1+C11+D2; A2+B2+C11+D2; A3+B1+C11+D2; A3+B2+C11+D2; A4+B1+C11+D2; A4+B2+C11+D2; A5+B1+C11+D2; A5+B2+C11+D2; A6+B1+C11; A6+B2+C11+D2; A7+B1+C11+D2; and A7+B2+C11+D2; A1+B1+C12+D2; A1+B2+C12+D2; A2+B1+C12+D2; A2+B2+C12+D2; A3+B1+C12+D2; A3+B2+C12+D2; A4+B1+C12+D2; A4+B2+C12+D2; A5+B1+C12+D2; A5+B2+C12+D2; A6+B1+C12+D2; A6+B2+C12+D2; A7+B1+C12+D2; and A7+B2+C12+D2; A1+B1+C1+D3; A1+B2+C1+D3; A2+B1+C1+D3; A2+B2+C1+D3; A3+B1+C1+D3; A3+B2+C1+D3; A4+B1+C1+D3; A4+B2+C1+D3; A5+B1+C1+D3; A5+B2+C1+D3; A6+B1+C1+D3; A6+B2+C1+D3; A7+B1+C1+D3; and A7+B2+C1+D3; A1+B1+C2+D3; A1+B2+C2+D3; A2+B1+C2+D3; A2+B2+C2+D3; A3+B1+C2+D3; A3+B2+C2+D3; A4+B1+C2+D3; A4+B2+C2+D3; A5+B1+C2+D3; A5+B2+C2+D3; A6+B1+C2+D3; A6+B2+C2+D3; A7+B1+C2+D3; and A7+B2+C2+D3; A1+B1+C3+D3; A1+B2+C3+D3; A2+B1+C3+D3; A2+B2+C3+D3; A3+B1+C3+D3; A3+B2+C3+D3; A4+B1+C3+D3; A4+B2+C3+D3; A5+B1+C3+D3; A5+B2+C3+D3; A6+B1+C3+D3; A6+B2+C3+D3; A7+B1+C3+D3; and A7+B2+C3+D3; A1+B1+C4+D3; A1+B2+C4+D3; A2+B1+C4+D3; A2+B2+C4+D3; A3+B1+C4+D3; A3+B2+C4+D3; A4+B1+C4+D3; A4+B2+C4+D3; A5+B1+C4+D3; A5+B2+C4+D3; A6+B1+C4+D3; A6+B2+C4+D3; A7+B1+C4+D3; and A7+B2+C4+D3; A1+B1+C5+D3; A1+B2+C5+D3; A2+B1+C5+D3; A2+B2+C5+D3; A3+B1+C5+D3; A3+B2+C5+D3; A4+B1+C5+D3; A4+B2+C5+D3; A5+B1+C5+D3; A5+B2+C5+D3; A6+B1+C5+D3; A6+B2+C5+D3; A7+B1+C5+D3; and A7+B2+C5+D3; A1+B1+C6+D3; A1+B2+C6+D3; A2+B1+C6+D3; A2+B2+C6+D3; A3+B1+C6+D3; A3+B2+C6+D3; A4+B1+C6+D3; A4+B2+C6+D3; A5+B1+C6+D3; A5+B2+C6+D3; A6+B1+C6+D3; A6+B2+C6+D3; A7+B1+C6+D3; andA7+B2+C6+D3; A1+B1+C7+D3; A1+B2+C7+D3; A2+B1+C7+D3; A2+B2+C7+D3; A3+B1+C7+D3; A3+B2+C7+D3; A4+B1+C7+D3; A4+B2+C7+D3; A5+B1+C7+D3; A5+B2+C7+D3; A6+B1+C7+D3; A6+B2+C7+D3; A7+B1+C7+D3; and A7+B2+C7+D3; A1+B1+C8+D3; A1+B2+C8+D3; A2+B1+C8+D3; A2+B2+C8+D3; A3+B1+C8+D3; A3+B2+C8+D3; A4+B1+C8+D3; A4+B2+C8+D3; A5+B1+C8+D3; A5+B2+C8+D3; A6+B1+C8+D3; A6+B2+C8+D3; A7+B1+C8+D3; and A7+B2+C8+D3; A1+B1+C9+D3; A1+B2+C9+D3; A2+B1+C9+D3; A2+B2+C9+D3; A3+B1+C9+D3; A3+B2+C9+D3; A4+B1+C9+D3; A4+B2+C9+D3; A5+B1+C9+D3; A5+B2+C9+D3; A6+B1+C9+D3; A6+B2+C9+D3; A7+B1+C9+D3; and A7+B2+C9+D3; A1+B1+C10+D3; A1+B2+C10+D3; A2+B1+C10+D3; A2+B2+C10+D3; A3+B1+C10+D3; A3+B2+C10+D3; A4+B1+C10+D3; A4+B2+C10+D3; A5+B1+C10+D3; A5+B2+C10+D3; A6+B1+C10+D3; A6+B2+C10+D3; A7+B1+C10+D3; and A7+B2+C10+D3; A1+B1+C11+D3; A1+B2+C11+D3; A2+B1+C11+D3; A2+B2+C11+D3; A3+B1+C11+D3; A3+B2+C11+D3; A4+B1+C11+D3; A4+B2+C11+D3; A5+B1+C11+D3; A5+B2+C11+D3; A6+B1+C11; A6+B2+C11+D3; A7+B1+C11+D3; and A7+B2+C11+D3; A1+B1+C12+D3; A1+B2+C12+D3; A2+B1+C12+D3; A2+B2+C12+D3; A3+B1+C12+D3; A3+B2+C12+D3; A4+B1+C12+D3; A4+B2+C12+D3; A5+B1+C12+D3; A5+B2+C12+D3; A6+B1+C12+D3; A6+B2+C12+D3; A7+B1+C12+D3; and A7+B2+C12+D3; A1+B1+C1+D4; A1+B2+C1+D4; A2+B1+C1+D4; A2+B2+C1+D4; A3+B1+C1+D4; A3+B2+C1+D4; A4+B1+C1+D4; A4+B2+C1+D4; A5+B1+C1+D4; A5+B2+C1+D4; A6+B1+C1+D4; A6+B2+C1+D4; A7+B1+C1+D4; and A7+B2+C1+D4; A1+B1+C2+D4; A1+B2+C2+D4; A2+B1+C2+D4; A2+B2+C2+D4; A3+B1+C2+D4; A3+B2+C2+D4; A4+B1+C2+D4; A4+B2+C2+D4; A5+B1+C2+D4; A5+B2+C2+D4; A6+B1+C2+D4; A6+B2+C2+D4; A7+B1+C2+D4; and A7+B2+C2+D4; A1+B1+C3+D4; A1+B2+C3+D4; A2+B1+C3+D4; A2+B2+C3+D4; A3+B1+C3+D4; A3+B2+C3+D4; A4+B1+C3+D4; A4+B2+C3+D4; A5+B1+C3+D4; A5+B2+C3+D4; A6+B1+C3+D4; A6+B2+C3+D4; A7+B1+C3+D4; and A7+B2+C3+D4; A1+B1+C4+D4; A1+B2+C4+D4; A2+B1+C4+D4; A2+B2+C4+D4; A3+B1+C4+D4; A3+B2+C4+D4; A4+B1+C4+D4; A4+B2+C4+D4; A5+B1+C4+D4; A5+B2+C4+D4; A6+B1+C4+D4; A6+B2+C4+D4; A7+B1+C4+D4; and A7+B2+C4+D4; A1+B1+C5+D4; A1+B2+C5+D4; A2+B1+C5+D4; A2+B2+C5+D4; A3+B1+C5+D4; A3+B2+C5+D4; A4+B1+C5+D4; A4+B2+C5+D4; A5+B1+C5+D4; A5+B2+C5+D4; A6+B1+C5+D4; A6+B2+C5+D4; A7+B1+C5+D4; and A7+B2+C5+D4; A1+B1+C6+D4; A1+B2+C6+D4; A2+B1+C6+D4; A2+B2+C6+D4; A3+B1+C6+D4; A3+B2+C6+D4; A4+B1+C6+D4; A4+B2+C6+D4; A5+B1+C6+D4; A5+B2+C6+D4; A6+B1+C6+D4; A6+B2+C6+D4; A7+B1+C6+D4; and A7+B2+C6+D4; A1+B1+C7+D4; A1+B2+C7+D4; A2+B1+C7+D4; A2+B2+C7+D4; A3+B1+C7+D4; A3+B2+C7+D4; A4+B1+C7+D4; A4+B2+C7+D4; A5+B1+C7+D4; A5+B2+C7+D4; A6+B1+C7+D4; A6+B2+C7+D4; A7+B1+C7+D4; and A7+B2+C7+D4; A1+B1+C8+D4; A1+B2+C8+D4; A2+B1+C8+D4; A2+B2+C8+D4; A3+B1+C8+D4; A3+B2+C8+D4; A4+B1+C8+D4; A4+B2+C8+D4; A5+B1+C8+D4; A5+B2+C8+D4; A6+B1+C8+D4; A6+B2+C8+D4; A7+B1+C8+D4; and A7+B2+C8+D4; A1+B1+C9+D4; A1+B2+C9+D4; A2+B1+C9+D4; A2+B2+C9+D4; A3+B1+C9+D4; A3+B2+C9+D4; A4+B1+C9+D4; A4+B2+C9+D4; A5+B1+C9+D4; A5+B2+C9+D4; A6+B1+C9+D4; A6+B2+C9+D4; A7+B1+C9+D4; and A7+B2+C9+D4; A1+B1+C10+D4; A1+B2+C10+D4; A2+B1+C10+D4; A2+B2+C10+D4; A3+B1+C10+D4; A3+B2+C10+D4; A4+B1+C10+D4; A4+B2+C10+D4; A5+B1+C10+D4; A5+B2+C10+D4; A6+B1+C10+D4; A6+B2+C10+D4; A7+B1+C10+D4; and A7+B2+C10+D4; A1+B1+C11+D4; A1+B2+C11+D4; A2+B1+C11+D4; A2+B2+C11+D4; A3+B1+C11+D4; A3+B2+C11+D4; A4+B1+C11+D4; A4+B2+C11+D4; A5+B1+C11+D4; A5+B2+C11+D4; A6+B1+C11; A6+B2+C I +D4; A7+B1+C11+D4; and A7+B2+C11+D4; A1+B1+C12+D4; A1+B2+C12+D4; A2+B1+C12+D4; A2+B2+C12+D4; A3+B1+C12+D4; A3+B2+C12+D4; A4+B1+C12+D4; A4+B2+C12+D4; A5+B1+C12+D4; A5+B2+C12+D4; A6+B1+C12+D4; A6+B2+C12+D4; A7+B1+C12+D4; and A7+B2+C12+D4; A1+B1+C1+D5; A1+B2+C1+D5; A2+B1+C1+D5; A2+B2+C1+D5; A3+B1+C1+D5; A3+B2+C1+D5; A4+B1+C1+D5; A4+B2+C1+D5; A5+B1+C1+D5; A5+B2+C1+D5; A6+B1+C1+D5; A6+B2+C1+D5; A7+B1+C1+D5; and A7+B2+C1+D5; A1+B1+C2+D5; A1+B2+C2+D5; A2+B1+C2+D5; A2+B2+C2+D5; A3+B1+C2+D5; A3+B2+C2+D5; A4+B1+C2+D5; A4+B2+C2+D5; A5+B1+C2+D5; A5+B2+C2+D5; A6+B1+C2+D5; A6+B2+C2+D5; A7+B1+C2+D5; and A7+B2+C2+D5; A1+BT+C3+D5; A1+B2+C3+D5; A2+B1+C3+D5; A2+B2+C3+D5; A3+B1+C3+D5; A3+B2+C3+D5; A4+B1+C3+D5; A4+B2+C3+D5; A5+B1+C3+D5; A5+B2+C3+D5; A6+B1+C3+D5; A6+B2+C3+D5; A7+B1+C3+D5; and A7+B2+C3+D5; A1+B1+C4+D5; A1+B2+C4+D5; A2+B1+C4+D5; A2+B2+C4+D5; A3+B1+C4+D5; A3+B2+C4+D5; A4+B1+C4+D5; A4+B2+C4+D5; A5+B1+C4+D5; A5+B2+C4+D5; A6+B1+C4+D5; A6+B2+C4+D5; A7+B1+C4+D5; and A7+B2+C4+D5; A1+B1+C5+D5; A1+B2+C5+D5; A2+B1+C5+D5; A2+B2+C5+D5; A3+B1+C5+D5; A3+B2+C5+D5; A4+B1+C5+D5; A4+B2+C5+D5; A5+B1+C5+D5; A5+B2+C5+D5; A6+B1+C5+D5; A6+B2+C5+D5; A7+B1+C5+D5; and A7+B2+C5+D5; A1+B1+C6+D5; A1+B2+C6+D5; A2+B1+C6+D5; A2+B2+C6+D5; A3+B1+C6+D5; A3+B2+C6+D5; A4+B1+C6+D5; A4+B2+C6+D5; A5+B1+C6+D5; A5+B2+C6+D5; A6+B1+C6+D5; A6+B2+C6+D5; A7+B1+C6+D5; and A7+B2+C6+D5; A1+B1+C7+D5; A1+B2+C7+D5; A2+B1+C7+D5; A2+B2+C7+D5; A3+B1+C7+D5; A3+B2+C7+D5; A4+B1+C7+D5; A4+B2+C7+D5; A5+B1+C7+D5; A5+B2+C7+D5; A6+B1+C7+D5; A6+B2+C7+D5; A7+B1+C7+D5; and A7+B2+C7+D5; A1+B1+C8+D5; A1+B2+C8+D5; A2+B1+C8+D5; A2+B2+C8+D5; A3+B1+C8+D5; A3+B2+C8+D5; A4+B1+C8+D5; A4+B2+C8+D5; A5+B1+C8+D5; A5+B2+C8+D5; A6+B1+C8+D5; A6+B2+C8+D5; A7+B1+C8+D5; and A7+B2+C8+D5; A1+B1+C9+D5; A1+B2+C9+D5; A2+B1+C9+D5; A2+B2+C9+D5; A3+B1+C9+D5; A3+B2+C9+D5; A4+B1+C9+D5; A4+B2+C9+D5; A5+B1+C9+D5; A5+B2+C9+D5; A6+B1+C9+D5; A6+B2+C9+D5; A7+B1+C9+D5; and A7+B2+C9+D5; A1+B1+C10+D5; A1+B2+C10+D5; A2+B1+C10+D5; A2+B2+C10+D5; A3+B1+C10+D5; A3+B2+C10+D5; A4+B1+C10+D5; A4+B2+C10+D5; A5+B1+C10+D5; A5+B2+C10+D5; A6+B1+C10+D5; A6+B2+C10+D5; A7+B1+C10+D5; and A7+B2+C10+D5; A1+B1+C11+D5; A1+B2+C11+D5; A2+B1+C11+D5; A2+B2+C11+D5; A3+B1+C11+D5; A3+B2+C11+D5; A4+B1+C11+D5; A4+B2+C11+D5; A5+B1+C11+D5; A5+B2+C11+D5; A6+B1+C11; A6+B2+C11+D5; A7+B1+C11+D5; and A7+B2+C11+D5; A1+B1+C12+D5; A1+B2+C12+D5; A2+B1+C12+D5; A2+B2+C12+D5; A3+B1+C12+D5; A3+B2+C12+D5; A4+B1+C12+D5; A4+B2+C12+D5; A5+B1+C12+D5; A5+B2+C12+D5; A6+B1+C12+D5; A6+B2+C12+D5; A7+B1+C12+D5; and A7+B2+C12+D5; A1+B1+C1+D6; A1+B2+C1+D6; A2+B1+C1+D6; A2+B2+C1+D6; A3+B1+C1+D6; A3+B2+C1+D6; A4+B1+C1+D6; A4+B2+C1+D6; A5+B1+C1+D6; A5+B2+C1+D6; A6+B1+C1+D6; A6+B2+C1+D6; A7+B1+C1+D6; and A7+B2+C1+D6; A1+B1+C2+D6; A1+B2+C2+D6; A2+B1+C2+D6; A2+B2+C2+D6; A3+B1+C2+D6; A3+B2+C2+D6; A4+B1+C2+D6; A4+B2+C2+D6; A5+B1+C2+D6; A5+B2+C2+D6; A6+B1+C2+D6; A6+B2+C2+D6; A7+B1+C2+D6; and A7+B2+C2+D6; A1+B1+C3+D6; A1+B2+C3+D6; A2+B1+C3+D6; A2+B2+C3+D6; A3+B1+C3+D6; A3+B2+C3+D6; A4+B1+C3+D6; A4+B2+C3+D6; A5+B1+C3+D6; A5+B2+C3+D6; A6+B1+C3+D6; A6+B2+C3+D6; A7+B1+C3+D6; and A7+B2+C3+D6; A1+B1+C4+D6; A1+B2+C4+D6; A2+B1+C4+D6; A2+B2+C4+D6; A3+B1+C4+D6; A3+B2+C4+D6; A4+B1+C4+D6; A4+B2+C4+D6; A5+B1+C4+D6; A5+B2+C4+D6; A6+B1+C4+D6; A6+B2+C4+D6; A7+B1+C4+D6; and A7+B2+C4+D6; A1+B1+C5+D6; A1+B2+C5+D6; A2+B1+C5+D6; A2+B2+C5+D6; A3+B1+C5+D6; A3+B2+C5+D6; A4+B1+C5+D6; A4+B2+C5+D6; A5+B1+C5+D6; A5+B2+C5+D6; A6+B1+C5+D6; A6+B2+C5+D6; A7+B1+C5+D6; and A7+B2+C5+D6; A1+B1+C6+D6; A1+B2+C6+D6; A2+B1+C6+D6; A2+B2+C6+D6; A3+B1+C6+D6; A3+B2+C6+D6;7A4+B1+C6+D6; A4+B2+C6+D6; A5+B1+C6+D6; A5+B2+C6+D6; A6+B1+C6+D6; A6+B2+C6+D6; A7+B1+C6+D6; and A7+B2+C6+D6; A1+B1+C7+D6; A1+B2+C7+D6; A2+B1+C7+D6; A2+B2+C7+D6; A3+B1+C7+D6; A3+B2+C7+D6; A4+B1+C7+D6; A4+B2+C7+D6; A5+B1+C7+D6; A5+B2+C7+D6; A6+B1+C7+D6; A6+B2+C7+D6; A7+B1+C7+D6; and A7+B2+C7+D6; A1+B1+C8+D6; A1+B2+C8+D6; A2+B1+C8+D6; A2+B2+C8+D6; A3+B1+C8+D6; A3+B2+C8+D6; A4+B1+C8+D6; A4+B2+C8+D6; A5+B1+C8+D6; A5+B2+C8+D6; A6+B1+C8+D6; A6+B2+C8+D6; A7+B1+C8+D6; and A7+B2+C8+D6; A1+B1+C9+D6; A1+B2+C9+D6; A2+B1+C9+D6; A2+B2+C9+D6; A3+B1+C9+D6; A3+B2+C9+D6; A4+B1+C9+D6; A4+B2+C9+D6; A5+B1+C9+D6; A5+B2+C9+D6; A6+B1+C9+D6; A6+B2+C9+D6; A7+B1+C9+D6; and A7+B2+C9+D6; A1+B1+C10+D6; A1+B2+C10+D6; A2+B1+C10+D6; A2+B2+C10+D6; A3+B1+C10+D6; A3+B2+C10+D6; A4+B1+C10+D6; A4+B2+C10+D6; A5+B1+C10+D6; A5+B2+C10+D6; A6+B1+C10+D6; A6+B2+C10+D6; A7+B1+C10+D6; and A7+B2+C10+D6; A1+B1+C11+D6; A1+B2+C11+D6; A2+B1+C11+D6; A2+B2+C11+D6; A3+B1+C11+D6; A3+B2+C11+D6; A4+B1+C11+D6; A4+B2+C11+D6; A5+B1+C11+D6; A5+B2+C11+D6; A6+B1+C11; A6+B2+C11+D6; A7+B1+C11+D6; and A7+B2+C1+D6; A1+B1+C12+D6; A1+B2+C12+D6; A2+B1+C12+D6; A2+B2+C12+D6; A3+B1+C12+D6; A3+B2+C12+D6; A4+B1+C12+D6; A4+B2+C12+D6; A5+B1+C12+D6; A5+B2+C12+D6; A6+B1+C12+D6; A6+B2+C12+D6; A7+B1+C12+D6; and A7+B2+C12+D6; A1+B1+C1+D7; A1+B2+C1+D7; A2+B1+C1+D7; A2+B2+C1+D7; A3+B1+C1+D7; A3+B2+C1+D7; A4+B1+C1+D7; A4+B2+C1+D7; A5+B1+C1+D7; A5+B2+C1+D7; A6+B1+C1+D7; A6+B2+C1+D7; A7+B1+C1+D7; and A7+B2+C1+D7; A1+B1+C2+D7; A1+B2+C2+D7; A2+B1+C2+D7; A2+B2+C2+D7; A3+B1+C2+D7; A3+B2+C2+D7; A4+B1+C2+D7; A4+B2+C2+D7; A5+B1+C2+D7; A5+B2+C2+D7; A6+B1+C2+D7; A6+B2+C2+D7; A7+B1+C2+D7; and A7+B2+C2+D7; A1+B1+C3+D7; A1+B2+C3+D7; A2+B1+C3+D7; A2+B2+C3+D7; A3+B1+C3+D7; A3+B2+C3+D7; A4+B1+C3+D7; A4+B2+C3+D7; A5+B1+C3+D7; A5+B2+C3+D7; A6+B1+C3+D7; A6+B2+C3+D7; A7+B1+C3+D7; and A7+B2+C3+D7; A1+B1+C4+D7; A1+B2+C4+D7; A2+B1+C4+D7; A2+B2+C4+D7; A3+B1+C4+D7; A3+B2+C4+D7; A4+B1+C4+D7; A4+B2+C4+D7; A5+B1+C4+D7; A5+B2+C4+D7; A6+B1+C4+D7; A6+B2+C4+D7; A7+B1+C4+D7; and A7+B2+C4+D7; A1+B1+C5+D7; A1+B2+C5+D7; A2+B1+C5+D7; A2+B2+C5+D7; A3+B1+C5+D7; A3+B2+C5+D7; A4+B1+C5+D7; A4+B2+C5+D7; A5+B1+C5+D7; A5+B2+C5+D7; A6+B1+C5+D7; A6+B2+C5+D7; A7+B1+C5+D7;and A7+B2+C5+D7; A1+B1+C6+D7; A1+B2+C6+D7; A2+B1+C6+D7; A2+B2+C6+D7; A3+B1+C6+D7; A3+B2+C6+D7; A4+B1+C6+D7; A4+B2+C6+D7; A5+B1+C6+D7; A5+B2+C6+D7; A6+B1+C6+D7; A6+B2+C6+D7; A7+B1+C6+D7; and A7+B2+C6+D7; A1+B1+C7+D7; A1+B2+C7+D7; A2+B1+C7+D7; A2+B2+C7+D7; A3+B1+C7+D7; A3+B2+C7+D7; A4+B1+C7+D7; A4+B2+C7+D7; A5+B1+C7+D7; A5+B2+C7+D7; A6+B1+C7+D7; A6+B2+C7+D7; A7+B1+C7+D7;and A7+B2+C7+D7; A1+B1+C8+D7; A1+B2+C8+D7; A2+B1+C8+D7; A2+B2+C8+D7; A3+B1+C8+D7; A3+B2+C8+D7; A4+B1+C8+D7; A4+B2+C8+D7; A5+B1+C8+D7; A5+B2+C8+D7; A6+B1+C8+D7; A6+B2+C8+D7; A7+B1+C8+D7;and A7+B2+C8+D7; A1+B1+C9+D7; A1+B2+C9+D7; A2+B1+C9+D7; A2+B2+C9+D7; A3+B1+C9+D7; A3+B2+C9+D7; A4+B1+C9+D7; A4+B2+C9+D7; A5+B1+C9+D7; A5+B2+C9+D7; A6+B1+C9+D7; A6+B2+C9+D7; A7+B1+C9+D7; and A7+B2+C9+D7; A1+B1+C10+D7; A1+B2+C10+D7; A2+B1+C10+D7; A2+B2+C10+D7; A3+B1+C10+D7; A3+B2+C10+D7; A4+B1+C10+D7; A4+B2+C10+D7; A5+B1+C10+D7; A5+B2+C10+D7; A6+B1+C10+D7; A6+B2+C10+D7; A7+B1+C10+D7; and A7+B2+C10+D7; A1+B1+C11+D7; A1+B2+C11+D7; A2+B1+C1+D7; A2+B2+C11+D7; A3+B1+C11+D7; A3+B2+C11+D7; A4+B1+C11+D7; A4+B2+C11+D7; A5+B1+C11+D7; A5+B2+C11+D7; A6+B1+C11; A6+B2+C11+D7; A7+B1+C11+D7; and A7+B2+C11+D7; A1+B1+C12+D7; A1+B2+C12+D7; A2+B1+C12+D7; A2+B2+C12+D7; A3+B1+C12+D7; A3+B2+C12+D7; A4+B1+C12+D7; A4+B2+C12+D7; A5+B1+C12+D7; A5+B2+C12+D7; A6+B1+C12+D7; A6+B2+C12+D7; A7+B1+C12+D7; and A7+B2+C12+D7; A1+B1+C1+D8; A1+B2+C1+D8; A2+B1+C1+D8; A2+B2+C1+D8; A3+B1+C1+D8; A3+B2+C1+D8; A4+B1+C1+D8; A4+B2+C1+D8; A5+B1+C1+D8; A5+B2+C1+D8; A6+B1+C1+D8; A6+B2+C1+D8; A7+B1+C1+D8; and A7+B2+C1+D8; A1+B1+C2+D8; A1+B2+C2+D8; A2+B1+C2+D8; A2+B2+C2+D8; A3+B1+C2+D8; A3+B2+C2+D8; A4+B1+C2+D8; A4+B2+C2+D8; A5+B1+C2+D8; A5+B2+C2+D8; A6+B1+C2+D8; A6+B2+C2+D8; A7+B1+C2+D8; and A7+B2+C2+D8; A1+B1+C3+D8; A1+B2+C3+D8; A2+B1+C3+D8; A2+B2+C3+D8; A3+B1+C3+D8; A3+B2+C3+D8; A4+B1+C3+D8; A4+B2+C3+D8; A5+B1+C3+D8; A5+B2+C3+D8; A6+B1+C3+D8; A6+B2+C3+D8; A7+B1+C3+D8; and A7+B2+C3+D8; A1+B1+C4+D8; A1+B2+C4+D8; A2+B1+C4+D8; A2+B2+C4+D8; A3+B1+C4+D8; A3+B2+C4+D8; A4+B1+C4+D8; A4+B2+C4+D8; A5+B1+C4+D8; A5+B2+C4+D8; A6+B1+C4+D8; A6+B2+C4+D8; A7+B1+C4+D8; and A7+B2+C4+D8; A1+B1+C5+D8; A1+B2+C5+D8; A2+B1+C5+D8; A2+B2+C5+D8; A3+B1+C5+D8; A3+B2+C5+D8; A4+B1+C5+D8; A4+B2+C5+D8; A5+B1+C5+D8; A5+B2+C5+D8; A6+B1+C5+D8; A6+B2+C5+D8; A7+B1+C5+D8; and A7+B2+C5+D8; A1+B1+C6+D8; A1+B2+C6+D8; A2+B1+C6+D8; A2+B2+C6+D8; A3+B1+C6+D8; A3+B2+C6+D8; A4+B1+C6+D8; A4+B2+C6+D8; A5+B1+C6+D8; A5+B2+C6+D8; A6+B1+C6+D8; A6+B2+C6+D8; A7+B1+C6+D8; and A7+B2+C6+D8; A1+B1+C7+D8; A1+B2+C7+D8; A2+B1+C7+D8; A2+B2+C7+D8; A3+B1+C7+D8; A3+B2+C7+D8; A4+B1+C7+D8; A4+B2+C7+D8; A5+B1+C7+D8; A5+B2+C7+D8; A6+B1+C7+D8; A6+B2+C7+D8; A7+B1+C7+D8; and A7+B2+C7+D8; A1+B1+C8+D8; A1+B2+C8+D8; A2+B1+C8+D8; A2+B2+C8+D8; A3+B1+C8+D8; A3+B2+C8+D8; A4+B1+C8+D8; A4+B2+C8+D8; A5+B1+C8+D8; A5+B2+C8+D8; A6+B1+C8+D8; A6+B2+C8+D8; A7+B1+C8+D8; and A7+B2+C8+D8; A1+B1+C9+D8; A1+B2+C9+D8; A2+B1+C9+D8; A2+B2+C9+D8; A3+B1+C9+D8; A3+B2+C9+D8; A4+B1+C9+D8; A4+B2+C9+D8; A5+B1+C9+D8; A5+B2+C9+D8; A6+B1+C9+D8; A6+B2+C9+D8; A7+B1+C9+D8; and A7+B2+C9+D8; A1+B1+C10+D8; A1+B2+C10+D8; A2+B1+C10+D8; A2+B2+C10+D8; A3+B1+C10+D8; A3+B2+C10+D8; A4+B1+C10+D8; A4+B2+C10+D8; A5+B1+C10+D8; A5+B2+C10+D8; A6+B1+C10+D8; A6+B2+C10+D8; A7+B1+C10+D8; and A7+B2+C10+D8; A1+B1+C11+D8; A1+B2+C11+D8; A2+B1+C11+D8; A2+B2+C11+D8; A3+B1+C11+D8; A3+B2+C11+D8; A4+B1+C11+D8; A4+B2+C11+D8; A5+B1+C11+D8; A5+B2+C11+D8; A6+B1+C11; A6+B2+C11+D8; A7+B1+C11+D8; and A7+B2+C11+D8; A1+B1+C12+D8; A1+B2+C12+D8; A2+B1+C12+D8; A2+B2+C12+D8; A3+B1+C12+D8; A3+B2+C12+D8; A4+B1+C12+D8; A4+B2+C12+D8; A5+B1+C12+D8; A5+B2+C12+D8; A6+B1+C12+D8; A6+B2+C12+D8; A7+B1+C12+D8; and A7+B2+C12+D8; A1+B1+C1+D9; A1+B2+C1+D9; A2+B1+C1+D9; A2+B2+C1+D9; A3+B1+C1+D9; A3+B2+C1+D9; A4+B1+C1+D9; A4+B2+C1+D9; A5+B1+C1+D9; A5+B2+C1+D9; A6+B1+C1+D9; A6+B2+C1+D9; A7+B1+C1+D9; and A7+B2+C1+D9; A1+B1+C2+D9; A1+B2+C2+D9; A2+B1+C2+D9; A2+B2+C2+D9; A3+B1+C2+D9; A3+B2+C2+D9; A4+B1+C2+D9; A4+B2+C2+D9; A5+B1+C2+D9; A5+B2+C2+D9; A6+B1+C2+D9; A6+B2+C2+D9; A7+B1+C2+D9; and A7+B2+C2+D9; A1+B1+C3+D9; A1+B2+C3+D9; A2+B1+C3+D9; A2+B2+C3+D9; A3+B1+C3+D9; A3+B2+C3+D9; A4+B1+C3+D9; A4+B2+C3+D9; A5+B1+C3+D9; A5+B2+C3+D9; A6+B1+C3+D9; A6+B2+C3+D9; A7+B1+C3+D9; and A7+B2+C3+D9; A1+B1+C4+D9; A1+B2+C4+D9; A2+B1+C4+D9; A2+B2+C4+D9; A3+B1+C4+D9; A3+B2+C4+D9; A4+B1+C4+D9; A4+B2+C4+D9; A5+B1+C4+D9; A5+B2+C4+D9; A6+B1+C4+D9; A6+B2+C4+D9; A7+B1+C4+D9; and A7+B2+C4+D9; A1+B1+C5+D9; A1+B2+C5+D9; A2+B1+C5+D9; A2+B2+C5+D9; A3+B1+C5+D9; A3+B2+C5+D9; A4+B1+C5+D9; A4+B2+C5+D9; A5+B1+C5+D9; A5+B2+C5+D9; A6+B1+C5+D9; A6+B2+C5+D9; A7+B1+C5+D9; and A7+B2+C5+D9; A1+B1+C6+D9; A1+B2+C6+D9; A2+B1+C6+D9; A2+B2+C6+D9; A3+B1+C6+D9; A3+B2+C6+D9; A4+B1+C6+D9; A4+B2+C6+D9; A5+B1+C6+D9; A5+B2+C6+D9; A6+B1+C6+D9; A6+B2+C6+D9; A7+B1+C6+D9; and A7+B2+C6+D9; A1+B1+C7+D9; A1+B2+C7+D9; A2+B1+C7+D9; A2+B2+C7+D9; A3+B1+C7+D9; A3+B2+C7+D9; A4+B1+C7+D9; A4+B2+C7+D9; A5+B1+C7+D9; A5+B2+C7+D9; A6+B1+C7+D9; A6+B2+C7+D9; A7+B1+C7+D9; and A7+B2+C7+D9; A1+B1+C8+D9; A1+B2+C8+D9; A2+B1+C8+D9; A2+B2+C8+D9; A3+B1+C8+D9; A3+B2+C8+D9; A4+B1+C8+D9; A4+B2+C8+D9; A5+B1+C8+D9; A5+B2+C8+D9; A6+B1+C8+D9; A6+B2+C8+D9; A7+B1+C8+D9; and A7+B2+C8+D9; A1+B1+C9+D9; A1+B2+C9+D9; A2+B1+C9+D9; A2+B2+C9+D9; A3+B1+C9+D9; A3+B2+C9+D9; A4+B1+C9+D9; A4+B2+C9+D9; A5+B1+C9+D9; A5+B2+C9+D9; A6+B1+C9+D9; A6+B2+C9+D9; A7+B1+C9+D9; and A7+B2+C9+D9; A1+B1+C10+D9; A1+B2+C10+D9; A2+B1+C10+D9; A2+B2+C10+D9; A3+B1+C10+D9; A3+B2+C10+D9; A4+B1+C10+D9; A4+B2+C10+D9; A5+B1+C10+D9; A5+B2+C10+D9; A6+B1+C10+D9; A6+B2+C10+D9; A7+B1+C10+D9; and A7+B2+C10+D9; A1+B1+C11+D9; A1+B2+C11+D9; A2+B1+C11+D9; A2+B2+C11+D9; A3+B1+C11+D9; A3+B2+C11+D9; A4+B1+C11+D9; A4+B2+C11+D9; A5+B1+C11+D9; A5+B2+C11+D9; A6+B1+C11; A6+B2+C11+D9; A7+B1+C11+D9; and A7+B2+C11+D9; A1+B1+C12+D9; A1+B2+C12+D9; A2+B1+C12+D9; A2+B2+C12+D9; A3+B1+C12+D9; A3+B2+C12+D9; A4+B1+C12+D9; A4+B2+C12+D9; A5+B1+C12+D9; A5+B2+C12+D9; A6+B1+C12+D9; A6+B2+C12+D9; A7+B1+C12+D9; and A7+B2+C12+D9; A1+B1+C1+D10; A1+B2+C1+D10; A2+B1+C1+D10; A2+B2+C1+D10; A3+B1+C1+D10; A3+B2+C1+D10; A4+B1+C1+D10; A4+B2+C1+D10; A5+B1+C1+D10; A5+B2+C1+D10; A6+B1+C1+D10; A6+B2+C1+D10; A7+B1+C1+D10; and A7+B2+C1+D10; A1+B1+C2+D10; A1+B2+C2+D10; A2+B1+C2+D10; A2+B2+C2+D10; A3+B1+C2+D10; A3+B2+C2+D10; A4+B1+C2+D10; A4+B2+C2+D10; A5+B1+C2+D10; A5+B2+C2+D10; A6+B1+C2+D10; A6+B2+C2+D10; A7+B1+C2+D10; and A7+B2+C2+D10; A1+B1+C3+D10; A1+B2+C3+D10; A2+B1+C3+D10; A2+B2+C3+D10; A3+B1+C3+D10; A3+B2+C3+D10; A4+B1+C3+D10; A4+B2+C3+D10; A5+B1+C3+D10; A5+B2+C3+D10; A6+B1+C3+D10; A6+B2+C3+D10; A7+B1+C3+D10; and A7+B2+C3+D10; A1+B1+C4+D10; A1+B2+C4+D10; A2+B1+C4+D10; A2+B2+C4+D10; A3+B1+C4+D10; A3+B2+C4+D10; A4+B1+C4+D10; A4+B2+C4+D10; A5+B1+C4+D10; A5+B2+C4+D10; A6+B1+C4+D10; A6+B2+C4+D10; A7+B1+C4+D10; and A7+B2+C4+D10; A1+B1+C5+D10; A1+B2+C5+D10; A2+B1+C5+D10; A2+B2+C5+D10; A3+B1+C5+D10; A3+B2+C5+D10; A4+B1+C5+D10; A4+B2+C5+D10; A5+B1+C5+D10; A5+B2+C5+D10; A6+B1+C5+D10; A6+B2+C5+D10; A7+B1+C5+D10; and A7+B2+C5+D10; A1+B1+C6+D10; A1+B2+C6+D10; A2+B1+C6+D10; A2+B2+C6+D10; A3+B1+C6+D10; A3+B2+C6+D10; A4+B1+C6+D10; A4+B2+C6+D10; A5+B1+C6+D10; A5+B2+C6+D10; A6+B1+C6+D10; A6+B2+C6+D10; A7+B1+C6+D10; and A7+B2+C6+D10; A1+B1+C7+D10; A1+B2+C7+D10; A2+B1+C7+D10; A2+B2+C7+D10; A3+B1+C7+D10; A3+B2+C7+D10; A4+B1+C7+D10; A4+B2+C7+D10; A5+B1+C7+D10; A5+B2+C7+D10; A6+B1+C7+D10; A6+B2+C7+D10; A7+B1+C7+D10; and A7+B2+C7+D10; A1+B1+C8+D10; A1+B2+C8+D10; A2+B1+C8+D10; A2+B2+C8+D10; A3+B1+C8+D10; A3+B2+C8+D10; A4+B1+C8+D10; A4+B2+C8+D10; A5+B1+C8+D10; A5+B2+C8+D10; A6+B1+C8+D10; A6+B2+C8+D10; A7+B1+C8+D10; and A7+B2+C8+D10; A1+B1+C9+D10; A1+B2+C9+D10; A2+B1+C9+D10; A2+B2+C9+D10; A3+B1+C9+D10; A3+B2+C9+D10; A4+B1+C9+D10; A4+B2+C9+D10; A5+B1+C9+D10; A5+B2+C9+D10; A6+B1+C9+D10; A6+B2+C9+D10; A7+B1+C9+D10; and A7+B2+C9+D10; A1+B1+C10+D10; A1+B2+C10+D10; A2+B1+C10+D10; A2+B2+C10+D10; A3+B1+C10+D10; A3+B2+C10+D10; A4+B1+C10+D10; A4+B2+C10+D10; A5+B1+C10+D10; A5+B2+C10+D10; A6+B1+C10+D10; A6+B2+C10+D10; A7+B1+C10+D10; and A7+B2+C10+D10; A1+B1+C11+D10; A1+B2+C11+D10; A2+B1+C11+D10; A2+B2+C11+D10; A3+B1+C11+D10; A3+B2+C11+D10; A4+B1+C11+D10; A4+B2+C11+D10; A5+B1+C11+D10; A5+B2+C I +D10; A6+B1+C11; A6+B2+C11+D10; A7+B1+C11+D10; and A7+B2+C11+D10; A1+B1+C12+D10; A1+B2+C12+D10; A2+B1+C12+D10; A2+B2+C12+D10; A3+B1+C12+D10; A3+B2+C12+D10; A4+B1+C12+D10; A4+B2+C12+D10; A5+B1+C12+D10; A5+B2+C12+D10; A6+B1+C12+D10; A6+B2+C12+D10; A7+B1+C12+D10; and A7+B2+C12+D10; A1+B1+C1+D11; A1+B2+C1+D11; A2+B1+C1+D11; A2+B2+C1+D11; A3+B1+C1+D11; A3+B2+C1+D11; A4+B1+C1+D11; A4+B2+C1+D11; A5+B1+C1+D11; A5+B2+C1+D11; A6+B1+C1+D11; A6+B2+C1+D11; A7+B1+C1+D11; and A7+B2+C1+D11; A1+B1+C2+D11; A1+B2+C2+D11; A2+B1+C2+D11; A2+B2+C2+D11; A3+B1+C2+D11; A3+B2+C2+D11; A4+B1+C2+D11; A4+B2+C2+D11; A5+B1+C2+D11; A5+B2+C2+D11; A6+B1+C2+D11; A6+B2+C2+D11; A7+B1+C2+D11; and A7+B2+C2+D11; A1+B1+C3+D11; A1+B2+C3+D11; A2+B1+C3+D11; A2+B2+C3+D1; A3+B1+C3+D11; A3+B2+C3+D11; A4+B1+C3+D11; A4+B2+C3+D11; A5+B1+C3+D11; A5+B2+C3+D11; A6+B1+C3+D11; A6+B2+C3+D11; A7+B1+C3+D11; and A7+B2+C3+D1; A1+B1+C4+D11; A1+B2+C4+D11; A2+B1+C4+D11; A2+B2+C4+D11; A3+B1+C4+D11; A3+B2+C4+D11; A4+B1+C4+D11; A4+B2+C4+D11; A5+B1+C4+D11; A5+B2+C4+D11; A6+B1+C4+D11; A6+B2+C4+D11; A7+B1+C4+D11; and A7+B2+C4+D11; A1+B1+C5+D11; A1+B2+C5+D11; A2+B1+C5+D11; A2+B2+C5+D11; A3+B1+C5+D11; A3+B2+C5+D11; A4+B1+C5+D11; A4+B2+C5+D11; A5+B1+C5+D11; A5+B2+C5+D11; A6+B1+C5+D11; A6+B2+C5+D11; A7+B1+C5+D11; and A7+B2+C5+D11; A1+B1+C6+D11; A1+B2+C6+D11; A2+B1+C6+D11; A2+B2+C6+D11; A3+B1+C6+D11; A3+B2+C6+D11; A4+B1+C6+D11; A4+B2+C6+D11; A5+B1+C6+D11; A5+B2+C6+D11; A6+B1+C6+D11; A6+B2+C6+D11; A7+B1+C6+D11; and A7+B2+C6+D11; A1+B1+C7+D11; A1+B2+C7+D11; A2+B1+C7+D11; A2+B2+C7+D11; A3+B1+C7+D11; A3+B2+C7+D11; A4+B1+C7+D11; A4+B2+C7+D11; A5+B1+C7+D11; A5+B2+C7+D11; A6+B1+C7+D11; A6+B2+C7+D11; A7+B1+C7+D11; and A7+B2+C7+D11; A1+B1+C8+D11; A1+B2+C8+D11; A2+B1+C8+D11; A2+B2+C8+D11; A3+B1+C8+D11; A3+B2+C8+D11; A4+B1+C8+D11; A4+B2+C8+D11; A5+B1+C8+D11; A5+B2+C8+D11; A6+B1+C8+D11; A6+B2+C8+D11; A7+B1+C8+D11; and A7+B2+C8+D11; A1+B1+C9+D11; A1+B2+C9+D11; A2+B1+C9+D11; A2+B2+C9+D11; A3+B1+C9+D11; A3+B2+C9+D11; A4+B1+C9+D11; A4+B2+C9+D11; A5+B1+C9+D11; A5+B2+C9+D11; A6+B1+C9+D11; A6+B2+C9+D11; A7+B1+C9+D11; and A7+B2+C9+D11; A1+B1+C10+D11; A1+B2+C10+D11; A2+B1+C10+D11; A2+B2+C10+D11; A3+B1+C10+D11; A3+B2+C10+D11; A4+B1+C10+D11; A4+B2+C10+D11; A5+B1+C10+D11; A5+B2+C10+D11; A6+B1+C10+D11; A6+B2+C10+D11; A7+B1+C10+D11; and A7+B2+C10+D11; A1+B1+C11+D11; A1+B2+C11+D11; A2+B1+C11+D11; A2+B2+C11+D11; A3+B1+C11+D11; A3+B2+C11+D11; A4+B1+C11+D11; A4+B2+C11+D11; A5+B1+C11+D11; A5+B2+C11+D11; A6+B1+C11; A6+B2+C11+D11; A7+B1+C11+D11; and A7+B2+C11+D11; A1+B1+C12+D11; A1+B2+C12+D11; A2+B1+C12+D11; A2+B2+C12+D11; A3+B1+C12+D11; A3+B2+C12+D11; A4+B1+C12+D11; A4+B2+C12+D11; A5+B1+C12+D11; A5+B2+C12+D11; A6+B1+C12+D11; A6+B2+C12+D11; A7+B1+C12+D11; and A7+B2+C12+D11; A1+B1+C1+D12; A1+B2+C1+D12; A2+B1+C1+D12; A2+B2+C1+D12; A3+B1+C1+D12; A3+B2+C1+D12; A4+B1+C1+D12; A4+B2+C1+D12; A5+B1+C1+D12; A5+B2+C1+D12; A6+B1+C1+D12; A6+B2+C1+D12; A7+B1+C1+D12; and A7+B2+C1+D12; A1+B1+C2+D12; A1+B2+C2+D12; A2+B1+C2+D12; A2+B2+C2+D12; A3+B1+C2+D12; A3+B2+C2+D12; A4+B1+C2+D12; A4+B2+C2+D12; A5+B1+C2+D12; A5+B2+C2+D12; A6+B1+C2+D12; A6+B2+C2+D12; A7+B1+C2+D12; and A7+B2+C2+D12; A1+B1+C3+D12; A1+B2+C3+D12; A2+B1+C3+D12; A2+B2+C3+D12; A3+B1+C3+D12; A3+B2+C3+D12; A4+B1+C3+D12; A4+B2+C3+D12; A5+B1+C3+D12; A5+B2+C3+D12; A6+B1+C3+D12; A6+B2+C3+D12; A7+B1+C3+D12; and A7+B2+C3+D12; A1+B1+C4+D12; A1+B2+C4+D12; A2+B1+C4+D12; A2+B2+C4+D12; A3+B1+C4+D12; A3+B2+C4+D12; A4+B1+C4+D12; A4+B2+C4+D12; A5+B1+C4+D12; A5+B2+C4+D12; A6+B1+C4+D12; A6+B2+C4+D12; A7+B1+C4+D12; and A7+B2+C4+D12; A1+B1+C5+D12; A1+B2+C5+D12; A2+B1+C5+D12; A2+B2+C5+D12; A3+B1+C5+D12; A3+B2+C5+D12; A4+B1+C5+D12; A4+B2+C5+D12; A5+B1+C5+D12; A5+B2+C5+D12; A6+B1+C5+D12; A6+B2+C5+D12; A7+B1+C5+D12; and A7+B2+C5+D12; A1+B1+C6+D12; A1+B2+C6+D12; A2+B1+C6+D12; A2+B2+C6+D12; A3+B1+C6+D12; A3+B2+C6+D12; A4+B1+C6+D12; A4+B2+C6+D12; A5+B1+C6+D12; A5+B2+C6+D12; A6+B1+C6+D12; A6+B2+C6+D12; A7+B1+C6+D12; and A7+B2+C6+D12; A1+B1+C7+D12; A1+B2+C7+D12; A2+B1+C7+D12; A2+B2+C7+D12; A3+B1+C7+D12; A3+B2+C7+D12; A4+B1+C7+D12; A4+B2+C7+D12; A5+B1+C7+D12; A5+B2+C7+D12; A6+B1+C7+D12; A6+B2+C7+D12; A7+B1+C7+D12; and A7+B2+C7+D12; A1+B1+C8+D12; A1+B2+C8+D12; A2+B1+C8+D12; A2+B2+C8+D12; A3+B1+C8+D12; A3+B2+C8+D12; A4+B1+C8+D12; A4+B2+C8+D12; A5+B1+C8+D12; A5+B2+C8+D12; A6+B1+C8+D12; A6+B2+C8+D12; A7+B1+C8+D12; and A7+B2+C8+D12; A1+B1+C9+D12; A1+B2+C9+D12; A2+B1+C9+D12; A2+B2+C9+D12; A3+B1+C9+D12; A3+B2+C9+D12; A4+B1+C9+D12; A4+B2+C9+D12; A5+B1+C9+D12; A5+B2+C9+D12; A6+B1+C9+D12; A6+B2+C9+D12; A7+B1+C9+D12; and A7+B2+C9+D12; A1+B1+C10+D12; A1+B2+C10+D12; A2+B1+C10+D12; A2+B2+C10+D12; A3+B1+C10+D12; A3+B2+C10+D12; A4+B1+C10+D12; A4+B2+C10+D12; A5+B1+C10+D12; A5+B2+C10+D12; A6+B1+C10+D12; A6+B2+C10+D12; A7+B1+C10+D12; and A7+B2+C10+D12; A1+B1+C11+D12; A1+B2+C11+D12; A2+B1+C11+D12; A2+B2+C11+D12; A3+B1+C11+D12; A3+B2+C11+D12; A4+B1+C11+D12; A4+B2+C11+D12; A5+B1+C11+D12; A5+B2+C11+D12; A6+B1+C11; A6+B2+C11+D12; A7+B1+C11+D12; and A7+B2+C11+D12; A1+B1+C12+D12; A1+B2+C12+D12; A2+B1+C12+D12; A2+B2+C12+D12; A3+B1+C12+D12; A3+B2+C12+D12; A4+B1+C12+D12; A4+B2+C12+D12; A5+B1+C12+D12; A5+B2+C12+D12; A6+B1+C12+D12; A6+B2+C12+D12; A7+B1+C12+D12; and A7+B2+C12+D12; A1+B1+C1+D13; A1+B2+C1+D13; A2+B1+C1+D13; A2+B2+C1+D13; A3+B1+C1+D13; A3+B2+C1+D13; A4+B1+C1+D13; A4+B2+C1+D13; A5+B1+C1+D13; A5+B2+C1+D13; A6+B1+C1+D13; A6+B2+C1+D13; A7+B1+C1+D13; and A7+B2+C1+D13; A1+B1+C2+D13; A1+B2+C2+D13; A2+B1+C2+D13; A2+B2+C2+D13; A3+B1+C2+D13; A3+B2+C2+D13; A4+B1+C2+D13; A4+B2+C2+D13; A5+B1+C2+D13; A5+B2+C2+D13; A6+B1+C2+D13; A6+B2+C2+D13; A7+B1+C2+D13; and A7+B2+C2+D13; A1+B1+C3+D13; A1+B2+C3+D3; A2+B1+C3+D13; A2+B2+C3+D13; A3+B1+C3+D13; A3+B2+C3+D13; A4+B1+C3+D13; A4+B2+C3+D13; A5+B1+C3+D13; A5+B2+C3+D13; A6+B1+C3+D13; A6+B2+C3+D13; A7+B1+C3+D13; and A7+B2+C3+D13; A1+B1+C4+D13; A1+B2+C4+D13; A2+B1+C4+D13; A2+B2+C4+D13; A3+B1+C4+D13; A3+B2+C4+D13; A4+B1+C4+D13; A4+B2+C4+D13; A5+B1+C4+D13; A5+B2+C4+D13; A6+B1+C4+D13; A6+B2+C4+D13; A7+B1+C4+D13; and A7+B2+C4+D13; A1+B1+C5+D13; A1+B2+C5+D13; A2+B1+C5+D13; A2+B2+C5+D13; A3+B1+C5+D13; A3+B2+C5+D13; A4+B1+C5+D13; A4+B2+C5+D13; A5+B1+C5+D13; A5+B2+C5+D13; A6+B1+C5+D13; A6+B2+C5+D13; A7+B1+C5+D13; and A7+B2+C5+D13; A1+B1+C6+D13; A1+B2+C6+D13; A2+B1+C6+D13; A2+B2+C6+D13; A3+B1+C6+D13; A3+B2+C6+D13; A4+B1+C6+D13; A4+B2+C6+D13; A5+B1+C6+D13; A5+B2+C6+D13; A6+B1+C6+D13; A6+B2+C6+D13; A7+B1+C6+D13; and A7+B2+C6+D13; A1+B1+C7+D13; A1+B2+C7+D13; A2+B1+C7+D13; A2+B2+C7+D13; A3+B1+C7+D13; A3+B2+C7+D13; A4+B1+C7+D13; A4+B2+C7+D13; A5+B1+C7+D13; A5+B2+C7+D13; A6+B1+C7+D13; A6+B2+C7+D13; A7+B1+C7+D13; and A7+B2+C7+D13; A1+B1+C8+D13; A1+B2+C8+D13; A2+B1+C8+D13; A2+B2+C8+D13; A3+B1+C8+D13; A3+B2+C8+D13; A4+B1+C8+D13; A4+B2+C8+D13; A5+B1+C8+D13; A5+B2+C8+D13; A6+B1+C8+D13; A6+B2+C8+D13; A7+B1+C8+D13; and A7+B2+C8+D13; A1+B1+C9+D13; A1+B2+C9+D13; A2+B1+C9+D13; A2+B2+C9+D13; A3+B1+C9+D13; A3+B2+C9+D13; A4+B1+C9+D13; A4+B2+C9+D13; A5+B1+C9+D13; A5+B2+C9+D13; A6+B1+C9+D13; A6+B2+C9+D13; A7+B1+C9+D13; and A7+B2+C9+D13; A1+B1+C10+D13; A1+B2+C10+D13; A2+B1+C10+D13; A2+B2+C10+D13; A3+B1+C10+D13; A3+B2+C10+D13; A4+B1+C10+D13; A4+B2+C10+D13; A5+B1+C10+D13; A5+B2+C10+D13; A6+B1+C10+D13; A6+B2+C10+D13; A7+B1+C10+D13; and A7+B2+C10+D13; A1+B1+C11+D13; A1+B2+C11+D13; A2+B1+C11+D13; A2+B2+C11+D13; A3+B1+C11+D13; A3+B2+C11+D13; A4+B1+C11+D13; A4+B2+C11+D13; A5+B1+C11+D13; A5+B2+C11+D13; A6+B1+C11; A6+B2+C11+D13; A7+B1+C11+D13; and A7+B2+C11+D13; A1+B1+C12+D13; A1+B2+C12+D13; A2+B1+C12+D13; A2+B2+C12+D13; A3+B1+C12+D13; A3+B2+C12+D13; A4+B1+C12+D13; A4+B2+C12+D13; A5+B1+C12+D13; A5+B2+C12+D13; A6+B1+C12+D13; A6+B2+C12+D13; A7+B1+C12+D13; and A7+B2+C12+D13; A1+B1+C1+D14; A1+B2+C1+D14; A2+B1+C1+D14; A2+B2+C1+D14; A3+B1+C1+D14; A3+B2+C1+D14; A4+B1+C1+D14; A4+B2+C1+D14; A5+B1+C1+D14; A5+B2+C1+D14; A6+B1+C1+D14; A6+B2+C1+D14; A7+B1+C1+D14; and A7+B2+C1+D14; A1+B1+C2+D14; A1+B2+C2+D14; A2+B1+C2+D14; A2+B2+C2+D14; A3+B1+C2+D14; A3+B2+C2+D14; A4+B1+C2+D14; A4+B2+C2+D14; A5+B1+C2+D14; A5+B2+C2+D14; A6+B1+C2+D14; A6+B2+C2+D14; A7+B1+C2+D14; and A7+B2+C2+D14; A1+B1+C3+D14; A1+B2+C3+D14; A2+B1+C3+D14; A2+B2+C3+D14; A3+B1+C3+D14; A3+B2+C3+D14; A4+B1+C3+D14; A4+B2+C3+D14; A5+B1+C3+D14; A5+B2+C3+D14; A6+B1+C3+D14; A6+B2+C3+D14; A7+B1+C3+D14; and A7+B2+C3+D14; A1+B1+C4+D14; A1+B2+C4+D14; A2+B1+C4+D14; A2+B2+C4+D14; A3+B1+C4+D14; A3+B2+C4+D14; A4+B1+C4+D14; A4+B2+C4+D14; A5+B1+C4+D14; A5+B2+C4+D14; A6+B1+C4+D14; A6+B2+C4+D14; A7+B1+C4+D14; and A7+B2+C4+D14; A1+B1+C5+D14; A1+B2+C5+D14; A2+B1+C5+D14; A2+B2+C5+D14; A3+B1+C5+D14; A3+B2+C5+D14; A4+B1+C5+D14; A4+B2+C5+D14; A5+B1+C5+D14; A5+B2+C5+D14; A6+B1+C5+D14; A6+B2+C5+D14; A7+B1+C5+D14; and A7+B2+C5+D14; A1+B1+C6+D14; A1+B2+C6+D14; A2+B1+C6+D14; A2+B2+C6+D14; A3+B1+C6+D14; A3+B2+C6+D14; A4+B1+C6+D14; A4+B2+C6+DD4; A5+B1+C6+D14; A5+B2+C6+D14; A6+B1+C6+D14; A6+B2+C6+D14; A7+B1+C6+D14; and A7+B2+C6+D14; A1+B1+C7+D14; A1+B2+C7+D14; A2+B1+C7+D14; A2+B2+C7+D14; A3+B1+C7+D14; A3+B2+C7+D14; A4+B1+C7+D14; A4+B2+C7+D14; A5+B1+C7+D14; A5+B2+C7+D14; A6+B1+C7+D14; A6+B2+C7+D14; A7+B1+C7+D14; and A7+B2+C7+D14; A1+B1+C8+D14; A1+B2+C8+D14; A2+B1+C8+D14; A2+B2+C8+D14; A3+B1+C8+D14; A3+B2+C8+D14; A4+B1+C8+D14; A4+B2+C8+D14; A5+B1+C8+D14; A5+B2+C8+D14; A6+B1+C8+D14; A6+B2+C8+D14; A7+B1+C8+D14; and A7+B2+C8+D14; A1+B1+C9+D14; A1+B2+C9+D14; A2+B1+C9+D14; A2+B2+C9+D14; A3+B1+C9+D14; A3+B2+C9+D14; A4+B1+C9+D14; A4+B2+C9+D14; A5+B1+C9+D14; A5+B2+C9+D14; A6+B1+C9+D14; A6+B2+C9+D14; A7+B1+C9+D14; and A7+B2+C9+D14; A1+B1+C10+D14; A1+B2+C10+D14; A2+B1+C10+D14; A2+B2+C10+D14; A3+B1+C10+D14; A3+B2+C10+D14; A4+B1+C10+D14; A4+B2+C10+D14; A5+B1+C10+D14; A5+B2+C10+D14; A6+B1+C10+D14; A6+B2+C10+D14; A7+B1+C10+D14; and A7+B2+C10+D14; A1+B1+C11+D14; A1+B2+C11+D14; A2+B1+C11+D14; A2+B2+C11+D14; A3+B1+C11+D14; A3+B2+C11+D14; A4+B1+C11+D14; A4+B2+C11+D14; A5+B1+C11+D14; A5+B2+C11+D14; A6+B1+C11; A6+B2+C11+D14; A7+B1+C11+D14; and A7+B2+C11+D14; A1+B1+C12+D14; A1+B2+C12+D14; A2+B1+C12+D14; A2+B2+C12+D14; A3+B1+C12+D14; A3+B2+C12+D14; A4+B1+C12+D14; A4+B2+C12+D14; A5+B1+C12+D14; A5+B2+C12+D14; A6+B1+C12+D14; A6+B2+C12+D14; A7+B1+C12+D14; and A7+B2+C12+D14; A1+B1+C1+D15; A1+B2+C1+D15; A2+B1+C1+D15; A2+B2+C1+D15; A3+B1+C1+D15; A3+B2+C1+D15; A4+B1+C1+D15; A4+B2+C1+D15; A5+B1+C1+D15; A5+B2+C1+D15; A6+B1+C1+D15; A6+B2+C1+D15; A7+B1+C1+D15; and A7+B2+C1+D15; A1+B1+C2+D15; A1+B2+C2+D15; A2+B1+C2+D15; A2+B2+C2+D15; A3+B1+C2+D15; A3+B2+C2+D15; A4+B1+C2+D15; A4+B2+C2+D15; A5+B1+C2+D15; A5+B2+C2+D15; A6+B1+C2+D15; A6+B2+C2+D15; A7+B1+C2+D15; and A7+B2+C2+D15; A1+B1+C3+D15; A1+B2+C3+D15; A2+B1+C3+D15; A2+B2+C3+D15; A3+B1+C3+D15; A3+B2+C3+D15; A4+B1+C3+D15; A4+B2+C3+D15; A5+B1+C3+D15; A5+B2+C3+D15; A6+B1+C3+D15; A6+B2+C3+D15; A7+B1+C3+D15; and A7+B2+C3+D15; A1+B1+C4+D15; A1+B2+C4+D15; A2+B1+C4+D15; A2+B2+C4+D15; A3+B1+C4+D15; A3+B2+C4+D15; A4+B1+C4+D15; A4+B2+C4+D15; A5+B1+C4+D15; A5+B2+C4+D15; A6+B1+C4+D15; A6+B2+C4+D15; A7+B1+C4+D15; and A7+B2+C4+D15; A1+B1+C5+D15; A1+B2+C5+D15; A2+B1+C5+D15; A2+B2+C5+D15; A3+B1+C5+D15; A3+B2+C5+D15; A4+B1+C5+D15; A4+B2+C5+D15; A5+B1+C5+D15; A5+B2+C5+D15; A6+B1+C5+D15; A6+B2+C5+D15; A7+B1+C5+D15; and A7+B2+C5+D15; A1+B1+C6+D15; A1+B2+C6+D15; A2+B1+C6+D15; A2+B2+C6+D15; A3+B1+C6+D15; A3+B2+C6+D15; A4+B1+C6+D15; A4+B2+C6+D15; A5+B1+C6+D15; A5+B2+C6+D15; A6+B1+C6+D15; A6+B2+C6+D15; A7+B1+C6+D15; and A7+B2+C6+D15; A1+B1+C7+D15; A1+B2+C7+D15; A2+B1+C7+D15; A2+B2+C7+D15; A3+B1+C7+D15; A3+B2+C7+D15; A4+B1+C7+D15; A4+B2+C7+D15; A5+B1+C7+D15; A5+B2+C7+D15; A6+B1+C7+D15; A6+B2+C7+D15; A7+B1+C7+D15; and A7+B2+C7+D15; A1+B1+C8+D15; A1+B2+C8+D15; A2+B1+C8+D15; A2+B2+C8+D15; A3+B1+C8+D15; A3+B2+C8+D15; A4+B1+C8+D15; A4+B2+C8+D15; A5+B1+C8+D15; A5+B2+C8+D15; A6+B1+C8+D15; A6+B2+C8+D15; A7+B1+C8+D15; and A7+B2+C8+D15; A1+B1+C9+D15; A1+B2+C9+D15; A2+B1+C9+D15; A2+B2+C9+D15; A3+B1+C9+D15; A3+B2+C9+D15; A4+B1+C9+D15; A4+B2+C9+D15; A5+B1+C9+D15; A5+B2+C9+D15; A6+B1+C9+D15; A6+B2+C9+D15; A7+B1+C9+D15; and A7+B2+C9+D15; A1+B1+C10+D15; A1+B2+C10+D15; A2+B1+C10+D15; A2+B2+C10+D15; A3+B1+C10+D15; A3+B2+C10+D15; A4+B1+C10+D15; A4+B2+C10+D15; A5+B1+C10+D15; A5+B2+C10+D15; A6+B1+C10+D15; A6+B2+C10+D15; A7+B1+C10+D15; and A7+B2+C10+D15; A1+B1+C11+D15; A1+B2+C11+D15; A2+B1+C11+D15; A2+B2+C11+D15; A3+B1+C11+D15; A3+B2+C11+D15; A4+B1+C11+D15; A4+B2+C11+D15; A5+B1+C11+D15; A5+B2+C11+D15; A6+B1+C11; A6+B2+C11+D15; A7+B1+C1+D15; and A7+B2+C11+D15; A1+B1+C12+D15; A1+B2+C12+D15; A2+B1+C12+D15; A2+B2+C12+D15; A3+B1+C12+D15; A3+B2+C12+D15; A4+B1+C12+D15; A4+B2+C12+D15; A5+B1+C12+D15; A5+B2+C12+D15; A6+B1+C12+D15; A6+B2+C12+D15; A7+B1+C12+D15; and A7+B2+C12+D15; A1+B1+C1+D16; A1+B2+C1+D16; A2+B1+C1+D16; A2+B2+C1+D16; A3+B1+C1+D16; A3+B2+C1+D16; A4+B1+C1+D16; A4+B2+C1+D16; A5+B1+C1+D16; A5+B2+C1+D16; A6+B1+C1+D16; A6+B2+C1+D16; A7+B1+C1+D16; and A7+B2+C1+D16; A1+B1+C2+D16; A1+B2+C2+D16; A2+B1+C2+D16; A2+B2+C2+D16; A3+B1+C2+D16; A3+B2+C2+D16; A4+B1+C2+D16; A4+B2+C2+D16; A5+B1+C2+D16; A5+B2+C2+D16; A6+B1+C2+D16; A6+B2+C2+D16; A7+B1+C2+D16; and A7+B2+C2+D16; A1+B1+C3+D16; A1+B2+C3+D16; A2+B1+C3+D16; A2+B2+C3+D16; A3+B1+C3+D16; A3+B2+C3+D16; A4+B1+C3+D16; A4+B2+C3+D16; A5+B1+C3+D16; A5+B2+C3+D16; A6+B1+C3+D16; A6+B2+C3+D16; A7+B1+C3+D16; and A7+B2+C3+D16; A1+B1+C4+D16; A1+B2+C4+D16; A2+B1+C4+D16; A2+B2+C4+D16; A3+B1+C4+D16; A3+B2+C4+D16; A4+B1+C4+D16; A4+B2+C4+D16; A5+B1+C4+D16; A5+B2+C4+D16; A6+B1+C4+D16; A6+B2+C4+D16; A7+B1+C4+D16; and A7+B2+C4+D16; A1+B1+C5+D16; A1+B2+C5+D16; A2+B1+C5+D16; A2+B2+C5+D16; A3+B1+C5+D16; A3+B2+C5+D16; A4+B1+C5+D16; A4+B2+C5+D16; A5+B1+C5+D16; A5+B2+C5+D16; A6+B1+C5+D16; A6+B2+C5+D16; A7+B1+C5+D16; and A7+B2+C5+D16; A1+B1+C6+D16; A1+B2+C6+D16; A2+B1+C6+D16; A2+B2+C6+D16; A3+B1+C6+D16; A3+B2+C6+D16; A4+B1+C6+D16; A4+B2+C6+D16; A5+B1+C6+D16; A5+B2+C6+D16; A6+B1+C6+D16; A6+B2+C6+D16; A7+B1+C6+D16; and A7+B2+C6+D16; A1+B1+C7+D16; A1+B2+C7+D16; A2+B1+C7+D16; A2+B2+C7+D16; A3+B1+C7+D16; A3+B2+C7+D16; A4+B1+C7+D16; A4+B2+C7+D16; A5+B1+C7+D16; A5+B2+C7+D16; A6+B1+C7+D16; A6+B2+C7+D16; A7+B1+C7+D16; and A7+B2+C7+D16; A1+B1+C8+D16; A1+B2+C8+D16; A2+B1+C8+D16; A2+B2+C8+D16; A3+B1+C8+D16; A3+B2+C8+D16; A4+B1+C8+D16; A4+B2+C8+D16; A5+B1+C8+D16; A5+B2+C8+D16; A6+B1+C8+D16; A6+B2+C8+D16; A7+B1+C8+D16; and A7+B2+C8+D16; A1+B1+C9+D16; A1+B2+C9+D16; A2+B1+C9+D16; A2+B2+C9+D16; A3+B1+C9+D16; A3+B2+C9+D16; A4+B1+C9+D16; A4+B2+C9+D16; A5+B1+C9+D16; A5+B2+C9+D16; A6+B1+C9+D16; A6+B2+C9+D16; A7+B1+C9+D16; and A7+B2+C9+D16; A1+B1+C10+D16; A1+B2+C10+D16; A2+B1+C10+D16; A2+B2+C10+D16; A3+B1+C10+D16; A3+B2+C10+D16; A4+B1+C10+D16; A4+B2+C10+D16; A5+B1+C10+D16; A5+B2+C10+D16; A6+B1+C10+D16; A6+B2+C10+D16; A7+B1+C10+D16; and A7+B2+C10+D16; A1+B1+C11+D16; A1+B2+C1l +D16; A2+B1+C11+D16; A2+B2+C11+D16; A3+B1+C11+D16; A3+B2+C11+D16; A4+B1+C11+D16; A4+B2+C11+D16; A5+B1+C11+D16; A5+B2+C11+D16; A6+B1+C11; A6+B2+C11+D16; A7+B1+C11+D16; and A7+B2+C11+D16; A1+B1+C12+D16; A1+B2+C12+D16; A2+B1+C12+D16; A2+B2+C12+D16; A3+B1+C12+D16; A3+B2+C12+D16; A4+B1+C12+D16; A4+B2+C12+D16; A5+B1+C12+D16; A5+B2+C12+D16; A6+B1+C12+D16; A6+B2+C12+D16; A7+B1+C12+D16; and A7+B2+C12+D16; A1+B1+C1+C7; A1+B2+C1+C7; A2+B1+C1+C7; A2+B2+C1+C7; A3+B1+C1+C7; A3+B2+C1+C7; A4+B1+C1+C7; A4+B2+C1+C7; A5+B1+C1+C7; A5+B2+C1+C7; A6+B1+C1+C7; A6+B2+C1+C7; A7+B1+C1+C7; and A7+B2+C1+C7; A1+B1+C1+C7+D3; A1+B2+C1+C7+D3; A2+B1+C1+C7+D3; A2+B2+C1+C7+D3; A3+B1+C1+C7+D3; A3+B2+C1+C7+D3; A4+B1+C1+C7+D3; A4+B2+C1+C7+D3; A5+B1+C1+C7+D3; A5+B2+C1+C7+D3; A6+B1+C1+C7+D3; A6+B2+C1+C7+D3; A7+B1+C1+C7+D3; and A7+B2+C1+C7+D3; A1+B1+C1+C7+D13; A1+B2+C1+C7+D13; A2+B1+C1+C7+D13; A2+B2+C1+C7+D13; A3+B1+C1+C7+D13; A3+B2+C1+C7+D13; A4+B1+C1+C7+D13; A4+B2+C1+C7+D13; A5+B1+C1+C7+D13; A5+B2+C1+C7+D13; A6+B1+C1+C7+D13; A6+B2+C1+C7+D13; A7+B1+C1+C7+D13; and A7+B2+C1+C7+D13; A1+B1+C1+C7+D14; A1+B2+C1+C7+D14; A2+B1+C1+C7+D14; A2+B2+C1+C7+D14; A3+B1+C1+C7+D14; A3+B2+C1+C7+D14; A4+B1+C1+C7+D14; A4+B2+C1+C7+D14; A5+B1+C1+C7+D14; A5+B2+C1+C7+D14; A6+B1+C1+C7+D14; A6+B2+C1+C7+D14; A7+B1+C1+C7+D14; and A7+B2+C1+C7+D14; A1+B1+C1+C7+D15; A1+B2+C1+C7+D15; A2+B1+C1+C7+D15; A2+B2+C1+C7+D15; A3+B1+C1+C7+D15; A3+B2+C1+C7+D15; A4+B1+C1+C7+D15; A4+B2+C1+C7+D15; A5+B1+C1+C7+D15; A5+B2+C1+C7+D15; A6+B1+C1+C7+D15; A6+B2+C1+C7+D15; A7+B1+C1+C7+D15; and A7+B2+C1+C7+D15; A1+B1+C1+C7+D16; A1+B2+C1+C7+D16; A2+B1+C1+C7+D16; A2+B2+C1+C7+D16; A3+B1+C1+C7+D16; A3+B2+C1+C7+D16; A4+B1+C1+C7+D16; A4+B2+C1+C7+D16; A5+B1+C1+C7+D16; A5+B2+C1+C7+D16; A6+B1+C1+C7+D16; A6+B2+C1+C7+D16; A7+B1+C1+C7+D16; and A7+B2+C1+C7+D16.

Particularly preferred combinations include A1+B1+C1+D1; A1+B2+C1+D1; A2+B1+C1+D1; A2+B2+C1+D1; A6+B1+C1+D1; A6+B2+C1+D1; A7+B1+C1+D1; A7+B2+C1+D1; A1+B1+C7+D2; A1+B2+C7+D2; A2+B1+C7+D2; A2+B2+C7+D2; A6+B1+C7+D2; A6+B2+C7+D2; A7+B1+C7+D2; A7+B2+C7+D2; A1+B1+C7+D3; A1+B2+C7+D3; A2+B1+C7+D3; A2+B2+C7+D3; A6+B1+C7+D3; A6+B2+C7+D3; A7+B1+C7+D3; A7+B2+C7+D3; A1+B1+C7+D4; A1+B2+C7+D4; A2+B1+C7+D4; A2+B2+C7+D4; A6+B1+C7+D4; A6+B2+C7+D4; A7+B1+C7+D4; A7+B2+C7+D4; A1+B1+D13; A1+B2++C7+D13; A2+B1+C7+D13; A2+B2+C7+D13; A6+B1+C7+D13; A6+B2+C7+D13; A7+B1+C7+D13; A7+B2+C7+D13; A1+B1+C7+D1; A1+B2+C7+D1; A2+B1+C7+D1; A2+B2+C7+D1; A6+B1+C7+D1; A6+B2+C7+D1; A7+B1+C7+D1; A7+B2+C7+D1; A1+B1+C7+D2; A1+B2+C7+D2; A2+B1+C7+D2; A2+B2+C7+D2; A6+B1+C7+D2; A6+B2+C7+D2; A7+B1+C7+D2; A7+B2+C7+D2; A1+B1+C7+D3; A1+B2+C7+D3; A2+B1+C7+D3; A2+B2+C7+D3; A6+B1+C7+D3; A6+B2+C7+D3; A7+B1+C7+D3; A7+B2+C7+D3; A1+B1+C7+D4; A1+B2+C7+D4; A2+B1+C7+D4; A2+B2+C7+D4; A6+B1+C7+D4; A6+B2+C7+D4; A7+B1+C7+D4; A7+B2+C7+D4; A1+B1+D13; A1+B2++C7+D13; A2+B1+C7+D13; A2+B2+C7+D13; A6+B1+C7+D13; A6+B2+C7+D13; A7+B1+C7+D13; A7+B2+C7+D13. More particularly preferred combinations include A1+B1+C1+D1; A1+B2+C1+D1; A6+B1+C1+D1; A6+B2+C1+D1; A7+B1+C1+D1; A7+B2+C1+D1; A1+B1+C1+D2; A1+B2+C1+D2; A6+B1+C1+D2; A6+B2+C1+D2; A7+B1+C1+D2; A7+B2+C1+D2; A1+B1+C1+D3; A1+B2+C1+D3; A6+B1+C1+D3; A6+B2+C1+D3; A7+B1+C1+D3; A7+B2+C1+D3; A1+B1+C1+D4; A1+B2+C1+D4; A6+B1+C1+D4; A6+B2+C1+D4; A7+B1+C1+D4; A7+B2+C1+D4; A1+B1+C1+D13; A1+B2+C1+D13; A6+B1+C1+D13; A6+B2+C1+D13; A7+B1+C1+D13; A7+B2+C1+D13; A1+B1+C7+D1; A1+B2+C7+D1; A6+B1+C7+D1; A6+B2+C7+D1; A7+B1+C7+D1; A7+B2+C7+D1; A1+B1+C7+D2; A1+B2+C7+D2; A6+B1+C7+D2; A6+B2+C7+D2; A7+B1+C7+D2; A7+B2+C7+D2; A1+B1+C7+D3; A1+B2+C7+D3; A6+B1+C7+D3; A6+B2+C7+D3; A7+B1+C7+D3; A7+B2+C7+D3; A1+B1+C7+D4; A1+B2+C7+D4; A6+B1+C7+D4; A6+B2+C7+D4; A7+B1+C7+D4; A7+B2+C7+D4; A1+B1+C7+D13; A1+B2+C7+D13; A6+B1+C7+D13; A6+B2+C7+D13; A7+B1+C7+D13; A7+B2+C7+D13.

The compositions of the present invention may comprise, in addition to the usual adjuvants and fillers deployed in agrochemical compositions, inorganic or organic acids. Suitable acids are, for example and not for limitation, phosphoric acid, hydrochloric acid, sulphonic acids, hydroxyl-, carboxylic-, and dicarboxylic acids. The amount of acid by weight in the compositions may be up to ten times the amount of the active ingredients.

The compositions of the present invention may also comprise alkali metal, alkaline earth metal, metal, or ammonium salts. Zinc chloride and alkali metal, alkaline earth metal, or ammonium salts of mineral acids, especially nitrates, phosphates, sulfates, chlorides, and carbonates of sodium, potassium, ammonium, magnesium, and calcium are preferred.

The compositions of the present invention may additionally comprise micronutrients to aid in the nourishment and health of the plant and/or plant propagation material. Suitable micronutrients include, but are not limited to, chlorine (Cl), zinc (ZN), boron (B), copper (Cu), iron (Fe), manganese (Mn) or molybdenum (Mo). Micronutrients may be supplied in chelate form.

Depending upon the particular plant propagation material to be treated, the conditions under which it is to be stored, and the soil and weather conditions under which it is expected to germinate and grow, the compositions of the present invention may include a wide spectrum of one or more additives. Such additives include, but are not limited to, uv-protectants, pigments, dyes, extenders such as flour, dispersing agents, excipients, anti-freezing agents, preservatives, herbicidal safeners, seed safeners, seed conditioners, micronutients, fertilizers, biocontrol agents, inoculants, surfactants, sequestering agents, plasticizers, colorants, brighteners, emulsifiers, flow agents such as calcium stearate, talc and vermiculite, coalescing agents, defoaming agents, humectants, thickeners, waxes, bactericides, insecticides, pesticides, and fillers such as cellulose, glass fibers, clay, kaolin, talc, pulverized tree bark (e.g., Douglas fir bark or alderbark), calcium carbonate and wood meal, and odor-modifying agents. Typical excipients include finely divided mineral substances such as pumice, attapulgite, bentonite, kaoline zeolite, diatomite, and other clays, modified diatomaceous adsorbents, charcoal, vermiculite, finely divided organic substances such as peat moss, wood powder, and the like. Such additives are commercially available and known in the art.

Typically, when a mixture of the components is prepared, either as tank-mixes, pre-mixes, dry dust-mixes, wettable powders, granules, soluable concentrates, emulsifyable concentrates, or flowable solutions, other formulation auxiliaries may also be used. Such formulation auxiliaries are known in the art.

When the compositions of the present invention include a fungicide they may be useful for the reductive, preventive and the curative protection of the plant propagation material against fungi and fungal diseases including against fungi, in particular of the oomycetes which belong to the class of phycomycetes (e.g., Phytophthora spp., Peronospora spp., Pseudoperonospora spp., Pythium spp. [i.e. P. utimum, P. aphanidermatum, P. graminicola, P. irregulare) or Plasmopara sp.), basidiomycete (i.e. Puccinia spp. [P.recondita, P. striformis, and P.graminis], Tilletia spp. [i.e T. caries and T contreversa], Ustilago spp. [i.e. U. maydis, U. nuda, U. hordei, and U. avenae]), ascomycete (such as Gibberella spp. [i.e. G. fujikuroi, G. roseum] Glomerella spp. [i.e. G. gossypii]), adelomycete or Fungi Imperfecti type, such as Rhizoctonia spp. (i.e. R. solani, R. cerealis and R. zea), Fusarium spp. (i.e. F. solani, F. oxysporum, F. roseum, F. nivale, F. moniliforme, F. proliferatum, F. graminearum, F. subglutinans), Helminthosporium spp. (i.e. H. oryzae, H. teres, H. gramineum and H. sativum), Phoma spp. (i.e. P. betae, P. foveata and P. lingam), Alternaria spp. (i.e. A. solani, A. macrospora and A. alternata), Colletotriuchum (i.e. C. graminicola, C. coccodes, C. capsici, C. gossypii and C. truncatum), Erysiphe spp. (i.e. E. graminis and E. cichoracearum) Gaeumannomyces spp. (i.e. G. graminis var graminis and G. graminis var. tritici), Botrytis spp. (i.e. B. cinerea), Pyricularia spp. (i.e. P. grisea and P. oryzae), Cercosoora spp. (i.e. C. beticola), Rhinchosporium spp. (i.e. R. secalis), Pyrenophora spp. (i.e. P. avenae), Septoria spp. (i.e. S. tritici and S. avenae), Whetzelinia spp. (i.e. W. sclerotiorum), Microdochium spp., Mycosohaerella spp., (i.e. M. fijiensis), Aspergillus spp. (i.e. A. niger and A. flavus), Cercospora spp. (i.e. C. arachidicola and C. gossypina), Claviceps spp., Cladosporium spp. (i.e. C. herbarum), Penicillium spp., Pestalozzia sp, Verticillium spp. (i.e. V. dahliae), Ascochyta spp. (i.e. A. pisi and A. gossypii), Guignardia spp. (i.e. G. bidwellii), Corticium rolftsii, Phomposis spp. (i.e. P. viticola), Sclerotinia spp. (i.e. S. sclerotiorum and S. minor), Sclerotinia minor, Coryneum cardinale, Acrostalagmus koningi, Corticium rolfsii, Diplodia spp. (i.e. D. natalensis), Hormodendron cladosporioides, Myrothecium spp. (i.e. M. verrucaria), Paecylomyces varioti, Pellicularia sasakii, Phellinus megaloporus, Septoria spp., Sclerotium spp. (i.e. S. rolfsii), Stachybotris atra, Trichodenma ssp. (i.e. T. pseudokoningi), Thielaviopsis basicola and Trichothecium roseum.

The compositions of the present invention comprising (a) at least one plant growth regulator and at least one plant activator or (b) the combined role of the at least one plant regulator and the at least one plant activator (when used sequentially or as a single composition) are also useful for reducing diseases that may affect the growth and development of the plants. The derived advantages are obtained by combining the at least one plant growth regulator and the at least one plant activator applied (a) directly on the seed, either as a single formulation or applied sequentially, in any order, as separate seed treatment formulations, or (b) with the at least one plant growth regulator applied on the seed, either as a single formulation or applied sequentially, in any order, as separate seed treatment formulations, and subsequently at least one plant activator and an optional at least one plant growth regulator applied in the soil, growth media, or irrigation system, or (c) with the at least one plant growth regulator applied on the seed and subsequently at least one plant activator and an optional at least one plant growth regulator applied on the foliage and/or flowers of the plants at a later stage in growth and development, or (d) with the at least one plant growth regulator and an additional plant growth regulator applied on the seed, either as a single formulation or sequentially, in any order, as separate seed treatment formulations, and subsequently at least one plant activator applied in the soil, growth media, or irrigation system, and an optional at least one plant growth regulator applied in the soil, growth media, or irrigation system, or (e) with the at least one plant growth regulator and a separate plant growth regulator applied on the seed, either as a single formulation or sequentially, in any order, as separate seed treatment formulations, and subsequently the plant activator and an optional at least one plant growth regulator applied on the foliage and flowers of the plant at a later stage in growth and development, or any combination of the above applications of the at least one plant growth regulator, and the at least one plant activator to the plant, the propagation material or the plant environment or its growing media or irrigation system. Application of the compositions of the present invention may be applied as described above, independent of any additional active ingredients or micronutrients or growing agents described as optionally useful in the method of the present invention. Optionally, the additional active ingredients, micronutrients or growing agents may be applied to the plant, the plant propagation material, the plant environment, or the growing media as part of a single composition with the at least one plant growth regulator and at least one plant activator or as part of separate compositions applied simultaneously or sequentially.

The present invention additionally contemplates appling at least one plant growth regulator on the plant propagation material, preferably on a seed, allowing the at least one plant growth regulator to be taken up as the plant grows and develops, and providing a plant product having a better ability to tolerate and utilize the plant activator applied later as a foliar treatment or soil treatment. In other words, the at least one plant growth regulator acts as a “safener” to the application of a plant activator, at doses which would otherwise be phytotoxic had the “safener” (at least one plant growth regulator composition) not been applied.

The present invention further includes a method for protecting plants from damaging bacterial diseases such as bacterial canker (Clavibacter michiganense), bacterial spot (Xanthomonas campestris pv campestris, vesicatoria, spinaciae, vitians, translucens, carotae) bacterial speck (Pseudomonas syringae pv. Tomato, lachrymans, coronafaciens, striafaciens, apii) Pseudomonas gladioli, and pith necrosis (Psedomonas corrugata) Erwinia carotovora ssp. Carotovora, Erwinia. chrysanthemi, Erwinia betavasculorum, Erwinia spp.) Pectobacterium carotovorum ssp. Carotovorum, Enterobacter cloacae. Control of damaging bacterial diseases includes applying a composition comprising at least one plant growth regulator and at least one plant activator to the plant propagation material, particularly to the seed. The at least one plant growth regulator may be combined with the at least one plant activator to form a single composition, or the at least one plant growth regulator may be applied as a treatment onto the plant propagation material, i.e., as a single seed treatment, followed by application of the optional additional plant growth regulator(s) and the at least one plant activator as additional single or combined seed treatment. Additionally, the optional additional plant growth regulator(s) and the at least one plant activator can additionally be applied later as a foliar treatment or soil treatment or through various irrigation systems, including drip systems.

As a further embodiment, the present invention additionally provides a method for reducing bacterial disease in pre-transplant seedlings, on post-transplant plants, and on fruits and/or flowers of plants, the method comprising applying to plant propagation material, preferably a seed, a composition comprising at least one plant growth regulator and optionally at least one plant activator to the plant propagation material, particularly to the seed. The at least one plant growth regulator may be combined with the at least one plant activator to form a single composition, or the at least one plant growth regulator may be applied as a treatment onto the plant propagation material, i.e., as a single seed treatment, followed by application of the optional additional plant growth regulator(s) and the optional at least one plant activator as additional single or combined seed treatment. Alternatively, or additionally, the optional additional plant growth regulator(s) and/or the optional at least one plant activator can additionally be applied later as a foliar treatment or soil treatment or through watering systems.

A preferred embodiment of the invention includes a method for suppressing bacterial disease comprising treating plant propagation material, preferably a seed, with an effective amount of at least one plant growth regulator, preferably paclobutrazol, cyproconazole, uniconazole, a gibberellin, or a mixture thereof, and at least one plant activator, preferably acibenzalor-S-methyl or harpin, and optionally additional pesticidal agents such as insecticides, fungicides, molluscocides, and nematicides, planting the propagation material, and achieving bacterial suppression in the planted material and in the resulting plant. Additionally, further post-emergent pesticidal treatments may be applied to control other agricultural pests including, but not limited to, fungi, insects, weeds, bacteria, nematodes, and the like.

An additional preferred embodiment of the invention includes a method for suppressing bacterial disease comprising treating plant propagation material, preferably a seed, with an effective amount of a composition comprising at least one plant growth regulator, preferably paclobutrazol, cyproconazole, uniconazole, a gibberellin, or a mixture thereof, planting the propagation material, treating the emergent plants with a plant activator, preferably acibenzalor-S-methyl or harpin, and achieving bacterial suppression in the resulting plant and its flowers and/or fruit. Additionally, further post-emergent pesticidal treatments or pre-planting seed treatments may be applied to control other agricultural pests including, but not limited to, fungi, insects, weeds, bacteria, nematodes and the like.

An additional preferred embodiment of the invention includes a method for suppressing bacterial disease comprising treating plant propagation material, preferably a seed, with an effective amount of a composition comprising at least one plant growth regulator, preferably paclobutrazol, cyproconazole, uniconazole, a gibberellin, or a mixture thereof, and at least one plant activator, optionally in combination with additional pestidal seed treatments, preferably fungicides and/or insecticides and/or nematicides, planting the propagation material, and achieving bacterial suppression in the planted material and in the resulting plant and its flowers and/or fruit. Additionally, further post-emergent pesticidal treatments may be applied to control other agricultural pests including, but not limited to, fungi, insects, weeds, bacteria, nematodes and the like.

An additional preferred embodiment of the invention includes a method for suppressing bacterial disease comprising treating a seed with an effective amount of a composition comprising at least one plant growth regulator selected from paclobutrazol, cyproconazole, uniconazole, a gibberellin, or a mixture thereof, in combination with at least one plant activator, planting the propagation material, and achieving bacterial suppression in the planted material and in the resulting plant and its flowers and/or fruits. Additionally, further post-emergent pesticidal treatments or pre-planting seed treatments may be applied to control other agricultural pests including, but not limited to, fungi, insects, weeds, bacteria, nematodes and the like.

The compositions and methods of the present invention additionally reduce damge from and/or protect plants from damaging viral diseases such as, but not limited to, Alfalfa mosaic, Cucumber mosaic diseases, Double Streak Potato virus, Tobacco Mosiac, Spotted Wilt virus and other diseases. The composition of at least one plant growth regulator and at least one plant activator also reduces damage and/or protects plants from damaging fungal diseases such as, but not limited to, Fusarium wilt (Fusarium oxyporum), Fusarium Crown rot (Fusarium oxysporum f.sp. radicis, spetoria leaf spot (Septoria lycopersica), Downy mildew and late blight (Phytopthora infestans), early blight (Alternaria solani), powdery mildew (Leveillula taurica), Phoma rot (Phoma destructiva), Leaf Mold (Fulviafilva), Grey Mold (Botrytis cinera), Grey Leaf Spot (Stemphylium solani), Anthracnose (Colletotrichum coccodes), Corky or Brown Root Rot (Pyrencochaeta lycopersici), Scletotinia Stem Rot (Sclerotinia Scleotiorum), Gummy Stem blight (Didymella bryoniae), Scab or Gummosis (Cladosporium cucumerinum), and several fruits rots, among other fungal diseases.

Specifically contemplated by the present invention is the “safening” effect provided by at least one plant growth regulator and optional at least one plant activator when applied as a seed treatment and followed by post-emergence application of plant activator other pesticides. The safening effect also includes post-emergence application of fungicides, insecticides, nematicides, herbicides, growth regulators, nutritional elements, surfactants, bio-enhancers, organic substances and other substances intended to promote growth and development of a plant material, including transplants.

Accordingly, the present invention further provides a method for safening against post-emergence application of plant activators, plant growth regulators, and/or other pesticides comprising applying to plant propagation material, preferably a seed, at least one plant growth regulator, optionally at least one plant activator, and optionally additional seed treatment pesticides such as nematicides, fungicides and insecticides. The safening effect also includes protection against post-emergence application of fungicides, insecticides, nematicides, herbicides, growth regulators, plant activators, nutritional elements, surfactants, bio-enhancers, organic substances and other substances intended to protect and promote growth and development of plant material, including transplants.

A further embodiment includes a method for safening against post-emergence application of plant activator and/or other pesticides comprising treating plant propagation material, preferably a seed, with an effective amount of a composition comprising at least one plant growth regulator, preferably paclobutrazol, cyproconazole, uniconazole, or a gibberellin, or a mixture thereof, and optionally at least one plant activator, optionally in combination with additional pestidal seed treatments, preferably fungicides and/or insecticides and/or nematicides, planting the propagation material, and achieving protection against post-emergent application of plant activators, insecticides, fungicides, nematicides, herbicides, growth regulators, plant activators, nutritional elements, surfactants, bio-enhancers, organic substances and other substances intended to protect and promote growth and development of plant material.

The safening effect is found in direct-seeded and transplanted crops and plants, as described herein, preferably in tomato plants. Additionally, the safening effect of the composition of the present invention is found in transgenic crops, particularly in plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal, nematicidal, or fungicidal resistance.

When the compositions of the present invention include an insecticide and/or nematicide, they may be useful for the reductive, preventive and the curative protection of the plant propagation material and transplants against insects and nematodes and diseases caused by and transmitted by insects and/or nematodes. Compositions and methods according to the invention having an additional insecticide agent may be used for the protection of the plant propagation material and developing plants, including transplants, against animal pests, including nematodes, such as pests from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.;

from the order Coleoptera, for example, Agriotes spp., Anthonomus spp., Atomaria linearis, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Tenebrio spp., Tribolium spp. and Trogoderma spp.;

from the order Orthoptera, for example, Blatta spp., Blattella spp., Gryllotalpa spp., Leucophaea maderae, Locusta spp., Periplaneta spp. and Schistocerca spp.;

from the order Isoptera, for example, Reticulitermes spp.;

from the order Psocoptera, for example, Liposcelis spp.;

from the order Anoplura, for example, Haematopinus spp., Linognathus spp., Pediculus spp., Pemphigus spp. and Phylloxera spp.;

from the order Mallophaga, for example, Damalinea spp. and Trichodectes spp.;

from the order Thysanoptera, for example, Frankliniella spp., Hercinothrips spp., Taeniothrips spp., Thrips palmi, Thrips tabaci and Scirtothrips aurantni;

from the order Heteroptera, for example, Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.;

from the order Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri;

from the order Hymenoptera, for example, Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.;

from the order Diptera, for example, Antherigona soccata, Bibio hortulanus, , Ceratitis spp., Chrysomyia spp., Culex spp., Cuterebra spp., Dacus spp., Delia spp., Drosophila melanogaster, Liriomyza spp., , Melanagromyza spp., Orseolia spp., Oscinella frit, Pegomyia hyoscyami, Phorbia spp., Rhagoletis pomonella, Sciara spp.;

from the order Acarina, for example, Acarus siro, Aceria sheldoni, Aculus schlechtendali, Amblyomma spp., Argas spp., , Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; and

from the class Nematoda, for example, the species of Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonlaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

When the compositions of the present invention include a nematicide they may be useful for the reductive, preventive and the curative protection of the plant propagation materials, plants, and transplants against nematodes and diseases caused by or transmitted by nematodes. Compositions and methods according to the invention having an additional nematicide may be used for the protection of the plant propagation materials, transplants, and developing plants against representatives of the class Nematoda including, for example: root knot nematodes, stem eelworms and foliar nematodes; especially Heterodera spp., for example Heterodera schachtii, Heterodora avenae and Heterodora trifolii; Hoplolaimus spp. such as Hoplolaimus galeatus and Hoplolaimus columbus; Globodera spp., for example Globodera rostochiensis; Meloidogyne spp., for example Meloidogyne incoginita and Meloidogyne javanica; Radopholus spp., for example Radopholus similis; Rotylenchulus spp. such as R. reniformis; Pratylenchus spp., for example Pratylenchus neglectans and Pratylenchus penetrans; Tylenchulus spp., for example Tylenchulus semipenetrans; Belonolaimus spp.; Longidorus spp.; Trichodorus spp.; Xiphinema spp.; Ditylenchus spp.; Aphelenchoides spp.; and Anguina spp.; in particular Meloidogyne spp., for example Meloidogyne incognita, and Heterodera spp., for example Heterodera glycines.

The form of the active ingredients may be selected so as to optimize the application or the bioperformance of the compositions. The forms of the active ingredient compositions may be selected, depending on these intended aims and the prevailing circumstances, from solutions, emulsifiable concentrates, suspension concentrates, directly sprayable or dilutable solutions, emulsions, microemulsions, suspo-emulsions, aqueous capsule suspensions, spreadable pastes, dilute emulsions, sprayable powders, soluble powders, dispersible powders, wettable powders, slurries, dusts, granules or encapsulations.

The term “plant propagation material” is understood to denote all the generative parts of the plant, including but not limited to seeds, which can be used for the multiplication of the latter and vegetative plant material such as cuttings and tubers (for example, potatoes). There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. A preferred plant propagation material is the seed. In an aspect of the present invention, these young plants and generative parts may be protected before transplantation by a total or partial treatment, for example, by treatment, for example by immersion, by a pesticide, e.g. in the form of a pesticidal composition, according to the present invention. The term “seed” to be treated with the compositions of the present invention means a plant body of the initial stage of cultivation used for reproduction of plants, and involves not only the so-called seeds but also plant bodies for nutrient reproduction such as bulb, tuber, seed tuber, aerial tuber, scaly bulb, stalks for cuttage, and the like.

The terms “soil” or “plant environment” for plants in the practice of the methods of the present invention mean a support for use in culture of a plant and especially a support in which roots are to be grown. The terms are not limited in material quality, but include any material that may be used so far as a plant can be grown therein. For instance, so-called various soils, seedling mat, tapes, water or hydroponic solutions and the like can also be used. Specific examples of the materials constituting the soil or cultivation carriers include, without limitation, sand, peat moss, perlite, vermiculite, cotton, paper, diatomaceous earth, agar, gelatinous materials, polymeric materials, rock wool, glass wool, wood chips, bark, pumice and the like, or their mixtures involving one or many of the mentioned materials.

Treating a seed or other plant propagation materials includes any process by which an active ingredient is made to adhere to the seed or material. Such treatment includes, but is not limited to, dressing, including liquid dressing, dust dressing, and slurrying, encrusting, coating (particularly film coating), conditioning, layering, encapusulation, soaking, pelleting, washing, kerneling, injecting, and other methods known in the art.

The plant propagation material may additionally be overcoated with the composition of the present invention, if the material has already been treated with other agrochemicals. Similarly, the plant propagation material may be overcoated with additional agrochemical compositions if the propagation material is first treated with the composition of the present invention. Various materials are suitable for overcoating including but not limited to, methyl cellulose, hydroxypropylmethylcellulose, dextrin, gums, waxes, vegetable or paraffin oils; water soluble or water disperse polysaccharides and their derivatives such as alginates, starch, and cellulose; and synthetic polymers such as polyethylene oxide, polyvinyl alcohol, polyacrylamides and polyvinylpyrrolidone and their copolymers and related polymers including mixtures of such polymers. The overcoat, if present, may optionally include any additives or pesticides such as those previously mentioned. Additionally, controlled release materials, as are known in the art, may be used with the compositions of the present invention.

Loading active ingredients onto a seed is an imperfect process. The amount of active ingredient contained on an individual seed varies according to the treatment process and type. The present invention provides for loading onto an individual seed an amount from 0.01 to 20 μg/seed, more particularly from 0.01 to 15 μg/seed, 0.1 to 10 μg/seed, or 0.1 to 5 μg/seed. Preferably, loading onto an individual seed ranges from 0.01 to 10 μg/seed; more preferably, from 0.01 to 5 μg/seed of total plant growth regulator. The plant activator is applied at rates from 0.01 to 20 μg/seed, more particularly from 0.01 to 15 μg/seed, 0.01 to 10 μg/seed, 0.1 to 1.0 μg/seed, 0.1 to 0.5 μg/seed. The plant activator applied post emergence to the plants or plant materials originating from seeds treated by the at least one plant growth regulator may be applied at a higher rate than is applied on the seed or plant propagating material.

The loading process of the present invention comprises direct seed slurry treatments using a spin disc applicator (e.g., Hege treater), batch or continiuos flow treaters, fluidized bed applicators, rotostatic applicators, film coaters, pan coaters, bag treaters, and any other seed treatment process known in the art. Accordingly, by the process of the present invention, it is possible to achieve a specific loading rate on a per seed basis. More particularly, a loading rate of active ingredient as defined above may be loaded onto each individual seed.

In another embodiment of the present invention, a method is provided for treating plants or plant propagation materials with a composition comprising at least one plant growth regulator and a plant activator. The method may further optionally comprise an additional pesticide, as defined above.

When unconcerned about the amount of active ingredient on a per seed basis, the formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

The compositions and methods of the present invention may be useful on primed and unprimed seeds. Priming is a water-based process known in the art that is performed on seeds to increase uniformity of germination and emergence from a growing medium or soil, thus enhancing plant stand establishment. By incorporating the compositions of the present invention comprising at least one plant growth regulator and at least one plant activator into the priming process, or by incorporating at least one plant growth regulator into the priming process and applying at least one plant activator post-emergence the benefits of optimum seed germination, optimum growth and development, synchronized time to flower, uniform flowering, uniformity in maturity of the crop, improved yields and improved quality of the harvested crop (fruit or other plant parts) are obtained. The time span between the emergence of the first and the last seedlings can be decreased more than with priming alone. As with priming, incorporation of the compositions and methods of the present invention into the priming process also increases the rate of emergence, so the plant stand establishes itself faster, ensuring maximum cartons of crop per acre at harvest. Wide ranges in times of seedling emergence decrease the amount of harvestable plants per acre, an undesirable situation for the commercial grower.

The present invention further includes a method comprising promoting germination of a plant by treating the plant, its environment, or its plant propagation material with an effective amount of a composition comprising at least one plant growth regulator and a plant activator and, optionally, at least one additional pesticide agent, as defined above, applied either as additional seed treatment or applied to the plant environment pre- or post-emergence.

Plant environment is considered to be the plant itself or the growing media of the plant, including soil surrounding the plant, both in the field and in pre-transplant conditions and greenhouse environments. Treatment of plants and/or their environments with a composition of the present invention includes, without limitation, root dipping, drenching, media spraying, foliar spraying, liner dipping, plug dipping, tray dipping, in-furrow, injection, fumigation, seed soaking and seed treatment, as described above. Preferably, treatment includes seed treatment and various dipping methods.

Promotion of germination is generally measured by tracking the percentage of seeds treated according to the methods of the present invention that germinate per the number of seeds planted, usually in comparison to the untreated seeds. In an alternative method, promotion of germination may be measured by tracking the percentage of seeds treated according to the methods of the present invention that result in plant shoot length (measured) within a given period of time. Likewise, root length, or bio-mass produced within a given time may be measured for plants or plant propagation material treated according to the methods of the present invention. By measuring changes in leaf color, stem thickness, number of foliage fully opened, or other plant characteristics occurring post-emergence, the promotion of germination may be quantified.

In another aspect, the present invention includes a method comprising enhancing the transplant health of a plant by treating the plant, its environment, or its plant propagation material with an effective amount of a composition comprising at least one plant growth regulator and a plant activator. Such method may further comprise, optionally, at least one additional pesticide, as defined above, applied as an additional seed treatment or applied to the plant or its environment.

As used herein, enhanced transplant health is indicated by improvements in one or more observed plant traits as compared to untreated plants. Examples of enhanced plant traits include, but are not limited to, increased stem girth, change in leaf color, early flowering, synchronized flowering, decreased lodging, delaying or eliminating tie-up of crops, increased disease resistance, enhanced water utilization/improved water use efficiency, including but not limited to decreased watering and/or less frequent watering (demonstrated by less wilting of the plant, the ability of the plant to rejuvenate following a suspension in watering), higher yield, higher quality/healthier plant appearance, greater transportability, decreased insect damage, and smaller plant canopies.

Synchronized flowering is indicated by blooms materializing within 0.5 to 1 days of one another throughout the entire crop. Preferably, synchronized flowering is indicated by at least 75% of the crops having blooms appear within 0.5 to 1 days of one another. Preferably, synchronized flowering is indicated by crop and flower harvesting of 90% of the crop within 0.5 to 1 days of one another.

Early flowering is considered to be blooms appearing within 1-4 weeks after transplanting. Early flowering is indicated by blooms materializing at a time earlier than untreated plants and/or plant materials. More specifically, early flowering is indicated by blooms and/or flowers materializing in at least 75% of the crop more than 2-7 days sooner than untreated plants and/or plant materials.

The significance of early, timed and synchronized flowering lends the crop to set fruits, pods or cobs from those flowers at a preferred time to meet marketing needs. This advantage is particularly useful in commercial crop production, weather direct seeded or transplanted, because a larger percentage (>75 to 90%) of the harvestable yields are rendered acceptable in the markets. Synchronized flowering and pod or fruit set also pre-dispose plants to uniform maturity and time to harvest. This induced advantage is useful in commercial crop production, whereby producers are able to maximize marketable yieds from the crop.

Transportability is used herein to describe the ability to move and/or transplant plants from one location to another without causing damage to the plants. For instance, and not for limitation, transportability is used to describe the ability to stack, ship, store, and transplant pre-transplanted plants. Improved transportability refers to the ability to minimize lodging and snapping and reduce mortality and other damage to plants occurring during the moving process. Generally, improved transportability refers to plants having less damage from the moving process than plants not treated with the composition of the present invention. Damage is measured by overall appearance of the plants, stem appearance, snap counts, plant vigor, leaf color, shape and health of seedling, and plant life itself.

In another aspect, the present invention provides a method for optimizing the canopy of plants by treating the plant, its environment, or plant propagation material with a composition comprising at least one plant growth regulator and at least one plant activator. Such method may further comprise, optionally, at least one additional pesticide, as defined above and applied either as additional seed treatment or in any pre- or post-emergent application.

Optimized plant canopy is indicated by an increase of field plants and/or greenhouse plants in one or more of the following indicators, as compared to untreated plants: increased nodes on plant; increased plant fruit and/or flowers; improved harvesting efficiency; decreased watering requirements; reduced plant surface area; reduced insect damage; reduced crop input requirements; more compact plant; improved light capture and photosynthetic efficiency.

Increased nodes on a plant are indicated by an actual increase in the number of growth nodes on the stem or a conservation of the natural genetic potential to form nodes on the plant.

Increased fruit and/or flowering are indicated by an actual increase in the overall number or size of blooms or by an increase in the overall number or size of harvested fruit.

Improved harvesting efficiency is indicated by plants having somewhat uniform size, somewhat uniform flowering and/or fruit maturation, yield quality, durability, and inputting requirements. Uniformity in these areas enables the grower to minimize the harvesting passes through a growing field. Additionally, uniformity in these areas allows for automation in harvesting and equipment selection based on a common standard.

Improved harvesting efficiency is measured relative to untreated plants. A crop is considered to have an improved harvesting efficiency when it has one or more of the following characteristics: uniform size, earlier flowering, synchronized flowering, synchronized fruit/flowering maturation, uniform size of fruit or pod, uniform ripening (coloring), increased yield quality, increased plant stamina/durability, and decreased inputting requirements.

Inputting requirements are considered to be any care and attention required to be given to the crop. These requirements include, for example and not for limitation, amount, frequency and type of fertilizers, nutrients, including micronutrients, and/or pesticides applied, frequency of weeding, pruning, or tilling, and frequency and quantity of watering.

Application of a composition of the present invention reduces the inputting requirements of a plant. Reduction of inputting requirements is considered to be a reduction in one or more of the inputting requirements described above. Reduction may be obtained on a single inputting function or it may be a measure of the overall inputting to the plant, or both. Quantifying the reduction is measured relative to untreated plants. Accordingly, the invention further provides a method for reducing the inputting requirements of a plant comprising applying to a seed of the plant or to plant propagation material an effective amount of a composition comprising at least one plant growth regulator and at least one plant activator. The composition may optionally comprise at least one additional pesticide, as provided above.

The compositions and methods of the present invention further improve the post harvest shelf life of the fruit, pod, vegetable, or flower of the plant. Plants treated with the compositions of the present invention will show increased storage stability, as demonstrated by shelf life in transit, shelf life in home, refrigerators, and the like. Additionally, post-harvest processing of fruits, vegetables and flowers of plants treated according to the methods of the present invention will show improved processing qualities including, but not limited to recovery, peeling, pulping, total soluble solids, better Brix, and the like. Such improved qualities are measured against untreated plants.

Treatment with an effective amount of a composition comprising at least one plant growth regulator and at least one plant activator will result in plants having healthier, more compact canopy sizes. The overall surface area of such compact plants, and/or plant crops, results in reduced insect pressure. Accordingly, the present invention provides for a method for controlling pest damage on, in or to a plant comprising treating the plant, its environment, or plant propagation material with an effective amount of a composition comprising at least one plant growth regulator and at least one plant activator. Such method may further comprise, optionally, at least one additional pesticide, as defined above, and applied to the plant propagation material prior to planting or to the plant and/or its environment. Pest damage includes pests as defined above. Contolling pest damage includes reducing the number of pests on the plant, minimizing the damage to the plant caused by the presence of pests on the plant, and minimizing the damage to the plant caused by or transmitted by diseases caused by such pests.

Overall surface area of a plant treated either as a pre-planted plant propagation material or post germination with a composition of the present invention is measured relative to untreated plants. Measurements may be obtained prior to flowering or post-flowering.

The present invention additionally provides for a process for improving the harvest maturity of plants. By treating the plant, its environment or its propagation material with a composition comprising at least one plant growth regulator and at least one plant activator, the maturation of the plant is uniform, aiding in timing harvest of the crop.

In addition to the methods of application discussed above, a method for spraying the composition of the present invention to the stalks and leaves of plants post emergence, a method of diluting a liquid preparation such as emulsifiable concentrate, flowable agent or a solid preparation such as wettable powder or wettable granular composition with a proper quantity of water and then spraying the dilution to leaves and stalks of plants post emergence, and a method of applying a composition in powder or granular form are also included in the treatment processes contemplated by the present invention. In each of the methods contemplated herein, the compositon of the present invention may optionally be applied at the same time as, before, or after at least one additional pesticide composition, as described above.

In addition to the methods of application discussed above, a method for applying the composition to the soil, a method of applying a liquid preparation either diluted or undiluted with water to the base of stalks, seedling beds for raising seedlings, or the like, a method of spraying a granular agent to the stalk base or seedling bed, a method of spraying a dust, a wettable powder, a wettable granule or a granular agent to the soil and mixing it with the whole soil either before seeding or before transplantation, a method of spraying a dust, a wettable powder, a wettable granule, a granular agent or the like to planting holes, planting rows, and the like are included in the treatment processes contemplated by the present invention. In each of the methods contemplated herein, the compositon of the present invention may optionally be applied at the same time as, before, or after at least one additional pesticide composition, as described above.

The compositions and/or methods according to the present invention are suitable for use on any plant, including but not limited to the following crops: cereals (wheat, barley, rye, oats, corn, rice, sorghum, triticale and related crops); beet (sugar beet and fodder beet); forage crops (alfalfa, clover, and related crops); leguminous plants (beans, lentils, peas, soybeans); oil plants (rape, mustard, peanuts, canola, sunflowers); cucumber plants (marrows, cucumbers, melons); fibre plants (cotton, flax, hemp, jute); vegetables (spinach, lettuce, peppers, asparagus, cabbages, broccoli, cauliflower, carrots, onions, tomatoes, potatoes, paprika); tobacco; as well as ornamentals (flowers, shrubs, broad-leaved trees and evergreens, such as conifers), and on turf.

When the compositions and/or methods according to the present invention are used on ornamental crops, including floweres, shrubs, broad-leaved trees and evergreens, the following specific ornamental crops may be included: Ageratum, Alonsoa, Anémones, Anisodontea capsenisis, Anthemis, Antirrhinum, Azalées (Rhododendron), Begonia Elatior, Bégonia semperflorens, Bégonia tubéreux, rhizomateux, Bougainvillés, Brachycome, Calceolaria, Capsicum annuum, Catharanthus roseus, Ornamental Brassica, Chrysanthemum, Cineraria (Cinéraire maritime), Cinéraires hybrides, Crassula coccinea, Cuphea ignea, Dicentra spectabilis, Dorotheantus, Eustoma grandiflorum, Forsythia, Fuchsia spp., Gnaphalium, Gomphrena globosa (pot), Heliotropium, Helianthus, Hibiscus,m, Hortensia, Hypoestes phyllostachya, Impatiens de Nouvelle Guineé, Impatiens, Impatiens walleriana, Iresines, Kalanchoës Hybrides, Lantana camara, Lavatera trimestris, Leonotis leonurus, Lilium, Mesembryanthemum, Mimulus, Nemesia, Tagetes, Carnation, Canna, Oxalis, Bellis, Pelargonium peltatum, Pelargonium zonale, Pensées (Pansy), Pétunia, Plecthranthus, Poinsettia, Primula, Ranunculus, Rosa, Salvia, Scaevola aemola, Schizanthus wisetonensis, Solanum, Surfinia, Nicotinia, Verbena hybrides et tapien, and other bedding plants. Preferred within this class of ornamental crops are pansy, petunia, begonia, impatiens, geranium (including from seeds and cuttings), Chrysanthemum (including from cuttings), Rosa (including pot plants and from cuttings), Poinsettia, Ranunculus, Fuchsia, Salvia, Hortensia, and other bedding plants, including perennials.

Suitable target crops also include transgenic crop plants of the foregoing types. The transgenic crop plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or transgenic plants which are capable of synthesizing such toxins, have been disclosed, for example, in EP-A-0 374 753, WO 93/07278, U.S. Pat. No. 5,530,195, EP-A-0 427 529 and EP-A-451 878 and are incorporated by reference in the present application.

Additionally, target crops also include plants produced for plant pharmaceuticals and/or neutraciticals. Where bioengineered plant genes exhibit a reduced expression due to abiotic stress, the present invention provides for enhanced or normalized expression under such stress. A composition comprising at least one plant growth regulator and at least one plant activator, as described herein, enhances the ability of plants to produce essential compounds that are utilized in preparing plant neutraciticals, plant based oils, plant based fibre, plant based therapeutic substances, plant based narcotics, plant based latex, plant based drugs, plant based pesticides, plant based alkaloids, green manure, forage, seeds for feeding birds and animals and the like.

The following Examples are given by way of illustration and not by way of limitation of the invention. As used herein, the designations of rate (1), rate (2), rate (3), and so on, are intended to show increasing rates of treatment, with rate (1) being the lowest rate of active ingredient applied and (2) being the next lowest rate, and so on. The data are intended to show relative activity between different rates of the same active ingredient and are not intended to correspond to a particular amount of active ingredient. Additionally, the terms define rates that are relative to treatment rates of the same active ingredient within each example. Unless specifically noted that the treatment rates correspond to a previous example, the values of these relative rates in one example may represent a different value in another example. For example, the “rate (3)” for treatment 5 in Example 1 corresponds to the same rate value of “rate (3)” for treatment 8 in Example 1, but is not intened to infer equivalence to the “rate (3)” value used in Example 3.

### EXAMPLE 1

### Effects of PGR and Plant Activator on Emergence of Fresh Market Cucumbers

Trials were conducted on cucumber variety Dasher II to determine the effects of seed treatments with plant growth regulators on emergence of the plants.

Using seeds of cucumbers, Var. Dasher II, seeds were treated and planted in greenhouse trials. Treatments consisted of (a) fludioxonil+mefenoxam, (b) fludioxonil+mefenoxam+paclobutrazol at rate (1), (c) fludioxonil+mefenoxam+paclobutrazol at rate (2), (d) fludioxonil+mefenoxam+paclobutrazol at rate (3), (e) fludioxonil+mefenoxam+paclobutrazol at rate (4), (f) fludioxonil+mefenoxam+acibenzolar-S-methyl, and (g) fluxioxonil+mefenoxam+paclobutrazol at rate (3)+acibenzolar-S-methyl. The treatments were compared with untreated check.

The results show that seeds treated with fungicides+paclobutrazol emerged later than the fungicide-only treated seeds and later than the untreated check. Additionally, the seeds treated with fungicides+paclobutrazol+acibenzolar-S-methyl emerged later and stockier than the fungicide-only and untreated check plants. The results are shown in Table A.

### EXAMPLE 2

### Effect of PGR Seed Treatments on Growth of Fresh-Market Cucumbers

Using the same protocol as described in Example 1, the growth of the resulting plants was measured and compared for each treatment against the untreated check. Results are shown in Table B.

TABLE A

| | No. Plants | | No. Plants | | No. Plants | | No. Plants | | No. Plants |
|---|---|---|---|---|---|---|---|---|---|
| | Emerged | | Emerged | | Emerged | | Emerged | | Emerged |
| | 6-Apr | | 8-Apr | | 9-Apr | | 10-Apr | | 12-Apr |
| CHECK UNTREATED | 0 | a | 16 | a | 22.5 | a | 23.8 | ab | 24 |
| Mefenoxam/fludioxonil | 0 | a | 9.3 | b | 22.8 | a | 24 | a | 24 |
| Mefenoxam/fludioxonil + | 0 | a | 2.5 | cd | 18 | b | 24 | a | 23.8 |
| rate (1) PBZ/seed | | | | | | | | | |
| Mefenoxam/fludioxonil + | 0 | a | 0 | d | 15.6 | b | 23.3 | c | 22.9 |
| rate (2) PBZ/seed | | | | | | | | | |
| Mefenoxam/fludioxonil + | 0 | a | 0.2 | d | 13.2 | c | 23.8 | ab | 23.8 |
| rate (3) PBZ/seed | | | | | | | | | |
| Mefenoxam/fludioxonil + | 0 | a | 0.7 | d | 12.5 | c | 23.7 | abc | 23.8 |
| rate (4) PBZ/seed | | | | | | | | | |
| Mefenoxam/fludioxonil + | 0 | a | 5.2 | c | 22.2 | a | 23.7 | abc | 23.8 |
| acibenzolar-S- | | | | | | | | | |
| methyl/seed | | | | | | | | | |
| Mefenoxam/fludioxonil + | 0 | a | 0.2 | d | 16 | b | 23.3 | bc | 23.5 |
| rate (3) PBZ/seed + | | | | | | | | | |
| acibenzolar-S- | | | | | | | | | |
| methyl/seed | | | | | | | | | |

TABLE B

| | Plant Height (cm) | | Plant Height (cm) | | Plant Height (cm) |
|---|---|---|---|---|---|
| | 15-Apr | | 22-Apr | | 27-Apr |
| CHECK UNTREATED | 10.1 | a | 19 | a | 19.3 |
| Mefenoxam/fludioxonil | 10 | a | 19 | a | 18.8 |
| Mefenoxam/fludioxonil + | 4.5 | b | 15.4 | b | 15.7 |
| rate (1) PBZ/seed | | | | | |
| Mefenoxam/fludioxonil + | 3.7 | c | 11.4 | c | 12.3 |
| rate (2) PBZ/seed | | | | | |
| Mefenoxam/fludioxonil + | 3.3 | cd | 8.9 | d | 9.7 |
| rate (3) PBZ/seed | | | | | |
| Mefenoxam/fludioxonil + | 3 | d | 7.6 | d | 8.5 |
| rate (4) PBZ/seed | | | | | |
| Mefenoxam/fludioxonil + | 10.2 | a | 19.8 | a | 19.2 |
| acibenzolar-S- | | | | | |
| methyl/seed | | | | | |
| Mefenoxam/fludioxonil + | 3.7 | c | 11.6 | c | 12.2 |
| rate (3) PBZ/seed + | | | | | |
| acibenzolar-S- | | | | | |
| methyl/seed | | | | | |

### EXAMPLE 3

### Effect of PGR Vigor of Fresh Market Cucumbers after Wind and Cold Stress

Using the plants resulting from the treatment of Example 1, the cucumber seedlings were moved outdoors to harden off for field planting. After two days of drizzly, cloudy weather outside, the sun came out with extremely gusty winds and cold temperatures in the mid-thirties. All plants from the trial of Example 1 were exposed to this stress. Vigor measurements were taken for each of the treatments. The results are provided in Table C.

TABLE C

| | % Vigor |
|---|---|
| CHECK UNTREATED | 58.3 |
| Mefenoxam/fludioxonil | 56.7 |
| Mefenoxam/fludioxonil + rate (1) PBZ/seed | 78.3 |
| Mefenoxam/fludioxonil + rate (2) PBZ/seed | 94.4 |
| Mefenoxam/fludioxonil + rate (3) PBZ/seed | 98.3 |
| Mefenoxam/fludioxonil + rate (4) PBZ/seed | 99.7 |
| Mefenoxam/fludioxonil + ASM/seed | 60.8 |
| Mefenoxam/fludioxonil + rate (3) PBZ/seed + | 96.2 |
| ASM/seed | |

### EXAMPLE 4

### Effects of PGR Seed Treatments on Direct-Seeded Cantaloupes

Trials were conducted on cantaloupe variety Ocotillo to determine the effects of seed treatments with plant growth regulators on emergence of the plants.

Using seeds of cantaloupes, Var. Ocotillo, seeds were treated and planted in greenhouse trials. Treatments consisted of (a) fludioxonil+mefenoxam, (b) fludioxonil+mefenoxam+paclobutrazol at rate (1), (c) fludioxonil+mefenoxam+paclobutrazol at rate (2), (d) fludioxonil+mefenoxam+paclobutrazol at rate (3), (e) fludioxonil+mefenoxam+paclobutrazol at rate (4), (f) fludioxonil+mefenoxam+acibenzolar-S-methyl, and (g) fluxioxonil+mefenoxam+paclobutrazol at rate (3)+acibenzolar-S-methyl. The treatments were compared with untreated check.

The results after thinning, 34 days after planting, are provided in Table D.

TABLE D

| | No. Plants |
|---|---|
| | Emerged |
| CHECK UNTREATED | 24.1 |
| Mefenoxam/fludioxonil | 23.8 |
| Mefenoxam/fludioxonil + rate (1) PBZ/seed | 24.5 |
| Mefenoxam/fludioxonil + rate (2) PBZ/seed | 18.5 |
| Mefenoxam/fludioxonil + rate (3) PBZ/seed | 13.6 |
| Mefenoxam/fludioxonil + rate (4) PBZ/seed | 9.5 |
| Mefenoxam/fludioxonil + ASM/seed | 18.8 |
| Mefenoxam/fludioxonil + rate (3) PBZ/seed + | 21.3 |
| ASM/seed | |

Results before thinning, 26 days after planting, are provide in Table E.

TABLE E

| | No. Plants |
|---|---|
| | Emerged |
| CHECK UNTREATED | 44.7 |
| Mefenoxam/fludioxonil | 45.6 |
| Mefenoxam/fludioxonil + rate (1) PBZ/seed | 47.9 |
| Mefenoxam/fludioxonil + rate (2) PBZ/seed | 34.3 |
| Mefenoxam/fludioxonil + rate (3) PBZ/seed | 23.4 |
| Mefenoxam/fludioxonil + rate (4) PBZ/seed | 15.3 |
| Mefenoxam/fludioxonil + ASM/seed | 35.1 |
| Mefenoxam/fludioxonil + rate (3) PBZ/seed + | 41.3 |
| ASM/seed | |

### EXAMPLE 5

### Water Use Efficiency

Variety Florida 47 tomatoe seeds were treated and the plants tested with respect to the cumulative amount of water used to sustain the plants from seeding through growth. Paclobutrazol seed treatment shows decreased water use during transplant production. Results are provided in Tables F, G, and H.

Using the data obtained from these trials, and empirical calculations, a tomato transplant business could save approximately 700 gallons of water while producing 27,000 transplants.

| | |
|---|---|
| Fungicide only | 2.4 liters/6 plants |
| Fungicide + 5 ug PBZ | 1.8 liters/6 plants |
| Difference | 0.6 liters/6 plants |

20 tables/greenhouse×28 flats/table×48 plants/flat×0.6 liters/6 plants×gal/3.75 1=710 gallons of water.

The time savings resulting from less frequent watering would be more valuable in areas where water is expensive or not readily available.

TABLE F

| | Cumulative Water Used ml/6 plants | | | | | | | | | |
|---|---|---|---|---|---|---|---|---|---|---|
| | 21- | 22- | 23- | 25- | 26- | 27- | 28- | 29- | 31- | 1- |
| | Jul | Jul | Jul | Jul | Jul | Jul | Jul | Jul | Jul | Aug |
| CHECK UNTREATED | 175 | 270 | 397 | 503 | 637.5 | 761 | 863 | 967 | 1160 | 1284 |
| Fludioxonil/mefenoxam | 180 | 279 | 409 | 511 | 640.17 | 766 | 873 | 977 | 1184 | 1317 |
| Fludioxonil/mefenoxam + | 132 | 208 | 323 | 433 | 541.5 | 644 | 735 | 826 | 1013 | 1133 |
| rate (1) PBZ | | | | | | | | | | |
| Fludioxonil/mefenoxam + | 134 | 210 | 324 | 430 | 538.67 | 641 | 728 | 819 | 1003 | 1123 |
| rate (2) PBZ | | | | | | | | | | |
| Fludioxonil/mefenoxam + | 113 | 174 | 271 | 372 | 464.67 | 555 | 634 | 714 | 878 | 984 |
| rate (3) PBZ | | | | | | | | | | |
| Fludioxonil/mefenoxam + | 120 | 189 | 293 | 395 | 491.17 | 585 | 665 | 745 | 913 | 1025 |
| rate (4) PBZ | | | | | | | | | | |

TABLE G
Weeks 3-5

| | Cumulative Water Used |
|---|---|
| | (ml/6 plants) |
| | 17-May |
| CHECK UNTREATED | 1374 |
| Fludioxonil/mefenoxam | 1421 |
| Fludioxonil/mefenoxam + | 1224 |
| rate (1) PBZ | |
| Fludioxonil/mefenoxam + | 1214 |
| rate (2) PBZ | |
| Fludioxonil/mefenoxam + | 1061 |
| rate (3) PBZ | |
| Fludioxonil/mefenoxam + | 1107 |
| rate (4) PBZ | |

TABLE H
projected through 6^{th} week

| | Cumulative Water Used (ml/6 plants) | | | | | | | | | |
|---|---|---|---|---|---|---|---|---|---|---|
| | 21-Jul | 22-Jul | 23-Jul | 25-Jul | 26-Jul | 27-Jul | 28-Jul | 29-Jul | 31-Jul | 1-Aug |
| CHECK UNTREATED | 175 | 270 | 397 | 503 | 638 | 761 | 863 | 967 | 1160 | 1284 |
| CHECK UNTREATED | 180 | 279 | 409 | 511 | 640.17 | 766 | 873 | 977 | 1184 | 1317 |
| Fludioxonil/mefenoxam | 132 | 208 | 323 | 433 | 541.5 | 644 | 735 | 826 | 1013 | 1133 |
| Fludioxonil/mefenoxam + | 134 | 210 | 324 | 430 | 538.67 | 641 | 728 | 819 | 1003 | 1123 |
| rate (1) PBZ | | | | | | | | | | |
| Fludioxonil/mefenoxam + | 113 | 174 | 271 | 372 | 464.67 | 555 | 634 | 714 | 878 | 984 |
| rate (2) PBZ | | | | | | | | | | |
| Fludioxonil/mefenoxam + | 120 | 189 | 293 | 395 | 491.17 | 585 | 665 | 745 | 913 | 1025 |
| rate (3) PBZ | | | | | | | | | | |
| Fludioxonil/mefenoxam + | 105 | 161 | 246 | 329 | 404.83 | 481 | 547 | 611 | 745 | 828 |
| rate (4) PBZ | | | | | | | | | | |
| PBZ (applied as soak) | 113 | 172 | 259 | 339 | 423.17 | 506 | 575 | 649 | 790 | 883 |

### EXAMPLE 6

### Improved Germination with Composition of PGR and Plant Activator Seed Treatment

Paclobutrazol was combined with a plant activator, specifically with acibenzolar-S-methyl (ASM), and applied as a seed treatment for cantaloupes (var. Ocotillo). The results are provided in Tables J and K.

TABLE J
26 Days after planting; before thinning

| | No. plants emerged |
|---|---|
| | (25 ft row) |
| CHECK UNTREATED | 44.7 |
| Fludioxonil/Mefenoxam | 45.6 |
| Fludioxonil/mefenoxam + rate (1) PBZ | 47.9 |
| Fludioxonil/mefenoxam + rate (2) PBZ | 34.3 |
| Fludioxonil/mefenoxam + rate (3) PBZ | 23.4 |
| Fludioxonil/mefenoxam + rate (4) PBZ | 15.3 |
| Fludioxonil/Mefenoxam + ASM seed | 35.1 |
| treatment | |
| Fludioxonil/Mefenoxam + rate (3) | 41.3 |
| PBZ/seed + ASM seed treatment | |

TABLE K
34 days after planting; after thinning

| | No. plants emerged |
|---|---|
| | (25 ft row) |
| CHECK UNTREATED | 24.1 |
| Fludioxonil/Mefenoxam | 23.8 |
| Fludioxonil/mefenoxam + rate (1) | 24.5 |
| PBZ | |
| Fludioxonil/mefenoxam + rate (2) | 18.5 |
| PBZ | |
| Fludioxonil/mefenoxam + rate (3) | 13.6 |
| PBZ | |
| Fludioxonil/mefenoxam + rate (4) | 9.5 |
| PBZ | |
| Fludioxonil/Mefenoxam + ASM | 18.8 |
| seed treatment | |
| Fludioxonil/Mefenoxam + rate (3) | 21.3 |
| PBZ/seed + ASM seed treatment | |

### EXAMPLE 7

### Improved Cold Tolerance with PGR and Plant Activator Seed Treatment

Greenhouse cucumber seedlings (var. Dasher II) grown from seeds treated with a composition of paclobutrazol and ASM were exposed to cold stress (34-35 F) when moved outdoors to harden off for field planting. After 2 days of drizzly cloudy weather, the sun came out with extremely gusty winds and cold temperatures. All plants in this seed treatment cucumber trial were exposed to cold stress. Vigor measurements were taken and are provided in Table L.

TABLE L

| | % Vigor |
|---|---|
| CHECK UNTREATED | 58.3 |
| Fludioxonil/Mefenoxam | 56.7 |
| Fludioxonil/Mefenoxam + PBZ Seed | 78.3 |
| Treatment | |
| Fludioxonil/Mefenoxam + ASM only | 60.8 |
| Fludioxonil/Mefenoxam + PBZ seed | 96.2 |
| treatment + ASM seed treatment | |

Plants grown from seeds treated with a composition of plant growth regulator and plant activator showed greater vigor, and thus greater resistance to cold stress.

### EXAMPLE 8

### Insect Control

Plants treated with plant growth regulator seed treatment showed less insect count compared to the untreated and fungicide-only seed treated plants. Presence of Colorado Potato Beetle was studied in plants resulting from the seed treatments with paclobutrazol. Results are provided in Table M.

TABLE M

| | No. Potato |
|---|---|
| | Beetle |
| | Adults/plant |
| CHECK UNTREATED | 5 |
| Fludioxonil/Mefenoxam | 2.5 |
| Fludioxonil/Mefenoxam + rate | 0.7 |
| (1) PBZ/seed | |
| Fludioxonil/Mefenoxam + rate | 0.7 |
| (2) PBZ/seed | |
| Fludioxonil/Mefenoxam + rate | 0.8 |
| (3) PBZ/seed | |
| Fludioxonil/Mefenoxam + rate | 0.5 |
| (4) PBZ/seed | |
| rate (3) PBZ | 0.8 |
| PBZ seed soak | 0.8 |

### EXAMPLE 9

### Improved Yields and Safening with PGR+Plant Activator Seed Treatments

In studies with vine ripe tomatoes, yields were shown to improve in plants whose seed was treated with a composition of plant growth regulator and plant activator. Results are provided in Tables N and O.

TABLE N
Cumulative Yield (All Harvests)

| | Yield (kg/plot = |
|---|---|
| | 10 plants) |
| CHECK UNTREATED | 62.4 |
| Fludioxonil/Mefenoxam only | 64.1 |
| Fludioxonil/Mefenoxam + PBZ seed treatment rate (1) | 80.2 |
| Fludioxonil/Mefenoxam + PBZ rate (2) | 79.8 |
| Fludioxonil/Mefenoxam + PBZ rate (3) | 76.1 |

TABLE O
Cumulative Tomato Yields

No. Fruit/Plot
(12 plants
29-Aug

| | |
|---|---|
| CHECK UNTREATED | 119 |
| AVERAGE OF 5 PROGRAMS WITH ASM | 96 |
| AVERAGE OF 3 PROGRAMS WITH ASM + PBZ | 141 |
| GROWER STANDARD | 90 |

Table O also illustrates the safening effect of the PGR on the seed to later foliar application of the plant activator. Without the PBZ on the seed, the yield decreases from 119 to 96. However, where PBZ was applied on the seed, the yield was substantially higher.

### EXAMPLE 10

### Safening and Disease Protection with PGR Seed Treatment Followed by Plant Activator Foliar Application

Clavibacter michiganesis is an important bacterial disease commonly found in tomatoes. ASM is effective against these bacteria as a foliar product applied at high rates. However, high rates of ASM are known to cause phytotoxicity in plants. It has now been found that when using seed treated with plant growth regulators, the toxic effects of high rate foliar-applied ASM are safened.

A set of tomato transplants from seed treated with paclobutrazol was set out and treated with a foliar application of ASM with a penetrating surfactant (Activator 90) to induce maximal phytotoxicity. Four more ASM applications were made at the same rate (with Activator 90) to induce maximal phytotoxicity. The entire trial was inoculated with Clavibacter 25 days after transplanting. The results are provided in Tables P and Q.

TABLE P
Flowering After Three ASM Applications

| | No. Open Flowers/5 plants |
|---|---|
| | 24-Aug |
| Untreated | 2.8 |
| Fludioxonil/Mefenoxam | 0.8 |
| Fludioxonil/Mefenoxam + rate (1) PBZ | 19.3 |
| Fludioxonil/Mefenoxam + rate (2) PBZ | 28.2 |

TABLE Q
Clavibacter Fruit Infections (All Fruit)

| | Disease Incidence (%) |
|---|---|
| | 24-Aug |
| Untreated | 35.4 |
| Fludioxonil/Mefenoxam | 13.6 |
| Fludioxonil/Mefenoxam + rate (2) PBZ | 3.1 |
| Fludioxonil/Mefenoxam + rate (3) PBZ | 5.9 |

### EXAMPLE 11

### Disease Resistance from PGR Seed Treatment

Disease resistance in the post-emergent plant has also been shown through use of plant growth regulators as a seed treatment. A set of tomato transplants from seed treated with paclobutrazol and a fungicidal mixture of fludioxonil and mefenoxam was inoculated with Xanthamonas spp. 18 days after transplanting. As shown in the data presented in Table R, the treatments having paclobutrazol seed treatment showed greater resistance against xanthamonas infection than plants treated with the fungicidal mixture alone. The antibacterial activity of the PGR-treated plants is significant at several rates of application.

TABLE R

| | | No. of infected plants | |
|---|---|---|---|
| | | (24 plants sampled) | |
| 1 | CHECK NON-INOC | 0 | f |
| 2 | Fludioxonil/Mefenoxam + rate (1) PBZ | 10.7 | bc |
| 3 | Fludioxonil/Mefenoxam + rate (2) PBZ | 12.7 | bc |
| 4 | Fludioxonil/Mefenoxam + rate (3) PBZ | 9.7 | c |
| 5 | Fludioxonil/Mefenoxam + rate (4) PBZ | 13 | bc |
| 6 | Fludioxonil/Mefenoxam + rate (1) PBZ + | 9.3 | c |
| | foliar ASM | | |
| 7 | Fludioxonil/Mefenoxam + rate (2) PBZ + | 8.3 | cd |
| | foliar ASM | | |
| 8 | Fludioxonil/Mefenoxam + rate (3) PBZ + | 3.3 | ef |
| | foliar ASM | | |
| 9 | Fludioxonil/Mefenoxam + rate (4) PBZ + | 4.7 | de |
| | foliar ASM | | |
| 10 | Fludioxonil/Mefenoxam FB foliar ASM | 15 | bc |
| 11 | Fludioxonil/Mefenoxam - Inoculated | 21.3 | a |

### EXAMPLE 12

### Additive Bactericidal Activity from PGR Seed Treatment and Foliar Plant Activator Application

As shown in the data presented in Tables S (PGR seed treatment followed by ASM foliar), two of the treatments having PGR seed treatments with foliar ASM application (Trts 8 and 9) showed statistically significant better bacterial disease control compared to the treatments having PGR seed treatment alone.

TABLE S

| | | No. of infected plants | |
|---|---|---|---|
| | | (24 plants sampled) | |
| 1 | CHECK NON-INOC | 0 | f |
| 2 | Fludioxonil/Mefenoxam + rate (1) PBZ | 10.7 | bc |
| 3 | Fludioxonil/Mefenoxam + rate (2) PBZ | 12.7 | bc |
| 4 | Fludioxonil/Mefenoxam + rate (3) PBZ | 9.7 | c |
| 5 | Fludioxonil/Mefenoxam + rate (4) PBZ | 13 | bc |
| 6 | Fludioxonil/Mefenoxam + rate (1) PBZ + | 9.3 | c |
| | foliar ASM | | |
| 7 | Fludioxonil/Mefenoxam + rate (2) PBZ + | 8.3 | cd |
| | foliar ASM | | |
| 8 | Fludioxonil/Mefenoxam + rate (3) PBZ + | 3.3 | ef |
| | foliar ASM | | |
| 9 | Fludioxonil/Mefenoxam + rate (4) PBZ + | 4.7 | de |
| | foliar ASM | | |
| 10 | Fludioxonil/Mefenoxam FB foliar ASM | 15 | bc |
| 11 | Fludioxonil/Mefenoxam - Inoculated | 21.3 | a |

### EXAMPLE 13

### Safening Against Post-Emergence Pesticide Application Using Plant Growth Regulartor Seed Treatment

Using a plant growth regulator as a seed treatment has shown to protect the emergent plant against foliar applications of other pesticides. Safening can be shown using several benchmarks, including early flowing, increased yields, better vigor, greater stem thickness, and larger fruit size.

The following basic treatment list applies to the data generated in Examples 13.1 through 13.4.

Treatment List

1. Check
2. Standard bacterial disease control (EBDC/Copper)
3. ASM bacterial disease control (label rate)
4. ASM bacterial disease control (exaggerated rate to induce phytotoxicity)
5. Low rate of PGR (rate 1)
6. ASM bacterial disease control (label rate) on top of low rate PGR (rate 1)
7. ASM bacterial disease control (exaggerated rate) on top of low rate of PGR (rate 1)
8. High rate of PGR (rate 2)
9. ASM bacterial disease control (label rate) on top of high rate of PGR (rate 2)
10. ASM bacterial disease control (exaggerated rate) on top of high rate of PGR (rate 2)

### EXAMPLE 13.1

### Flowering from PGR Seed Treatment and Activator Foliar Application in Tomatoes

A set of tomato transplants from seed treated with paclobutrazol plant growth regulator according to the treatment list provided above was transplanted on June 16. The transplants were treated with eight (8) foliar applications on the following dates after transplant: June 21, June 30, July 8, July 15, July 22, July 30, August 9, August 17. Trials were inoculated with Clavibacter (bacterial canker) on August 12 and August 20. The effects on flowering were studied, and results are provided in Table U.

TABLE U

| Treatment | 6-Jul | 9-Jul | 12-Jul | 15-Jul | 18-Jul |
|---|---|---|---|---|---|
| 1 | 0 | 0 | 17.6 | 39 | 85.4 |
| 2 | 0 | 0.2 | 20.6 | 41.4 | 80 |
| 3 | 0 | 0 | 10 | 34.2 | 79.2 |
| 4 | 0 | 1.8 | 9.2 | 25.8 | 74.4 |
| 5 | 4.4 | 24.4 | 52.6 | 84 | 114.8 |
| 6 | 5 | 25 | 47.4 | 83.6 | 108.4 |
| 7 | 1.8 | 28.4 | 50.4 | 84.2 | 112.8 |
| 8 | 2.2 | 24.8 | 49.4 | 82.6 | 118.4 |
| 9 | 3.6 | 30 | 49 | 80 | 106.2 |
| 10 | 6.2 | 27.6 | 49 | 79.4 | 101.4 |

### EXAMPLE 13.2

### Plant Vigor Measurements from PGR Seed Treatment and Activator Foliar Application in Tomatoes

Using the plants and protocol provided in Example 14.2, the effects of treatments with a plant activator on plant vigor were studied, and results are in Table V.

TABLE V

| | | | | | | | | | | |
|---|---|---|---|---|---|---|---|---|---|---|
| Treatment | 1 | 2 | 3 | 4 | 5 | 6 | 7 | 8 | 9 | 10 |
| Vigor (%) | 85 | 88.2 | 85.4 | 86.4 | 95.6 | 93.8 | 94.6 | 93.2 | 95.4 | 94.6 |

All plants grown from plant growth regulator-treated seed were more vigorous than plants grown from non- plant growth regulator-treated seed after all foliar plant activator applications were made.

### EXAMPLE 13.3

### Stem Thickness Measurements from PGR Seed Treatment and Activator Foliar Application in Tomatoes

Using the plants and protocol provided in Example 14.2, the effects of the foliar treatments with a plant activator on plant stem size were measured, and results are provided in Table W.

TABLE W

| | | | | | | | | | | |
|---|---|---|---|---|---|---|---|---|---|---|
| Treatment | 1 | 2 | 3 | 4 | 5 | 6 | 7 | 8 | 9 | 10 |
| Stem Diameter (mm) | 10.3 | 10.5 | 10.9 | 11.2 | 14.8 | 14.2 | 14.7 | 15.1 | 14.2 | 14.6 |

All plants grown from plant growth regulator-treated seed had thicker, healthier stems than plants grown from non-plant growth regulator-treated seed after all foliar plant activator applications were made.

### EXAMPLE 13.4

### Yields from PGR Seed Treatment and Activator Foliar Application in Tomatoes

Using the plants and protocol provided in Example 14.2, the effects of the foliar treatments with a plant activator on fruit yield were measured, and results are provided in Tables X-AA.

TABLE X
First Pick (August 23)

| | | | | | | | | | | |
|---|---|---|---|---|---|---|---|---|---|---|
| Treatment | 1 | 2 | 3 | 4 | 5 | 6 | 7 | 8 | 9 | 10 |
| Yield (lbs/plot) | 2.05 | 1.04 | 1.98 | 1.24 | 14.65 | 15.35 | 14.08 | 13.24 | 12.12 | 13.99 |

All plants grown from plant growth regulator-treated seed outyielded plants grown from non-plant growth regulator-treated seed regardless of whether or not foliar plant activator applications were made.

TABLE Y
Second Pick (September 8)

| | | | | | | | | | | |
|---|---|---|---|---|---|---|---|---|---|---|
| Treatment | 1 | 2 | 3 | 4 | 5 | 6 | 7 | 8 | 9 | 10 |
| Yield (lbs/plot) | 39.12 | 39.2 | 35.24 | 29 | 50.34 | 44.8 | 40.92 | 45.24 | 40.92 | 33.62 |

All plants grown from plant growth regulator-treated seed outyielded plants grown from non-plant growth regulator-treated seed regardless of whether or not foliar plant activator applications were made.

TABLE Z
Third Pick (September 18)

| | | | | | | | | | | |
|---|---|---|---|---|---|---|---|---|---|---|
| Treatment | 1 | 2 | 3 | 4 | 5 | 6 | 7 | 8 | 9 | 10 |
| Yield (lbs/plot) | 64.57 | 66.52 | 60.66 | 53.16 | 81.55 | 74.11 | 66.32 | 82.64 | 70.08 | 62.17 |

All plants grown from plant growth regulator-treated seed out-yielded plants grown from non-plant growth regulator-treated seed regardless of whether or not foliar plant activator applications were made.

TABLE AA
Cumulative Yield (All Picks)

| | | | | | | | | | | |
|---|---|---|---|---|---|---|---|---|---|---|
| Treatment | 1 | 2 | 3 | 4 | 5 | 6 | 7 | 8 | 9 | 10 |
| Yield (lbs/plot) | 64.57 | 66.52 | 60.66 | 53.16 | 81.55 | 74.11 | 66.32 | 82.64 | 70.08 | 62.17 |

Although there are some increases in yields between plants grown from treated seed and plants grown with untreated seed, there are only slight differences between plants from treated seed followed by foliar applictions of plant activator and those having no follow-up foliar treatment. As a result, the seed treatment allows for superior bacterial control with a plant activator without the threat of reducing yields.

### EXAMPLE 14

### Lodging Control Using PGR Seed Treatments

Barley seeds were treated with paclobutrazol (alone) and with paclobutrazol in combination with gibberrelic acid at varying rates. The resulting plants were then additionally treated with foliar applications of trinexapac plant growth regulator (applied as Palisade™ 128 and Palisade™ 150) at the Feekes 6 timing. Emergence and percent lodging were measured against the check. The results are found in Tables BB and CC.

TABLE BB
Emergence

| | 8 Days after plant- | | 14 Days after plant- | |
|---|---|---|---|---|
| | ing (no. emerged- | | ing (no. emerged- | |
| Treatment | 6 ft row) | | 6 ft row) | |
| CHECK | 143 | a | 142.7 | a |
| PBZ rate (1) | 68.2 | b | 113.2 | b |
| PBZ ratge (2) | 36.3 | c | 106.3 | b |
| PBZ rate (3) | 38.7 | c | 114.5 | b |
| PBZ (1) + GA rate (1) | 133.5 | a | 135.2 | a |
| PBZ (2) + GA rate (1) | 131.7 | a | 130 | a |
| PBZ (3) + GA rate (1) | 127.6 | a | 129.7 | a |
| PBZ (2) + GA rate (1) + TXP | 135 | a | 133 | a |
| PBZ (3) + GA rate (1) + TXP | 132.7 | a | 129 | a |

TABLE CC
Lodging

| | % Lodging | | | | | | | |
|---|---|---|---|---|---|---|---|---|
| Treatment | 19 May | | 7 Jun | | 11 Jun | | 18 Jun | |
| CHECK | 8.3 | a | 85.8 | a | 38.3 | a | 35 | a |
| Trinexapac [128] Feekes | 8.3 | a | 7.5 | c | 0.5 | e | 0 | d |
| 6 | | | | | | | | |
| Trinexapac [150] Feekes | 11.7 | a | 0.2 | c | 0 | e | 0 | d |
| 6 | | | | | | | | |
| Trinexapac [128] Feekes | 7.5 | a | 79.2 | ab | 17.2 | cd | 1.7 | d |
| 6 + 7 days | | | | | | | | |
| PBZ rate (1) | 0 | a | 85.8 | a | 29.2 | ab | 31.7 | ab |
| PBZ ratge (2) | 0 | a | 68.3 | b | 16.8 | cd | 23.3 | bc |
| PBZ rate (3) | 0 | a | 72.5 | ab | 9.2 | de | 20 | c |
| PBZ (1) + GA rate (1) | 0 | a | 73.3 | ab | 33.3 | a | 30.8 | ab |
| PBZ (2) + GA rate (1) | 0 | a | 85 | a | 33.8 | a | 31.7 | ab |
| PBZ (3) + GA rate (1) | 0 | a | 80 | ab | 27.5 | abc | 30.8 | ab |
| PBZ (2) + GA rate (1) + | 0 | a | 0.8 | c | 0 | e | 0 | d |
| TXP | | | | | | | | |
| PBZ (3) + GA rate (1) + | 0 | a | 0 | c | 0 | e | 0 | d |
| TXP | | | | | | | | |

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

We claim:

1. A composition comprising a combination of at least one plant growth regulator and at least one plant activator.

2. The composition according to claim 1, wherein the plant growth regulator is selected from antiauxins; auxins; cytokinins; defoliants; ethylene inhibitors; gibberellins; growth inhibitors; morphactins; growth retardants/modifiers; and growth stimulators.

3. The composition according to claim 2, wherein the at least one plant growth regulator is selected from paclobutrazol, cyproconazole, tetcyclacis, uniconazole, gibberellic acids, ancymidol, ethephon, glycinebetaine, aminocyclopropane-1-carboxylic acid, and trinexapac-ethyl.

4. The composition according to claim 1, wherein the at least one plant activator is selected from acibenzolar-S-methyl, probenazole, harpin protein, and reynoutria sachalinensis extract (reysa).

5. The composition according to claim 3, wherein the at least one plant activator is selected from acibenzolar-S-methyl, probenazole, harpin protein, and reynoutria sachalinensis extract (reysa).

6. The composition according to claim 1, further comprising one or more fungicides selected from azoxystrobin; bitertanol; carboxin; Cu₂O; cymoxanil; cyproconazole; cyprodinil; dichlofluamid; difenoconazole; diniconazole; epoxiconazole; fenpiclonil; fludioxonil; fluoxastrobin; fluquiconazole; flusilazole; flutriafol; furalaxyl; guazatin; hexaconazole; hymexazol; imazalil; imibenconazole; ipconazole; kresoxim-methyl; mancozeb; metalaxyl; mefenoxam; metconazole; myclobutanil; oxadixyl; pefurazoate; penconazole; pencycuron; picoxystrobin; prochloraz; propiconazole; pyroquilone; (±)-cis-1-(4-chlorophenyl)-2-(1H-1,2,4-triazol-1-yl)cycloheptanol; spiroxamin; tebuconazole; thiabendazole; tolifluamide; triazoxide; triadimefon; triadimenol; trifloxystrobin, triflumizole; triticonazole, uniconazole and compounds, stereoisomers, and mixtures of stereoisomers of the formulae: 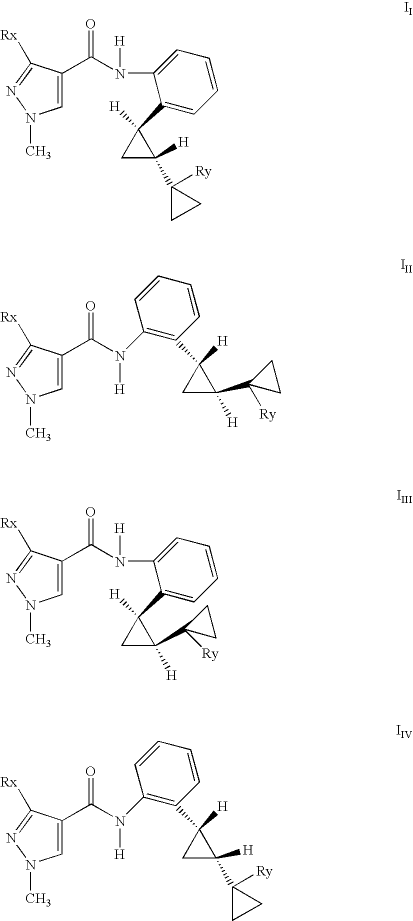
wherein
Rₓ is trifluoromethyl or difluoromethyl and
R_{y} is hydrogen or methyl; or a tautomer of such a compound.

7. The composition according to claim 6, wherein the one or more fungicides is selected from azoxystrobin, cyproconazole; difenoconazole; fludioxonil; fluoxastrobin, metalaxyl; mefenoxam; myclobutanil, picoxystrobin; propiconazole; tebuconazole; thiabendazole; trifloxystrobin; triticonazole, uniconazole and compounds, stereoisomers, and mixtures of stereoisomers of the formulae: 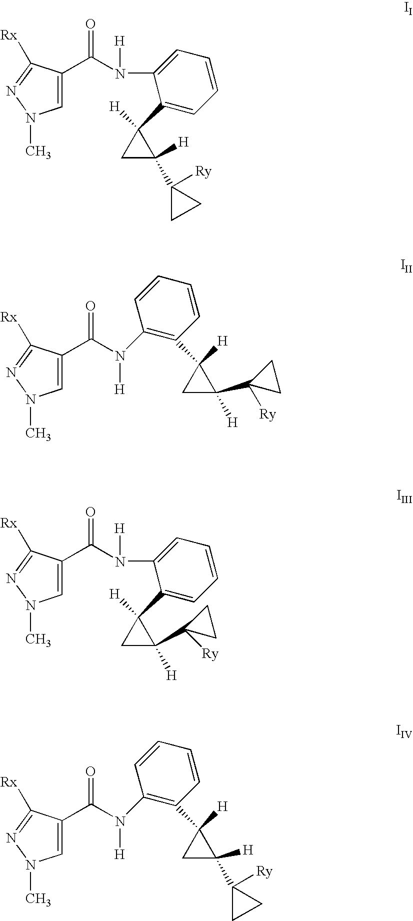
wherein
Rₓ is trifluoromethyl or difluoromethyl and
R_{y} is hydrogen or methyl; or a tautomer of such a compound.

8. The composition according to claim 1, further comprising one or more insecticides, acaracides, nematicides or molluscicides selected from abamectin, cyanoimine, acetamiprid, thiodicarb, nitromethylene, nitenpyram, clothianidin, dinotefuran, fipronil, lufenuron, pyripfoxyfen, thiacloprid, tefluthrin, fluxofenime; imidacloprid, thiamethoxam, chloranthraniliprole, beta cyfluthrin, lambda cyhalothrin, fenoxycarb, diafenthiuron, pymetrozine, diazinon, disulphoton; profenofos, furathiocarb, cyromazin, cypermethrin, tau-fluvalinate, tefluthrin or Bacillus thuringiensis products.

9. The composition according to claim 8, wherein the one or more insecticides, acaracides, nematicides or molluscicides selected from abamectin, thiodicarb, clothianidin, fipronil, thiacloprid, tefluthrin, imidacloprid, thiamethoxam, chloranthraniliprole, acetamiprid, beta cyfluthrin, lambda cyhalothrin, and Bacillus thuringiensis products.

10. The composition according to claim 9, further comprising one or more fungicides selected from azoxystrobin, cyproconazole; difenoconazole; fludioxonil; fluoxastrobin, metalaxyl; mefenoxam; myclobutanil, picoxystrobin; propiconazole; tebuconazole; thiabendazole; trifloxystrobin; triticonazole, uniconazole and compounds, stereoisomers, and mixtures of stereoisomers of the formulae: 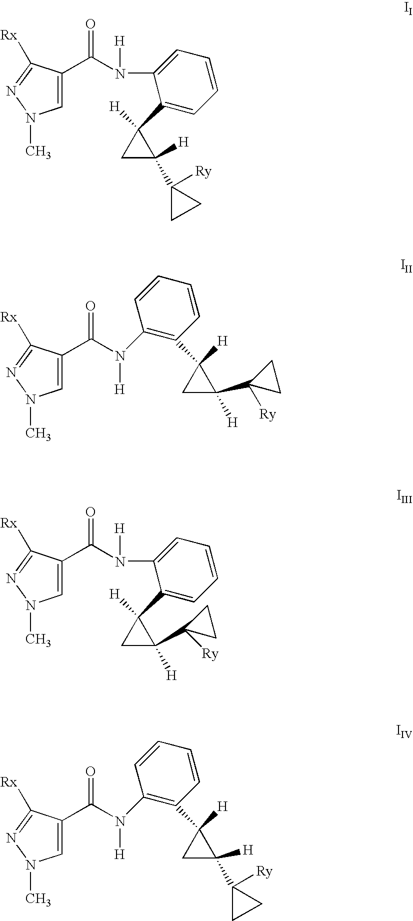
wherein
Rₓ is trifluoromethyl or difluoromethyl and
R_{y} is hydrogen or methyl; or a tautomer of such a compound.

11. The composition according to claim 10, wherein the plant growth regulator is paclobutrazole, the plant activator is acibenzalor-S-methyl, the one or more fungicide is mefenoxam and fludioxonil, and the insecticide is thiamethoxam.

12. Plant propagation material treated with a composition according to claim 1.

13. Plant propagation material according to claim 12, wherein the plant propagation material is seed.

14. Plant propagation material according to claim 13, wherein the seed is the seed of cereals selected from wheat, barley, rye, oats, corn, rice, sorghum, triticale and related crops; sugar beet; fodder beet; leguminous plants selected from beans, lentils, peas, soybeans; oil plants selected from rape, mustard, peanuts, canola, and sunflowers; cucumber plants; marrows; watermelons; cantaloupes; melons; fibre plants selected from cotton, flax, hemp, and jute; forage crops selected from alfalfa and clover; vegetables selected from spinach, lettuce, peppers, asparagus, cabbages, broccoli, cauliflower, carrots, onions, tomatoes, potatoes, and paprika; tobacco; ornamentals selected from flowers, shrubs, broad-leaved trees and evergreens; and turf.

15. Plant propagation material according to claim 14, wherein the seed is the seed of cucumbers, watermelons; cantaloupes; melons; sugar beet, spinach, lettuce, peppers, asparagus, cabbages, broccoli, cauliflower, carrots, onions, tomatoes, wheat, barley, canola, alfalfa, clover, pansy, petunia, begonia, impatiens, geranium, chrysanthemum, roses, poinsettia, and cotton.

16. A method for reducing disease in pre-transplant seedlings, post-transplant plants, or on fruits and/or flowers of plants, comprising applying to plant propagation material an effective amount of a composition according to claim 1.

17. The method according to claim 16, wherein the disease is bacterial disease selected from Clavibacter michiganense, Xanthomonas campestris pv campestris, vesicatoria, spinaciae, vitians, translucens, carotae, Pseudomonas syringae pv. Tomato, lachrymans, coronafaciens, striafaciens, apii, Pseudomonas gladioli, Psedomonas corrugate, Erwinia carotovora ssp. Carotovora, Erwinia. chrysanthemi, Erwinia betavasculorum, Erwinia spp., Pectobacterium carotovorum ssp. Carotovorum, and Enterobacter cloacae.

18. The method according to claim 17, further comprising planting the propagation material, and achieving bacterial suppression in a resulting plant and/or its fruit or flower.

19. The method according to claim 17, further comprising treating the plant post-emergence with one or more insecticides, fungicides, nematicides, and/or additional plant growth regulators or plant activators.

20. The method according to claim 17, wherein the at least one plant growth regulator and at least one plant activator may be applied to the plant propagation material simultaneously or sequentially in any order.

21. A method for reducing disease in pre-transplant seedlings, post-transplant plants, or on fruits and/or flowers of plants, comprising applying to plant propagation material an effective amount of a composition according to claim 10.

22. The method according to claim 21, wherein the at least one plant growth regulator, the at least one plant activator, the one or more fungicides, and the one or more insecticides, acaracides, nematicides, or molluscicides may be applied to the plant propagation material simultaneously or sequentially in any combination.

23. The method according to claim 21, wherein the plant propagation material, prior to planting, is treated with one or more insecticides, fungicides, nematicides, and/or additional plant growth regulators or plant activators.

24. The method according to claim 21, wherein the plant growth regulator is selected from paclobutrazole, cyproconazole, uniconazole, gibberellic acid, ancymidol, or trinexapac-ethyl; the plant activator is selected from acibenzalor-S-methyl or harpin protein; the insecticide is selected from thiamethoxam; the fungicide is selected from mefenoxam, fludioxonil, azoxystrobin, or a mixture thereof, or a mixture of mefenoxam and fludioxonil.

25. A method for safening a plant against post-emergent treatment with pesticides comprising applying to plant propagation material an effective amount of composition according to claim 1.

26. A method for safening a plant against post-emergent treatment with pesticides comprising applying to plant propagation material an effective amount of composition according to claim 10.

27. The method according to claim 25, wherein the pesticide safened against is selected from one or more of plant growth regulators, plant activators, insecticides, nematicides, acaracides, molluscicides, and fungicides.

28. The method according to claim 26, wherein the pesticide safened against is selected from one or more of plant growth regulators, plant activators, insecticides, nematicides, acaracides, molluscicides, and fungicides.

29. A method for enhanced transplant health in a crop plant, including ornamental crops, comprising applying a composition according to claim 1 as a seed treatment.

30. A method for enhanced transplant health in a crop plant, including ornamental crops, comprising applying a composition according to claim 10 as a seed treatment.

31. The method according to claim 29, wherein the composition is applied directly on the seed, either as a single formulation or sequentially, in any order, as separate seed treatment formulations.

32. The method according to claim 30, wherein the composition is applied directly on the seed, either as a single formulation or sequentially, in any order, as separate seed treatment formulations.

33. The method according to claim 31, further comprising applying additional plant growth regulators, plant activators, insecticides, nematicides, acaracides, molluscicides, and fungicides to the soil, growth media, or irrigation system.

34. The method according to claim 32, further comprising applying additional plant growth regulators, plant activators, insecticides, nematicides, acaracides, molluscicides, and fungicides to the soil, growth media, or irrigation system.

35. A method for extending the shelf life of post-harvest crops, including ornamental crops, comprising applying a composition according to claim 1 as a seed treatment.

36. The method according to claim 35, wherein the composition is applied directly on the seed, either as a single formulation or sequentially, in any order, as separate seed treatment formulations.

37. The method according to any one of claims 35, further comprising applying additional plant growth regulators, plant activators, insecticides, nematicides, acaracides, molluscicides, and fungicides to the soil, growth media, or irrigation system.

38. A method for extending the shelf life of post-harvest crops, including ornamental crops, comprising applying a composition according to claim 10 as a seed treatment.

39. The method according to claim 38, wherein the composition is applied directly on the seed, either as a single formulation or sequentially, in any order, as separate seed treatment formulations.

40. The method according to any one of claims 38, further comprising applying additional plant growth regulators, plant activators, insecticides, nematicides, acaracides, molluscicides, and fungicides to the soil, growth media, or irrigation system.

41. A method for improving the harvesting efficiency in crop plants, including ornamental crops, comprising applying a composition according to claim 1 as a seed treatment.

42. The method according to claim 41, wherein the composition is applied directly on the seed, either as a single formulation or sequentially, in any order, as separate seed treatment formulations.

43. The method according to claim 41, further comprising applying additional plant growth regulators, plant activators, insecticides, nematicides, acaracides, molluscicides, and fungicides to the soil, growth media, or irrigation system.

44. A method for improving the harvesting efficiency in crop plants, including ornamental crops, comprising applying a composition according to claim 10 as a seed treatment.

45. The method according to claim 44, wherein the composition is applied directly on the seed, either as a single formulation or sequentially, in any order, as separate seed treatment formulations.

46. The method according to claim 44, further comprising applying additional plant growth regulators, plant activators, insecticides, nematicides, acaracides, molluscicides, and fungicides to the soil, growth media, or irrigation system.

47. A method for reducing the input requirements in crop plants, including ornamental crops, comprising applying a composition according to any one of claims 1 as a seed treatment.

48. The method according to claim 47, wherein the composition is applied directly on the seed, either as a single formulation or sequentially, in any order, as separate seed treatment formulations.

49. The method according to any one of claims 48, further comprising applying additional plant growth regulators, plant activators, insecticides, nematicides, acaracides, molluscicides, and fungicides to the soil, growth media, or irrigation system.

50. A method for reducing the input requirements in crop plants, including ornamental crops, comprising applying a composition according to any one of claims 10 as a seed treatment.

51. The method according to claim 50, wherein the composition is applied directly on the seed, either as a single formulation or sequentially, in any order, as separate seed treatment formulations.

52. The method according to any one of claims 50, further comprising applying additional plant growth regulators, plant activators, insecticides, nematicides, acaracides, molluscicides, and fungicides to the soil, growth media, or irrigation system.
